(19) United States
(12) Patent Application Publication
(10) Pub. No.: US 2026/0299498 A1
(43) Pub. Date: Oct. 1, 2026

(54) POST-PROCESSING DEVICE AND IMAGE FORMING SYSTEM USING POST-PROCESSING DEVICE

(71) Applicant: FUJIFILM Business Innovation Corp., Tokyo (JP)

(72) Inventors: Motoharu NAKAO, Kanagawa (JP); Toru INOUE, Kanagawa (JP); Hina SAITO, Kanagawa (JP); Yasutaka GOTOH, Kanagawa (JP); Sodai HIGUCHI, Kanagawa (JP)

(73) Assignee: FUJIFILM Business Innovation Corp., Tokyo (JP)

(21) Appl. No.: 19/315,696

(22) Filed: Sep. 1, 2025

(30) Foreign Application Priority Data
Mar. 27, 2025 (JP) 2025-054029

(51) Int. Cl. G03G 15/00; G03G 15/20

(52) U.S. Cl. CPC G03G 15/6573; G03G 15/2064; G03G 15/6585; G03G 2215/00603; G03G 2215/00759; G03G 2215/00772; G03G 2215/0604

(57) ABSTRACT

A post-processing device includes a transport section that transports a medium, on which an image formed using an imaging material and wax are held and which has passed through a fixing section that fixes the image of the medium by heating and pressurization, at a predetermined transport speed by nipping the medium, a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section, an acquisition section that acquires use environment information of the wax held on the medium that has passed through the fixing section, and an adjustment section that adjusts a rubbing condition of the rubbing section based on the use environment information acquired by the acquisition section.

### CROSS-REFERENCE TO RELATED APPLICATIONS

This application is based on and claims priority under 35 USC 119 from Japanese Patent Application No. 2025-054029 filed Mar. 27, 2025.

### BACKGROUND

### (i) Technical Field

The present invention relates to a post-processing device and an image forming system using the post-processing device.

### (ii) Related Art

In the related art, as an image forming system using a toner containing wax or a post-processing device used in the image forming system, for example, an image forming system and a post-processing device disclosed in JP2002-91205A (Detailed Description of the Invention, FIG. 1), JP2011-175066A (Detailed Description of the Invention, FIG. 2), and JP2009-192982A (Best Mode for Carrying Out the Invention, FIG. 1) have already been known.

JP2002-91205A (Detailed Description of the Invention, FIG. 1) discloses an image forming device including a cleaning section that cleans a waste material including at least a wax component on a surface of a recording medium after fixing and before being discharged outside the device.

JP2011-175066A (Detailed Description of the Invention, FIG. 2) discloses a fixing device that controls surface recovery processing of recovering surface properties of a fixing member based on a temperature of the fixing member.

JP2009-192982A (Best Mode for Carrying Out the Invention, FIG. 1) discloses an image forming device including an image rubbing section that is provided at a downstream position of a fixing device in a recording medium transport direction and is composed of a glossiness imparting member and a medium transport member, and a heating control section that controls heating of the image rubbing section, in which the glossiness imparting member is heated by the heating control section, and paper after a toner image is fixed by the fixing device is nipped between the glossiness imparting member and the medium transport member of the image rubbing section, and an image surface of the paper is rubbed by the glossiness imparting member while being transported by the medium transport member.

### SUMMARY

Aspects of non-limiting embodiments of the present disclosure relate to a post-processing device and an image forming system using the post-processing device that smooth wax on a medium by appropriately rubbing the wax on the medium in consideration of a use environment of the wax before post-processing, while transporting the medium, to make the wax on the medium less visible.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing device including: a transport section that transports a medium, on which an image formed using an imaging material and wax are held and which has passed through a fixing section that fixes the image of the medium by heating and pressurization, at a predetermined transport speed by nipping the medium; a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section; an acquisition section that acquires use environment information of the wax held on the medium that has passed through the fixing section; and an adjustment section that adjusts a rubbing condition of the rubbing section based on the use environment information acquired by the acquisition section.

### BRIEF DESCRIPTION OF THE DRAWINGS

Exemplary embodiment(s) of the present invention will be described in detail based on the following figures, wherein:

FIG. 1A is a diagram showing an example of an outline of an exemplary embodiment of an image forming system including a post-processing device to which the present invention is applied, FIG. 1B is a diagram showing an example of the post-processing device shown in FIG. 1A, and FIG. 1C is a diagram schematically showing a change before and after a wax held on a medium passes through the post-processing device;

FIG. 2 is a diagram showing an overall configuration of an image forming system according to Exemplary Embodiment 1;

FIG. 3A is a diagram showing a configuration example of a fixing device used in the image forming system of FIG. 2, FIG. 3B is a diagram showing a state where a medium that holds an unfixed image formed using a toner enters the fixing device, and FIG. 3C is a diagram showing a state where wax on a surface of the toner is transferred to a heating roll, which is a fixing member for heating, in a case where the medium has passed through the fixing device;

FIG. 4A is a diagram showing a state where the wax that slips through a cleaning mechanism in the wax transferred to the heating roll is transferred to a side of a pressure roll that is a fixing member for pressurization, FIG. 4B is a diagram showing a state where the wax is transferred from the heating roll and the pressure roll that are the fixing members to a front surface and a back surface of the medium in a case where a subsequent medium passes through the fixing device, and FIG. 4C is a diagram schematically showing a state where the wax transferred to the surface of the medium is solidified;

FIG. 5 is a diagram showing a peripheral configuration example of a post-processing device of the image forming system according to Exemplary Embodiment 1;

FIG. 6A is a diagram showing an example of surface information detection in which surface information of the medium is optically detected, and FIG. 6B is a diagram showing an example of a surface information detector that detects the presence or absence of the medium having low surface resistance;

FIG. 7 is a diagram showing a major portion of a post-processing device according to Exemplary Embodiment 1;

FIG. 8 is a diagram showing a configuration example of a transport roll and a rubbing roll of the post-processing device according to Exemplary Embodiment 1;

FIG. 9A is a diagram showing a support structure example of the transport roll, and FIG. 9B is a diagram showing a retract mechanism example shown in FIG. 9A;

FIG. 10A is a diagram showing the support structure example of the rubbing roll, FIG. 10B is a diagram showing an example of a nip release mechanism shown in FIG. 10A, FIG. 10C is an arrow view taken from a C direction in FIG. 10B, and FIG. 10D is a diagram showing a configuration example of application of a contact pressure in a case of contact of the rubbing roll;

FIG. 11A is a diagram showing a relationship between the wax held on the medium and physical properties of the medium, FIG. 11B is a diagram showing a relationship between the wax held on the medium and a temperature condition of the medium, and FIG. 11C is a diagram showing an example of viscosity characteristics of the wax held on the medium with respect to a medium temperature;

FIG. 12 is a flowchart showing processing of adjusting a rubbing energy of the rubbing roll of the post-processing device according to Exemplary Embodiment 1;

FIG. 13 is a flowchart showing an example of the adjustment of the rubbing energy of the rubbing roll to paper having smoothness of equal to or less than 3000;

FIG. 14 is a flowchart showing an example of the adjustment of the rubbing energy of the rubbing roll to paper having smoothness of exceeding 3000;

FIG. 15 is a flowchart showing an example of the adjustment of the rubbing energy of the rubbing roll in a case of metallic paper;

FIG. 16A is a diagram showing a state where the medium is passing through the surface information detector, and FIG. 16B is a diagram showing a state where the medium is passing through the fixing device;

FIG. 17A is a diagram showing a state before the medium enters the transport roll and the rubbing roll as the post-processing device, and FIG. 17B is a diagram showing a state where the medium passes through the transport roll and the rubbing roll as the post-processing device;

FIGS. 18A to 18E are diagrams showing a post-processing operation procedure of the post-processing device according to Exemplary Embodiment 1 in time series;

FIG. 19A is a diagram schematically showing a change state of the wax held on the medium before and after the wax passes through the post-processing device according to Exemplary Embodiment 1, FIG. 19B is a plan view of FIG. 19A viewed from above, and FIG. 19C is a diagram schematically showing a change state of wax held on a medium before and after the wax passes through a post-processing device according to Comparative Example 1;

FIG. 20 is a diagram showing a major portion of a post-processing device according to Exemplary Embodiment 2;

FIG. 21 is a diagram showing a configuration example of a transport roll and a rubbing roll of the post-processing device according to Exemplary Embodiment 2;

FIGS. 22A to 22E are diagrams showing a post-processing operation procedure of the post-processing device according to Exemplary Embodiment 2 in time series;

FIG. 23 is a diagram showing a peripheral configuration example of a post-processing device according to Exemplary Embodiment 3;

FIG. 24 is a diagram showing a drive control system of the post-processing device according to Exemplary Embodiment 3;

FIG. 25 is a diagram showing a configuration example of a transport roll and a rubbing roll of the post-processing device according to Exemplary Embodiment 3;

FIG. 26 is a flowchart showing a control processing procedure of the post-processing device according to Exemplary Embodiment 3;

FIG. 27A is a diagram schematically showing a first mode of the post-processing device according to Exemplary Embodiment 3, FIG. 27B is a diagram schematically showing a second mode of the post-processing device, and FIG. 27C is a diagram schematically showing a third mode of the post-processing device;

FIG. 28A is a diagram showing a state where the medium is passing through the surface information detector, and FIG. 28B is a diagram showing a state where the medium is passing through the fixing device;

FIG. 29A is a diagram showing a state before the medium enters the transport roll and the rubbing roll as the post-processing device, and FIG. 29B is a diagram showing behavior of a state where a leading end of the medium has entered the transport roll as the post-processing device;

FIG. 30A is a diagram showing a behavior of the medium in a state where the trailing end of the medium has passed through the first rubbing roll, and FIG. 30B is a diagram showing a behavior of the medium in a state where a trailing end of the medium has passed through the transport roll;

FIGS. 31A to 31E are diagrams showing a post-processing operation procedure of the post-processing device according to Exemplary Embodiment 3 in time series;

FIG. 32 is a diagram showing a major portion of a post-processing device according to Exemplary Embodiment 4 and a drive control system of the post-processing device;

FIG. 33 is a diagram showing a configuration example of a first transport roll, a second transport roll, a first rubbing roll, and a second rubbing roll of the post-processing device according to Exemplary Embodiment 4;

FIG. 34 is a flowchart showing a control processing procedure of the post-processing device according to Exemplary Embodiment 4;

FIG. 35A is a diagram schematically showing a first mode of the post-processing device, FIG. 35B is a diagram schematically showing a second mode of the post-processing device, and FIG. 35C is a diagram schematically showing a third mode of the post-processing device;

FIGS. 36A to 36F are diagrams showing a post-processing operation procedure of the post-processing device according to Exemplary Embodiment 4 in time series;

FIG. 37A is a diagram showing, in a post-processing device according to Exemplary Embodiment 5, a state where a medium that requires wax post-processing passes through the post-processing device, and FIG. 37B is a diagram showing a state where a medium that does not require the wax post-processing passes through the post-processing device.

FIG. 38 is a diagram showing a major portion of a post-processing device according to Exemplary Embodiment 6;

FIG. 39A is a diagram showing an example of a microscope photograph of a surface of a medium before post-processing by a post-processing device according to Example 1, FIG. 39B is a diagram schematically showing a state of wax adhering on the surface of the medium shown in FIG. 39A, FIG. 39C is a diagram showing an example of a microscope photograph of the surface of the medium after the post-processing by the post-processing device according to Example 1, and FIG. 39D is a diagram schematically showing a state of the wax adhering on the surface of the medium shown in FIG. 39C;

FIG. 40 is a graph showing a relationship between a thickness of a thin film-like layer after post-processing of wax adhering to a medium and visibility of the wax in evaluating performance of a post-processing device according to Example 2;

FIG. 41A is a graph showing a relationship between a paper temperature before a rubbing processing and a wax offset level before the rubbing processing, and FIG. 41B is a diagram showing an example of rubbing energy of a rubbing roll required for the paper temperature for different types of paper;

FIG. 42 is a diagram showing an example of discriminating media having different surface properties using a surface information detector of a reflection optical system; and

FIG. 43A is a diagram showing that, even in a case where embossed paper and uncoated paper have the same thickness, there is a difference in transmitted light, and FIG. 43B is a diagram showing an example in which the embossed paper and the uncoated paper are discriminated from each other using a surface information detector of a transmission optical system.

### DETAILED DESCRIPTION

### Outline of Exemplary Embodiment

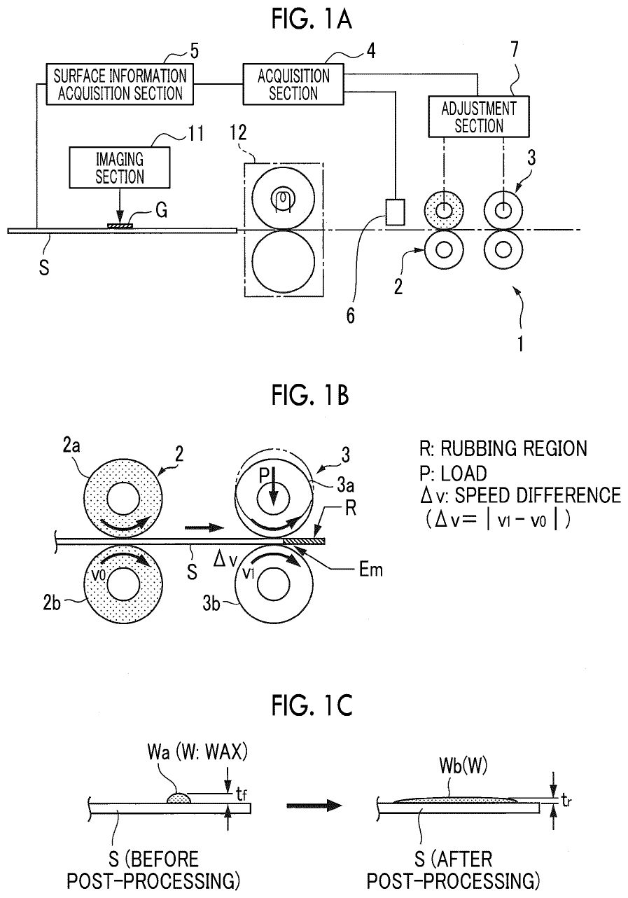

FIG. 1A shows an outline of an exemplary embodiment of an image forming system to which the present invention is applied.

In the same drawing, the image forming system includes an imaging section 11 that holds an image G formed using an imaging material containing wax on a medium S, a fixing section 12 that performs heating and pressurization to fix the image G formed by the imaging section 11 on the medium S, and a post-processing device 1 that performs post-processing on the medium S that has passed through the fixing section 12.

In the present example, as shown in FIG. 1B, the post-processing device 1 includes a transport section 2 that transports a medium S, on which an image G formed using an imaging material and wax are held and which has passed through a fixing section 12 that fixes the image G of the medium S by heating and pressurization, at a predetermined transport speed v0 by nipping the medium S, a rubbing section 3 that is located upstream or downstream of the transport section 2 in a transport direction of the medium S and that rubs a surface of the medium S such that a layer thickness after passage of the wax held on the surface of the medium S is reduced, in a case where the medium S transported by the transport section 2 passes through the rubbing section 3, an acquisition section 4 that acquires use environment information of the wax held on the medium S that has passed through the fixing section 12, and an adjustment section 7 that adjusts a rubbing condition of the rubbing section 3 based on the use environment information acquired by the acquisition section 4.

In such technical means, the medium S is not limited to a sheet-like medium cut into a predetermined size, and also includes a continuous medium such as a roll-like medium. The imaging section 11 need only form the image G formed using the imaging material (for example, a toner) containing the wax and hold the image G on the medium S. Representative examples thereof include an electrophotographic method and an electrostatic recording method, but the present invention is not limited to this. Here, the reason why the wax is contained in the imaging material is to ensure the mold releasability between the image G and a fixing member during the fixation using the heating and pressurization performed by the fixing section 12.

In addition, the fixing section 12 may be selected as appropriate as long as the fixing method using the heating and pressurization may be adopted. Representative examples thereof include an aspect in which a fixing member for heating and a fixing member for pressurization are disposed in a pressurized manner, and the medium S passes through a contact region between the fixing member for heating and the fixing member for pressurization. In this case, the fixing member may be selected as appropriate from a roll-like fixing member, a belt-like fixing member, and the like. As a heating method of the fixing member for heating, a heating source may be incorporated into the fixing member, or an aspect may be adopted in which the heating is performed outside the fixing member. Further, a cleaning element for cleaning the wax, paper dust, and the like transferred to the fixing member may be additionally provided in the fixing member for heating. Further, a heating source or a cleaning element may be added to the fixing member for pressurization as necessary.

Further, the post-processing device 1 is built in, for example, an image forming unit in which the imaging section 11 and the fixing section 12 are mounted. However, the present invention is not limited to this aspect, and the post-processing device 1 may be configured as an independent unit separate from the image forming unit. In this case, the post-processing device 1 may be installed alongside the image forming unit to construct the image forming system. Alternatively, the post-processing device 1 may be installed by not being alongside the image forming unit and used to perform the post-processing on the medium S that is once output from the image forming unit.

In the present example, in order for the medium S to pass through the post-processing device 1, an element for feeding the medium S and an element for taking out the medium S are provided before and after a transport path of the medium S in the post-processing device 1. The transport section 2 may be selected as appropriate as long as the transport section 2 transports the medium S at the predetermined transport speed v0 by nipping the medium S. The transport speed v0 referred to here is selected in consideration of a feeding speed of the medium S fed to the post-processing device 1 or a taking-out speed of the medium S taken out from the post-processing device 1. In addition, the transport section 2 need only include a plurality of transport members (for example, a plurality of rotating bodies 2a and 2b) that transport the medium S by nipping the medium S.

In the present example, the rubbing section 3 is located upstream or downstream of the transport section 2 in the transport direction of the medium S and is required to rub the surface of the medium S. The meaning of “surface of the medium S” referred to here is not limited to the front surface of the medium S and also includes the back surface. Therefore, an aspect is representative in which the rubbing section 3 rubs both the front and back surfaces of the medium S as rubbing targets, but a configuration is also included in which any one of the front surface or the back surface of the medium S is rubbed as the rubbing target.

As the configuration example of the rubbing section 3, the rubbing section 3 may be fixedly installed without being limited to the movable aspect as long as the rubbing section 3 has an effect of coming into contact with the medium S and rubbing the surface of the medium S.

Further, the rubbing operation using the rubbing section 3 may be selected as appropriate as long as a layer thickness tr after the passage of the wax held on the surface of the medium S is equal to or less than a value required for making the wax on the medium S less visible in a case where the medium S transported by the transport section 2 passes through the rubbing section 3. According to the experiment by the inventors of the present invention, it has been confirmed that the wax is effective in making the wax less visible in a case where the layer thickness tr of the wax is equal to or less than 0.15 μm.

This point will be specifically described as follows. In a case where the wax is transferred to the surface of the medium S that has passed through the fixing section 12, as shown in FIG. 1C, wax W is deformed to be rounded by the surface tension in a procedure of being cooled and solidified, and a granular mass (lump) Wa is likely to be formed. In this case, in a case where, for example, a transparent film of which the surface is smooth is used as the medium S, light is scattered by a granular mass Wa portion (layer thickness tf), and thus the granular mass Wa is whitened and visualized.

In the present example, as shown in FIG. 1B, the post-processing device 1 rubs the surface of the medium S by the rubbing section 3. Therefore, in a rubbing region R rubbed by the rubbing section 3, the wax W in the granular mass Wa can be smoothed to form a thin film-like layer Wb. Here, in a case where the layer thickness tr (tr<tf) of the thin film-like layer Wb is selected to an appropriate level, the visualization phenomenon of the wax W due to the scattering of the transmitted light or the reflected light on the medium S is reduced, and the wax W on the medium S is less visible.

In addition, a target acquired by the acquisition section 4 is use environment information of the wax held on the medium S that has passed through the fixing section 12. The use environment information of the wax referred to here may be selected as appropriate as long as information that affects a wax rubbing behavior is included. Representative examples of the use environment information include “surface information related to a surface state of the medium” and “temperature information of the medium” that affects the viscosity of the wax. However, an aspect in which the rubbing condition of the rubbing section 3 is adjusted based on any one information is also included. For example, there is an aspect in which the rubbing condition is adjusted between metallic paper and other types of paper, or there is an aspect in which the rubbing condition is adjusted based on the temperature information of the medium S in a case where the rubbing processing by rubbing section 3 is performed on a specific medium S.

In addition, the adjustment section 7 adjusts the rubbing condition of the rubbing section 3 based on the use environment information of the wax to set an amount of crush deformation of the wax to an appropriate amount. In a case where the amount of crush deformation of the wax is insufficient, the stain due to the wax is conspicuous, and in a case where the amount of crush deformation of the wax is excessive, the medium S is likely to be damaged.

Next, a representative aspect or a desired aspect of the post-processing device 1 according to the present exemplary embodiment will be described.

First, as a desired aspect of the acquisition section 4, the acquisition section 4 acquires the surface information related to the surface state of the medium S and the temperature information of the medium S, as the use environment information of the wax. In this case, the acquisition section 4 need only include a surface information acquisition section 5 that acquires the surface information related to the surface state of the medium S, and a temperature information acquisition section 6 that acquires the temperature information of the medium S located between the fixing section 12 and the rubbing section 3.

Here, as a representative aspect of the surface information acquisition section 5, there is an aspect in which the smoothness or the surface roughness of the medium S is acquired as the surface information. In addition, as another representative aspect, there is an aspect in which the presence or absence of a metal layer on a substrate of the medium S is acquired as the surface information. As the medium S having the metal layer on the substrate, there is so-called metallic paper. In this case, the present invention is not limited to an aspect in which the metal layer is exposed on the surface of the medium S, and there is also an aspect in which a surface of the metal layer is covered with a protective layer such as a resin.

In some image forming systems, the medium S to be used is determined in advance. In this type of the image forming system, it is also possible to store the type of the medium S to be used and the surface information in a memory or the like in advance and to acquire the surface information of the medium S by designating the type of the medium S as the surface information acquisition section 5.

In addition, as a desired aspect of the surface information acquisition section 5, there is an aspect in which the surface information acquisition section 8 is provided upstream of the rubbing section 3 in the transport direction of the medium S, and includes a detection section that detects the surface information in a case where the medium S has passed through the detection section. As the detection section referred to here, there is a section for optically detecting the smoothness or the surface roughness of the medium S. In addition, as the detection section, there is a section that can detect the presence or absence of the metal layer on the substrate of the medium S. In this case, in the medium S having the metal layer on the substrate, the optical detection can be performed, as well as electrical detection can also be performed by utilizing the conduction of the metal layer.

In addition, as a representative aspect of the temperature information acquisition section 6, there is an aspect in which the temperature information acquisition section 6 includes a temperature detection section that detects the surface temperature of the medium S. In a case of the present example, for example, an aspect is preferable in which the temperature detection section is disposed closer to the rubbing section 3 than the fixing section 12. This aspect is effective in acquiring the temperature information of the wax immediately before the rubbing processing by the rubbing section 3 is performed.

In addition, a representative aspect of the adjustment section 7, there is an aspect in which the adjustment section 7 adjusts a rubbing energy Em applied to the wax held on the medium S as the rubbing condition of the rubbing section 3.

In the present example, the adjustment section 7 makes any one or both of a rubbing load for pressing the surface of the medium S and a speed difference Δv between the transport section 2 and the rubbing section 3 variable in a case of adjusting the rubbing energy Em. Here, the speed difference Δv=|v1−v0|. Here, v1 means the transport speed of the medium S by the rubbing section 3.

As a representative aspect of the adjustment section 7 of this type, there is an aspect in which the adjustment section 7 acquires the smoothness or the surface roughness of the medium S as the use environment information of the wax by the acquisition section 4, and adjusts, depending on the smoothness or the surface roughness of the medium S, the rubbing energy to be larger in a case where the medium S is less smooth than in a case where the medium S is smoother.

In addition, as another representative aspect of the adjustment section 7, there is an aspect in which the acquisition section 4 acquires the presence or absence of the metal layer on the substrate of the medium S as the use environment information of the wax, and varies the rubbing energy in a case where the medium S has the metal layer on the substrate as compared with the medium which does not have the metal layer on the substrate. For example, in an aspect (metallic paper or aluminum vapor deposition paper) in which the metal layer is exposed on the surface, the metal layer has a mirror surface, and thus the visibility of rubbing scratches is high. In this case, even in a case where the smoothness is the same as the smoothness of the medium having no metal layer on the substrate, for example, it is preferable to select a low rubbing energy such that the metal layer is not damaged.

Further, as a desired aspect of the adjustment section 7, there is an aspect in which the adjustment section 7 acquires the temperature information of the medium as the use environment information of the wax by the acquisition section 4, and adjusts, depending on the temperature information of the medium S, the rubbing energy to be larger in a case where the temperature of the medium S is lower than in a case where the temperature of the medium S is higher.

In the present example, as a representative aspect of the rubbing section 3, there is an aspect in which the rubbing section 3 consists of a plurality of rotating bodies 3a and 3b that are disposed to face each other with respect to the medium S and that are able to come into contact with each other and separable from each other between a contact position at which the plurality of rotating bodies 3a and 3b are in contact with the medium S and a non-contact position, and rubs the surface of the medium S in a case where the plurality of rotating bodies 3a and 3b are disposed at the contact position.

In this case, for example, it is preferable that, in a case where the plurality of rotating bodies 3a and 3b constituting the rubbing section 3 are disposed at the contact position, a frictional force between the transport section 2 and the medium S is greater than a frictional force between the rubbing section 3 and the medium S.

In addition, for example, it is preferable that the plurality of rotating bodies 3a and 3b constituting the rubbing section 3 are disposed at the contact position in a case where the transport section 2 transports the medium, and are disposed at the non-contact position in a case where the transport section 2 does not transport the medium.

Hereinafter, the present invention will be described in more detail based on the exemplary embodiments shown in the accompanying drawings.

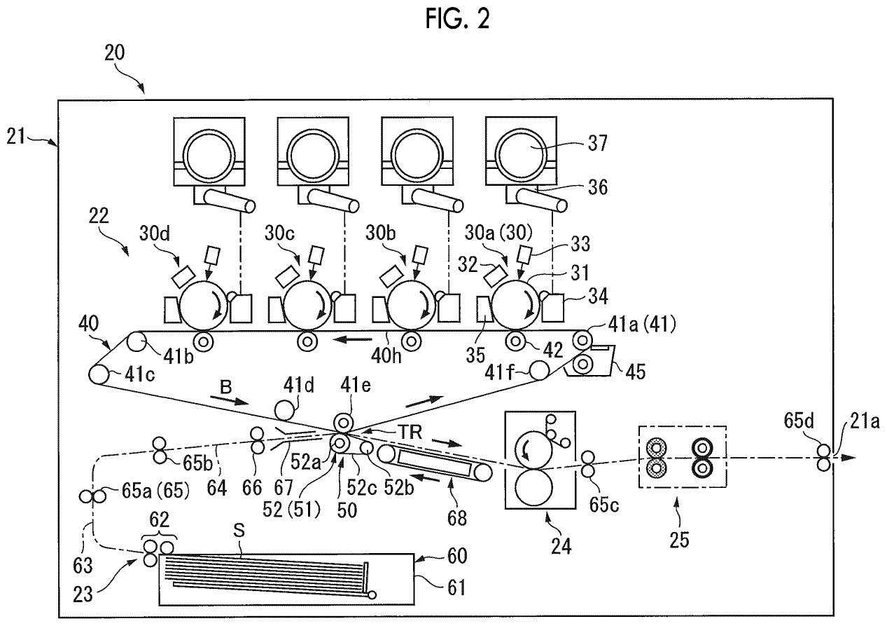

FIG. 2 shows an overall configuration of an image forming system according to Exemplary Embodiment 1.

### Overall Configuration of Image Forming System

In the same drawing, an image forming system 20 includes a unit housing 21 having a required external appearance shape. Major elements such as an imaging engine 22, a medium transport system 23, a fixing device 24, and a post-processing device 25 are mounted in an internal space of the unit housing 21.

### Imaging Engine

In the present example, the imaging engine 22 corresponds to the imaging section 11 shown in FIGS. 1A and 1B.

In FIG. 2, the imaging engine 22 includes a plurality of (four in the present example) image forming portions 30 (specifically, 30a to 30d) that form images of a plurality of (four in the present example) color components, an intermediate transfer body 40 that sequentially performs primary transfer of the images of the respective color components formed by the plurality of image forming portions 30 to hold the images, and that transports the images to a position for the transfer to the medium, and a transfer device 50 that performs secondary (batch) transfer of the images of the respective color components held by the intermediate transfer body 40 to the medium.

In the present example, the respective image forming portions 30 (30a to 30d) form the images of the respective color components of yellow (Y), magenta (M), cyan (C), and black (K). The arrangement of the image forming portions 30 may be changed as appropriate, and it goes without saying that a portion that forms the image of another color component (white, transparent, spot color of special color component, or the like) may also be included in the plurality of image forming portions 30. In the present example, the image forming portion 30 is configured to form the images of a plurality of color components, but may form, for example, a monochromatic image of only black (K). Further, in the present example, the imaging engine 22 forms the image on the medium via the intermediate transfer body 40, but the imaging engine 22 may directly form the image on the medium without passing through the intermediate transfer body 40.

### Image Forming Portion

In the same drawing, each of the image forming portions 30 (30a to 30d) adopts an electrophotographic method. In the present example, each of the image forming portions 30 (30a to 30d) has a photoconductor 31 that rotates in a predetermined direction. Then, devices such as a charger 32, an exposure device 33, a developing device 34, and a cleaning device 35 are disposed in order around the photoconductor 31.

Here, the photoconductor 31 is formed in, for example, a drum shape and has a photosensitive layer serving as an image forming surface and an image holding surface, on a surface thereof. In addition, the charger 32 charges an outer peripheral surface of the photoconductor 31 to a required surface potential. As the charger 32, for example, a non-contact charging method using a corona discharge or a contact charging method using a charging roll is adopted.

Further, the exposure device 33 irradiates the outer peripheral surface of the photoconductor 31 with light in accordance with image information to form an electrostatic latent image for each color component image. As the exposure device 33, a light irradiation device such as a laser scanner or an LED array is used. In the present example, the exposure device 33 is individually provided for each of the image forming portions 30 (30a to 30d), but a part or all of the exposure devices 33 may be commonly used.

In addition, the developing device 34 uses a developer containing each color component toner as an example of the imaging material, and develops each electrostatic latent image on the photoconductor 31 as an image formed using each color component toner. The toner in the developer contains an appropriate amount of wax. This wax is mostly used to ensure the mold releasability between the fixing member of the fixing device 24 and the image on the medium. Further, a toner replenishing mechanism 36 is provided in an upper space portion of the developing device 34 of each image forming portion 30, and is connected to each developing device 34 in communication. A toner cartridge 37 including a container that accommodates a toner for replenishment is attachably and detachably provided in each toner replenishing mechanism 36.

In addition, the cleaning device 35 is provided downstream of a primary transfer portion of the photoconductor 31 to the intermediate transfer body 40 in a rotation direction of the photoconductor 31. The cleaning device 35 cleans the residues such as the toner remaining on the photoconductor 31 after the primary transfer.

In the present example, the electrophotographic method using the photoconductor 31 and the exposure device 33 is adopted, but the present invention is not limited to this, and it goes without saying that the electrostatic recording method using a dielectric and an ion flow recorder may be adopted.

### Intermediate Transfer Body

In the present example, the intermediate transfer body 40 consists of, for example, an endless belt member made of a polyimide resin or the like. The intermediate transfer body 40 is stretched over a plurality of (six in the present example) tension rolls 41 (specifically, 41a to 41f). In the present example, among the plurality of tension rolls 41, for example, the tension roll 41a is used as a driving roll, and the other tension rolls 41b to 41f are used as driven rolls. In the present example, the photoconductors 31 of the image forming portions 30 are arranged at predetermined intervals to face a horizontal portion 40h of the intermediate transfer body 40, which is stretched between the tension rolls 41a and 41b.

On a back surface of the horizontal portion 40h of the intermediate transfer body 40, the primary transfer device 42 is provided to face the photoconductor 31 of each image forming portion 30. Each primary transfer device 42 electrostatically transfers the image formed by each image forming portion 30 to the intermediate transfer body 40. Here, the primary transfer device 42 may be selected as appropriate as long as the primary transfer device 42 causes a transfer electric field for attracting the image on the photoconductor 31 to the intermediate transfer body 40 side to act. For example, a transfer member (for example, a transfer roll, a discharge wire for generating a corona discharge, or the like) need only be installed to face the photoconductor 31, and a transfer voltage for primary transfer need only be applied to the transfer member.

Further, an intermediate transfer body cleaning device 45 is provided on an outer peripheral surface of the intermediate transfer body 40, which is stretched over the tension roll 41a. The intermediate transfer body cleaning device 45 cleans the residues such as the toner, paper dust, and the like remaining on the intermediate transfer body 40 after the image is transferred to the medium.

### Transfer Device

In the present example, the transfer device 50 is provided on an outer peripheral surface of the intermediate transfer body 40, which is stretched over the tension roll 41e. The transfer device 50 electrostatically transfers the image held on the intermediate transfer body 40 to the medium. Here, the transfer device 50 may be selected as appropriate as long as the transfer device 50 causes a transfer electric field for attracting the image on the intermediate transfer body 40 to the medium side to act. For example, the transfer member 51 need only be installed to face the tension roll 41e of the intermediate transfer body 40, and a transfer voltage for secondary transfer need only be applied to the transfer member 51 or the tension roll 41e to form a transfer electric field for secondary (batch) transfer between the transfer member 51 and the tension roll 41e. In the present example, a transfer belt module 52 is adopted as the transfer member 51. The transfer belt module 52 has an aspect in which a transfer belt 52c is stretched between a transfer roll 52a and a peeling roll 52b. In the present example, a transfer electric field is formed between the transfer roll 52a and the tension roll 41e, and an action region of the transfer electric field acts as a transfer region TR. The medium S receives the image transfer operation in the transfer region TR, passes through the transfer region TR, is guided along the transfer belt 52c, and is peeled off by the peeling roll 52b.

The transfer member 51 is not limited to the transfer belt module 52, and an aspect in which only the transfer roll is used or a discharge wire using a corona discharge or the like may be selected as appropriate.

### Medium Transport System

In the present example, the medium transport system 23 includes a medium supply device 60 that supplies the medium S. In the present example, a sheet-like medium S cut to a predetermined size is used. This medium supply device 60 accommodates the medium S in an accommodation container 61 and sends out the medium S one by one by a feeder 62. In the present example, one accommodation container 61 is provided, but a plurality of accommodation containers 61 may be provided.

In addition, a vertical transport path 63 that transports the medium S supplied from the medium supply device 60 in a substantially vertical direction is provided in the unit housing 21. A horizontal transport path 64 that transports the medium S in a substantially horizontal direction is provided on an upper side of the vertical transport path 63. Here, the horizontal transport path 64 extends to a discharge port 21a open in a side wall of the unit housing 21. In addition, a medium discharge receiver (not shown) that receives the discharged medium S is provided outside the discharge port 21a of the unit housing 21. An appropriate number of transport rolls 65 (specifically, 65a to 65d) are provided in the vertical transport path 63 and the horizontal transport path 64. The transport roll 65d provided immediately before the discharge port 21a functions as a discharge roll that discharges the medium S to the medium discharge receiver.

Further, in the horizontal transport path 64, an alignment roll 66 is provided upstream of the transfer region TR of the transfer device 50 in the transport direction of the medium S. The alignment roll 66 aligns the leading end of the medium S supplied from the medium supply device 60 and then sends out the medium S toward the transfer region TR at an appropriate timing. Further, a guide member 67 that guides the medium S toward the transfer region TR is provided between the alignment roll 66 and the transfer region TR.

In addition, in the horizontal transport path 64, a transport belt 68 is provided downstream of the transfer device 50 in the transport direction of the medium S. The transport belt 68 transport the medium S on which the unfixed image is held, by stably holding the medium S in a state of being electrostatically attracted.

Further, in the horizontal transport path 64, the fixing device 24 is provided downstream of the transport belt 68 in the transport direction of the medium S. In the horizontal transport path 64, the post-processing device 25 is provided downstream of the fixing device 24 in the transport direction of the medium S.

In the present example, the medium transport system 23 has the aspect in which only the vertical transport path 63 and the horizontal transport path 64 are provided, but the present invention is not limited to this. For example, a reversible branch transport path (not shown) that branches downward between the fixing device 24 and the post-processing device 25 may be provided in the horizontal transport path 64. In the aspect in which the branch transport path is provided, the medium reversed by the branch transport path may be returned to the vertical transport path 63 again from the horizontal transport path 64 through a return transport path. In this case, it is possible to transfer the image to the back surface of the reversed medium in the transfer region TR. In addition, a branch return transport path that branches from the middle in the branch transport path may be provided, and the reversed medium may be discharged to the medium discharge receiver outside the unit housing 21.

### Fixing Device

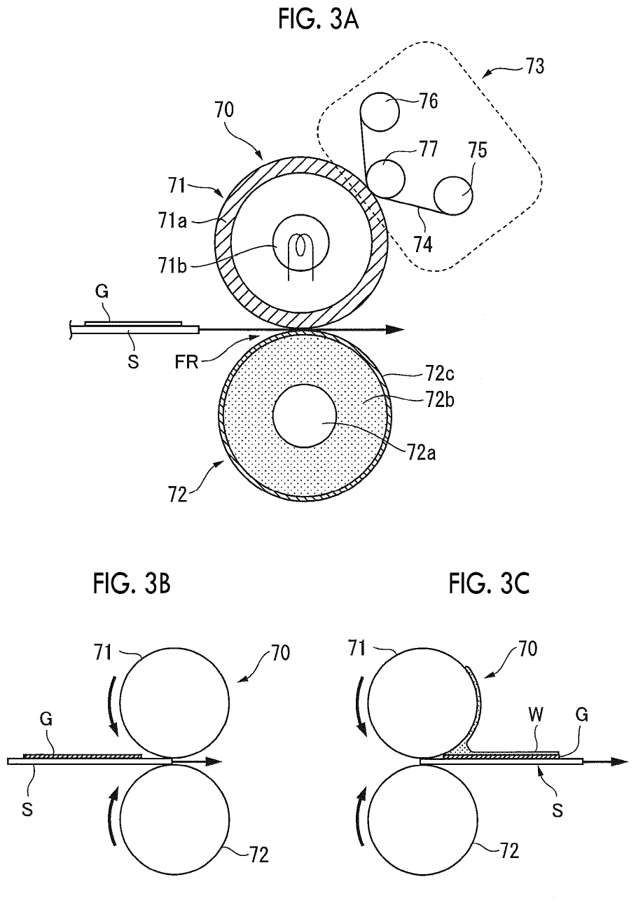

In the present example, as shown in FIG. 3A, the fixing device 24 performs heating and pressurization to fix the image G on the medium S. The fixing device 24 includes a heating roll 71 as the fixing member for heating and a pressure roll 72 as the fixing member for pressurization. The heating roll 71 is disposed in contact with an image holding surface side of the medium S and rotates via a drive force from a drive source (not shown). On the other hand, the pressure roll 72 is disposed to face the heating roll 71 in a strongly pressed manner and rotates following the heating roll 71. Therefore, the fixing device 24 allows the image G formed using the toner held on the medium S to pass through a fixing region FR between the heating roll 71 and the pressure roll 72, and performs heating and pressurization to fix the image G.

In the present example, the heating roll 71 is formed in an aspect in which a heater 71b is built in a roll body 71a made of metal having a high thermal conductivity. Here, a heating method of the heating roll 71 is not limited to this, and the roll body 71a may be heated by bringing an external heater (not shown) into contact with an outer peripheral surface of the roll body 71a.

On the other hand, the pressure roll 72 is formed by laminating a heat-resistant elastic layer 72b around a core bar 72a made of metal, and coating a surface of the elastic layer 72b with a protective layer 72c. A heater may be added to the pressure roll 72 as necessary.

In the present example, the medium S is allowed to, in a state of being nipped by the elastic deformation of the pressure roll 72, pass through the fixing region FR between the heating roll 71 and the pressure roll 72 and the image G on the medium S is heated and pressurized.

In the present example, the fixing device 24 has a roll pair configuration, but the present invention is not limited to this, and the fixing device 24 may be selected as appropriate, for example, to be configured with a heating belt in which an electromagnetic induction heating method is adopted, instead of the heating roll 71.

### Cleaning Mechanism

In the present exemplary embodiment, the heating roll 71 of the fixing device 24 is provided with a cleaning mechanism 73. The cleaning mechanism 73 mostly reduces a wax component in the toner adhering to the heating roll 71.

Here, the reason why the wax component adheres to the heating roll 71 will be briefly supplemented.

In general, the toner used in the developing device 34 of the image forming portion 30 contains the wax. Therefore, as shown in FIG. 3A, the image G formed using the toner transferred to the medium S contains the wax component. In this state, as shown in FIGS. 3B and 3C, in a case where the medium S holding the image G passes through the fixing region FR of the fixing device 24, the image G is fixed on the medium S in the fixing region FR by performing heating and pressurization. In this case, a situation occurs in which a portion of the wax W on a toner surface is transferred from the image G portion to the heating roll 71 by the heating.

In the present example, as shown in FIG. 3A, the cleaning mechanism 73 adopts a method of pressing and moving the cleaning member in a rubbing manner on the surface of the heating roll 71. Specifically, the cleaning mechanism 73 includes a cleaning web 74, a delivery roll 75, a winding roll 76, and a pressing roll 77. Here, the cleaning web 74 is, for example, an example of a cleaning member consisting of a heat-resistant nonwoven fabric or the like. The delivery roll 75 is an example of a delivery member around which the cleaning web 74 is wound in a state of being braked to be delivered. The winding roll 76 is an example of a winding member around which the used part of the cleaning web 74 is wound to be wound. Further, the pressing roll 77 is an example of a pressing member that presses the cleaning web 74 stretched between the delivery roll 75 and the winding roll 76 against the heating roll 71.

With the cleaning mechanism 73 according to the present example, the cleaning web 74 is pressed and moved in a rubbing manner on the surface of the heating roll 71. In this case, since the cleaning web 74 is made of a heat-resistant nonwoven fabric or the like, the liquefied wax W is absorbed by the capillary phenomenon on the surface of the heating roll 71. In the present example, it is effective to gradually wind the cleaning web 74 in terms of increasing an absorption life of the cleaning web 74.

### Issue of Cleaning Mechanism

The cleaning mechanism 73 according to the present example has the following issue.

In the cleaning mechanism 73 according to the present example, the cleaning web 74 has a structure in which the cleaning web 74 comes into contact with the rotating heating roll 71 only once in principle. Therefore, there may be a case where the wax W cannot be sufficiently absorbed due to the capillary phenomenon in a case where the cleaning web 74 comes into contact with the wax W which is liquefied but still has viscosity only once.

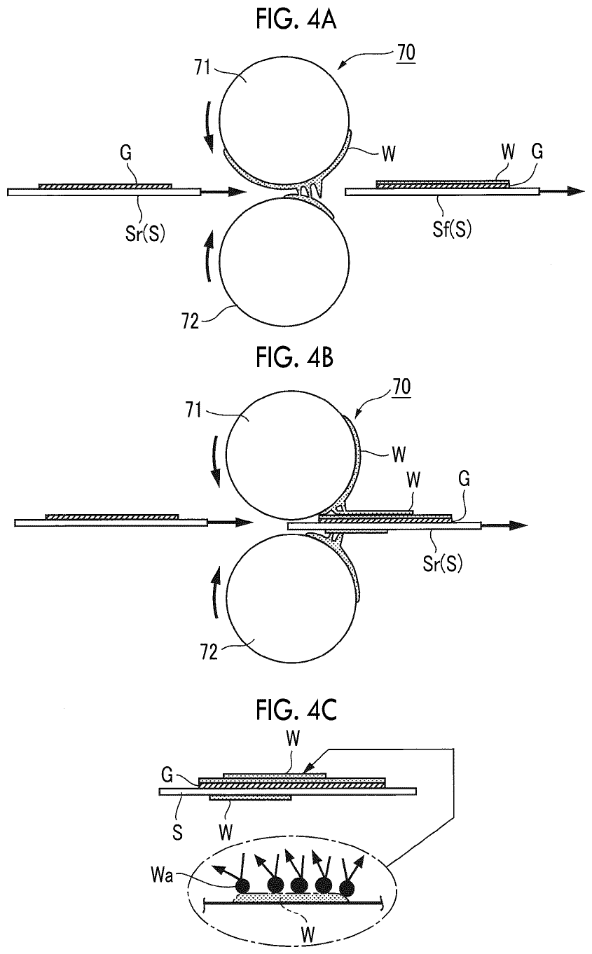

In this case, as shown in FIG. 4A, a situation before a preceding medium Sf exits the fixing region FR of the fixing device 24 and the subsequent medium Sr enters the fixing region FR of the fixing device 24 is assumed. In an inter-image region between the preceding medium Sf and the subsequent medium Sr (region between the media S), the heating roll 71 and the pressure roll 72 are in a state of being in direct contact with each other in the fixing region FR. In this state, a portion of the wax W transferred to the heating roll 71 is not cleaned by the cleaning mechanism 73 (see FIG. 3A) and slips. In this case, a situation may occur in which the wax W is transferred from the heating roll 71 to the pressure roll 72.

Thereafter, as shown in FIG. 4B, in a case where the subsequent medium Sr passes through the fixing region FR, a situation occurs in which the wax W transferred to the heating roll 71 and the pressure roll 72 is counter-transferred to the front surface and the back surface of the medium S.

Therefore, the wax W may remain on the surface of the medium S even after the fixation using the fixing device 24. In this case, as shown in FIG. 4C, the wax W remaining on the medium S is aggregated in a granular form and solidified along with the cooling of the medium S, and is changed to the granular mass Wa. In this state, for example, in a case where the medium S is a transparent film medium, a situation may occur in which the reflected light or the transmitted light to the medium S is scattered by the granular mass Wa, and the wax trace is visualized. In this way, in a case where the wax trace is visualized, the wax trace is manifested as a contamination or an image defect of the medium S.

In order to eliminate such a situation, for example, it is considered to increase the number of times of contact between the heating roll 71 and the cleaning web 74 of the cleaning mechanism 73. However, this measure requires the rotation of the heating roll 71 to be continued for a long time, and the fixing processing using the fixing device 24 is required to be waited for during the time, so that it cannot be said that this measure is a desired measure.

In the present example, although the cleaning mechanism 73 is provided only on the heating roll 71, it goes without saying that the cleaning mechanism 73 may be provided on the pressure roll 72 side, but even in a case where the cleaning mechanism 73 is added to both the heating roll 71 and the pressure roll 72, it is difficult to completely remove the wax W that slips through the cleaning mechanism 73 on the heating roll 71 and the pressure roll 72.

### Peripheral Configuration Example of Post-Processing Device

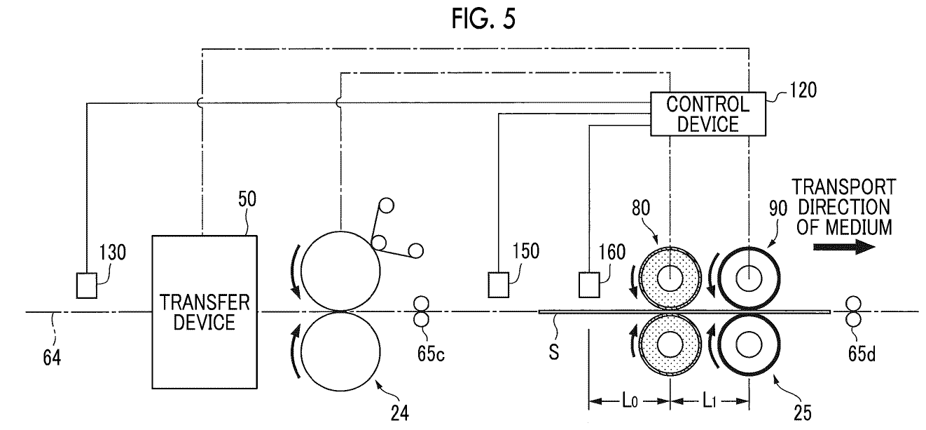

In the present exemplary embodiment, as shown in FIG. 5, the post-processing device 25 is provided downstream of the fixing device 24 in the transport direction of the medium S, in consideration of a possibility that the wax W remains on the medium S that has passed through the fixing device 24.

In the present example, the post-processing device 25 performs the post-processing of changing the wax remaining on the medium S from a visible state (granular mass) to a less visible state (smoothed state). This is to suppress a light scattering phenomenon caused by the granular mass Wa by spreading and smoothing the granular mass Wa via the rubbing operation.

In the present example, as shown in FIG. 5, a surface information detector 130 is provided upstream of the transfer device 50 in the transport direction of the medium S in the horizontal transport path 64. The surface information detector 130 detects surface information related to the surface state of the medium S. In the present example, it is assumed that the “surface state of the medium S” is the smoothness or the surface roughness of the medium S or the presence or absence of the metal layer on the substrate (whether or not the medium S is so-called metallic paper). The details of the surface information detector 130 will be described later.

In addition, as shown in FIG. 5, a temperature detector 150 is provided downstream of the fixing device 24 in the transport direction of the medium S in the horizontal transport path 64. The temperature detector 150 is disposed upstream of the post-processing device 25 in the transport direction of the medium S. The temperature detector 150 is configured with, for example, a radiation thermometer, and detects the surface temperature of the medium S to be transported, in a non-contact manner.

In the present example, the temperature detector 150 need only be provided in any of the horizontal transport paths 64 between the fixing device 24 and the post-processing device 25. However, in order to detect the surface temperature of the medium S immediately before the medium S enters the post-processing device 25, for example, it is preferable to dispose the temperature detector 150 closer to the post-processing device 25.

Further, in the present example, a position detector 160 is provided between the temperature detector 150 and the post-processing device 25 in the horizontal transport path 64. The position detector 160 is configured with, for example, a photo sensor, and detects a timing at which the leading end or the trailing end of the medium S has passed through the position detector 160.

Further, in the present exemplary embodiment, as shown in FIG. 5, a control device 120 that controls the respective elements (imaging engine 22 (including transfer device 50), medium transport system 23, fixing device 24, post-processing device 25, and the like) of the image forming system 20 is provided.

The surface information detector 130, the temperature detector 150, and the position detector 160 are connected to the control device 120 via an I/O port.

In FIG. 5, reference numerals 65c and 65d denote the transport rolls that transport the medium S.

### Surface Information Detector

### Configuration Example 1 of Surface Information Detector

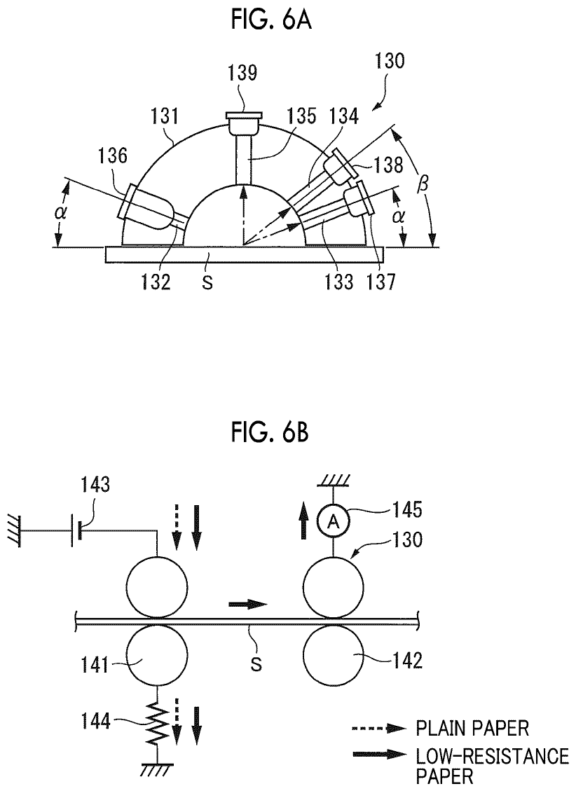

In the present example, as shown in FIG. 6A, in the surface information detector 130, a plurality of waveguides 132 to 135 are formed in an arch-shaped housing 131 made of metal. A first waveguide 132 is an irradiation waveguide that is disposed at an angle α (for example, 15 to 30) with respect to the surface of the medium S toward a center portion (corresponding to a light irradiation portion) of the arch-shaped housing 131. A second waveguide 133 is a waveguide that is disposed at a position symmetrical to the first waveguide 132 toward the center portion of the arch-shaped housing 131 and that receives specularly reflected light. A third waveguide 134 is a waveguide that is disposed on the same side as the second waveguide 133 toward the center portion of the arch-shaped housing 131, that is disposed at an angle β (β>α) with respect to the surface of the medium S, and that receives diffused light. A fourth waveguide 135 is a waveguide that receives the diffused light from the center portion of the arch-shaped housing 131 in the vertical direction.

In addition, in the present example, a light emitting element 136, such as an LED, is provided on an outer peripheral side of the first waveguide 132. In addition, light receiving elements 137 to 139, such as photodiodes, are provided on an outer peripheral side of the second to fourth waveguides 133 to 135.

Therefore, in the present example, it is assumed that the surface of the medium S located at the center portion of the arch-shaped housing 131 is irradiated with irradiation light from the light emitting element 136. In this case, the specularly reflected light from the surface of the medium S is detected by the light receiving element 137, and the diffused light from the surface of the medium S is detected by the light receiving elements 138 and 139.

In this case, the medium S of which a surface is smoother has a higher proportion of the specularly reflected light, so that the smoothness or the surface roughness is grasped by using a ratio of the specularly reflected light to the diffused light.

In addition, the surface information detector 130 according to the present example can also discriminate whether or not the medium S is the metallic paper having the metal layer on the substrate. For example, a threshold value of a specularly reflected light level unique to the metallic paper need only be selected, to discriminate the metallic paper by comparing the threshold value with the specularly reflected light level.

### Configuration Example 2 of Surface Information Detector

In the present example, the surface information detector 130 detects whether or not the paper is low-resistance paper by using the physical properties of the low-resistance paper such as metallic paper.

As shown in FIG. 6B, the surface information detector 130 is provided with a pair of discrimination rolls 141 and a pair of discrimination rolls 142 arranged alongside each other along the transport direction of the medium S. Here, a discrimination power supply 143 is connected to one of the pair of discrimination rolls 141 located on the upstream side in the transport direction of the medium S. The other of the pair of discrimination rolls 141 is grounded via a resistor 144. In addition, an ammeter 145 is provided between one of the pair of discrimination rolls 142 located on the downstream side in the transport direction of the medium S and the ground. The discrimination rolls 141 and 142 may also serve as the transport members (transport rolls 65 and alignment rolls 66) of the medium S, or may be provided separately from the transport members.

In the present example, for example, it is assumed that plain paper (that is included in non-low-resistance paper other than low-resistance paper) is used as the medium S. In this case, even in a case where the plain paper is disposed to straddle between the pair of discrimination rolls 141 and the pair of discrimination rolls 142, the surface resistance of the plain paper is large to some extent, and thus the following operation is performed. That is, the discrimination current from the discrimination power supply 143 flows to cross the pair of discrimination rolls 141 as indicated by a dashed line in FIG. 6B. Therefore, there is almost no discrimination current that is transmitted through the medium S to reach the ammeter 145 on the discrimination roll 142 side.

On the other hand, it is assumed that the low-resistance paper such as the metallic paper is used as the medium S. In this case, in a case where the low-resistance paper is disposed to straddle between the pair of discrimination rolls 141 and the pair of discrimination rolls 142, the surface resistance of the low-resistance paper is smaller than the surface resistance of the plain paper, and thus the following operation is performed. That is, as shown by a solid line in FIG. 6B, a part of the discrimination current from the discrimination power supply 143 flows across the pair of discrimination rolls 141. In addition, the remaining part of the discrimination current is transmitted through the medium S to reach the ammeter 145 on the discrimination roll 142 side. Therefore, the surface resistance of the medium S is calculated by a measurement current measured by the ammeter 145 and an applied voltage of the discrimination power supply 143, and the medium type is discriminated.

### Others

In the present example, as a representative example of the surface information of the medium S, the smoothness or the surface roughness of the medium, or information on whether or not the metal layer is provided on the substrate is adopted, but the transparency, affinity, and the like of the surface portion of the medium may be included as necessary.

### Basic Configuration of Post-Processing Device

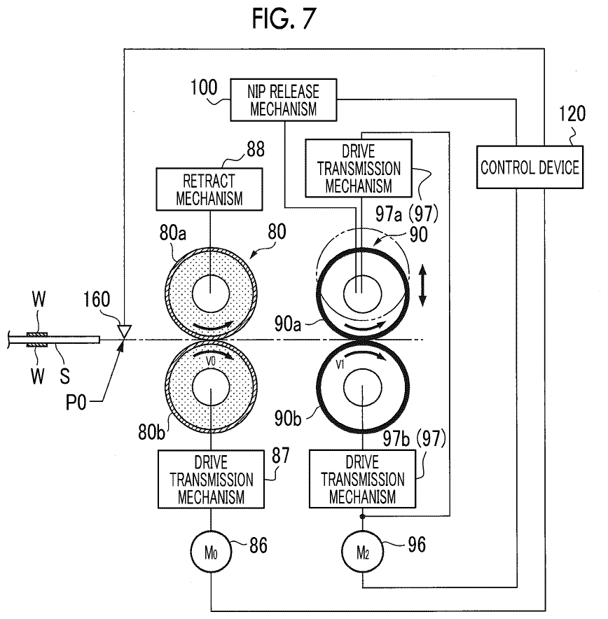

FIG. 7 is a diagram showing a major portion of the post-processing device according to Exemplary Embodiment 1.

In the same drawing, the post-processing device 25 includes a transport roll 80 as a transport section that transports the medium S that has passed through the fixing device 24 at a predetermined transport speed v0, and a rubbing roll 90 as a rubbing section that is located downstream of the transport roll 80 in the transport direction of the medium S and that rubs the surface of the medium S in the same direction as the transport direction of the medium S at a speed v1 that is higher than the transport speed v0, and the transport roll 80 and the rubbing roll 90 are mounted in a housing (not shown) in an appropriate arrangement. In the housing (not shown), an inlet opening and an outlet opening for the medium S to pass through are formed.

In the present example, the rubbing roll 90 is configured to rub both the front and back surfaces of the medium S. This is because there is a possibility that the wax is transferred to both the front and back surfaces of the medium S that has passed through the fixing device 24.

### Transport Roll

### Configuration Example and Drive Method of Transport Roll

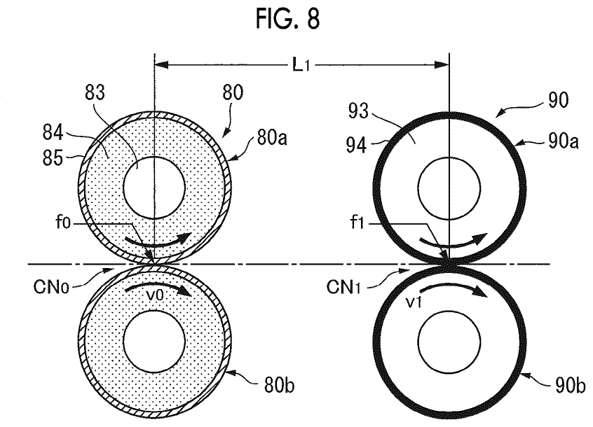

In the present example, as shown in FIGS. 7 and 8, the transport roll 80 consists of the plurality of rotating bodies 80a and 80b that are disposed to face each other with respect to the medium S. The rotating bodies 80a and 80b constituting the transport roll 80 have a structure in which a solid shaft 83 made of metal such as SUS is covered with an elastic layer 84 such as silicone rubber, and a mold-releasing layer 85 such as PFA for preventing the wax adhesion is provided on a surface of the elastic layer 84.

In the present example, the plurality of rotating bodies 80a and 80b are disposed in contact with each other, and the medium S is nipped in a contact region CN0 between the rotating bodies 80a and 80b and transported. Here, in the transport roll 80, among the plurality of rotating bodies 80a and 80b, for example, the rotating body 80b located on the lower side is a driving roll, and the rotating body 80a located on the upper side is a driven roll. Then, a drive force from a drive motor 86 is transmitted to the rotating body 80b as a driving roll via a drive transmission mechanism 87 such as a drive transmission gear train.

### Retract Configuration Example of Transport Roll

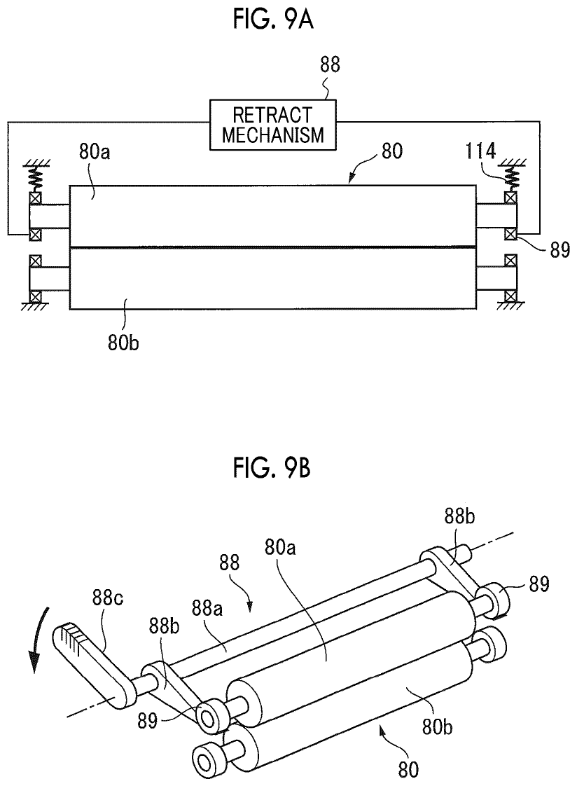

In the present example, as shown in FIGS. 7, 9A, and 9B, a retract mechanism 88 as a retractable retract section is provided in one rotating body 80a of the transport roll 80. The retract mechanism 88 supports both ends of the shaft 83 of one rotating body 80a, and releases a nip state (corresponding to a contact state between the plurality of rotating bodies 80a and 80b) of the transport roll 80, for example, in a case where the medium S is jammed. In the present example, as shown in FIG. 9B, the retract mechanism 88 has, on both sides of a support shaft 88a that is rotatable, support arms 88b that protrude radially with respect to the support shaft 88a. The support arms 88b support bearings 89 provided at both ends of the shaft 83 of one rotating body 80a from below. In addition, an operation lever 88c that protrudes radially with respect to the support shaft 88a in a direction different from the support arms 88b is provided at one end of the support shaft 88a.

### Setting of Nip Pressure of Transport Roll

As shown in FIG. 9A, biasing springs 114 as biasing sections for adjusting a nip pressure (corresponding to a contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and can variably set a biasing force by adjusting the compression deformation amount via an adjustment portion (not shown). As a result, the nip pressure of the transport roll 80 is set.

### Use Example of Retract Mechanism

In the present example, the retract mechanism 88 need only be operated, for example, in a case where the medium S is jammed (medium jam) during the passage of the transport roll 80. Specifically, as shown in FIG. 9B, an operator need only manually push down the operation lever 88c of the retract mechanism 88 and swing the support arms 88b upward about the support shaft 88a. In this case, the rotating body 80a is pushed up by the support arms 88b against the biasing force of the biasing springs 114, and the contact state between the plurality of rotating bodies 80a and 80b is released. In a case where the operation lever 88c is returned to an original position, the contact state between the plurality of rotating bodies 80a and 80b is returned to an original state.

### Rubbing Roll

### Configuration Example of Rubbing Roll

In the present example, as shown in FIGS. 7 and 8, the rubbing roll 90 consists of the plurality of rotating bodies 90a and 90b that are disposed to face each other with respect to the medium S. In the present example, the rotating bodies 90a and 90b constituting the rubbing roll 90 need only have, at least on a surface, a rubbing portion for rubbing the wax W. In the present example, each of the rotating bodies 90a and 90b has a structure in which a surface of a solid shaft 93 made of metal such as SUS is covered with a nonwoven fabric 94. Here, as the nonwoven fabric 94, for example, a felt or a microfiber cloth having a thickness of equal to or less than 1 mm is used. The nonwoven fabric 94 is fixed to the shaft 93 by an adhesive, a double-sided tape, or the like. In this case, the nonwoven fabric 94 may be fixed by spirally winding a strip-shaped member around the shaft 93 or may be fixed by winding a cloth-shaped member around the shaft 93.

The configuration example of the rubbing roll 90 is not limited to the aspect in which the nonwoven fabric 94 is used. Instead of the nonwoven fabric 94, a pile fabric composed of a nap-raised cloth, a knitted fabric composed of a continuous mesh, a woven fabric woven by combining yarns consisting of warp and weft fibers, and the like may be used.

In addition, in the present example, the rubbing roll 90 has a structure in which the surface of the shaft 93 is covered with the nonwoven fabric 94, but the present invention is not limited to this, and an aspect may be adopted in which a rubbing portion is integrally formed around the roll body.

### Drive Method of Rubbing Roll

In addition, in the present example, the rubbing roll 90 uses both the rotating bodies 90a and 90b as driving rolls. That is, a drive force from a drive motor 96 is transmitted to both the rotating bodies 90a and 90b via drive transmission mechanisms 97 (specifically, 97a and 97b) such as drive transmission gear trains. Here, the drive transmission mechanisms 97a and 97b may be partially shared or may be separately provided. In the present example, the drive transmission mechanism 97b is configured to share the drive transmission mechanism 97a.

### Speed Condition of Rubbing Roll

As shown in FIGS. 7 and 8, the rubbing roll 90 need only rub the surface of the medium S in the same direction as the transport direction of the medium S at the speed v1 that is higher than the transport speed v0 of the transport roll 80.

In the present example, the rubbing roll 90 is selected to rotate in the same direction as the transport direction of the medium S in a contact region CN1 between the plurality of rotating bodies 90a and 90b. That is, the rotating body 90a located on the upper side rotates in a counterclockwise direction, and the rotating body 90b located on the lower side rotates in a clockwise direction.

In a case where the selection is made in this manner, the speed difference (v1-v0) corresponding to a circumferential speed difference between the rubbing roll 90 and the transport roll 80 is greater than zero. Therefore, the medium S is transported by the transport roll 80 at the transport speed v0. In this situation, in a case where the medium S passes through the rubbing roll 90, the rubbing operation using the rubbing roll 90 on the surface of the medium S is ensured.

Here, the speed v1 of the rubbing roll 90 may be selected as appropriate. However, in order to increase the rubbing resistance of the rubbing roll 90, for example, it is preferable to set v1 to be high.

In the present example, the value is set to about 5 to 10 times v0 in the absolute value.

### Contact/Separation Configuration Example of Rubbing Roll

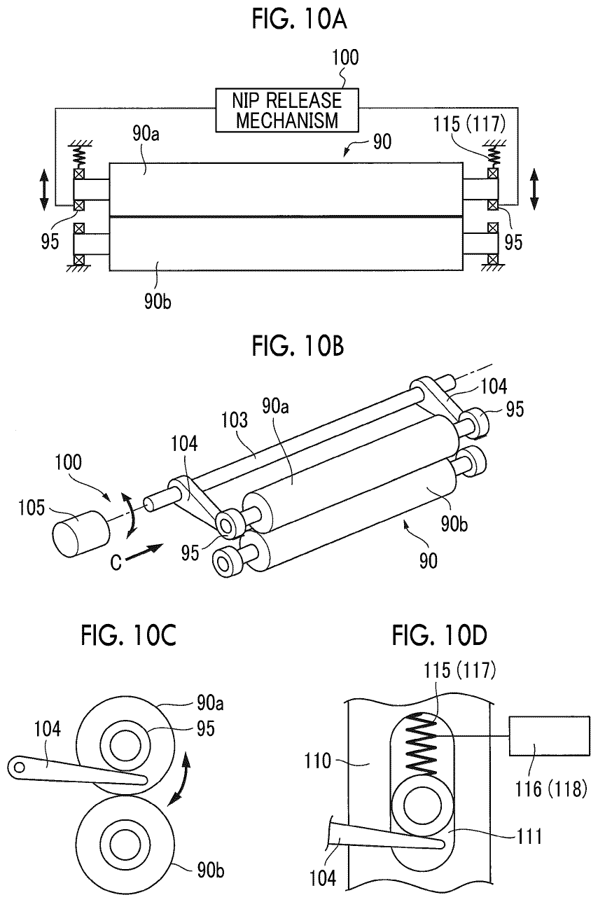

In the present example, as shown in FIGS. 7, 10A, and 10B, one rotating body 90a of the rubbing roll 90 is provided with a nip release mechanism 100 as a contact/separation section that is movable between a contact position at which the rotating body 90a is in contact with the other rotating body 90b and a non-contact position at which the rotating body 90a is separated from the contact position. The nip release mechanism 100 supports both ends of the shaft 93 of the rotating body 90a, and switches between the nip state of the rubbing roll 90 (corresponding to the contact state between the plurality of rotating bodies 90a and 90b) and a release state (corresponding to a non-contact state between the plurality of rotating bodies 90a and 90b) based on a control signal. In the present example, as shown in FIG. 10B, the nip release mechanism 100 has, on both sides of a support shaft 103 that is rotatable, support arms 104 that protrude radially with respect to the support shaft 103. The support arms 104 support bearings 95, which are provided at both ends of the shaft 93 of one rotating body 90a located on the upper side, from below.

In the present example, the bearings 95 provided at both ends of the shaft 93 are supported by a support panel 110 to be movable up and down. Specifically, an elongated hole 111 extending in an up-down direction is formed in the support panel 110. The bearings 95, which are provided at both ends of the shaft 93 of the rotating body 90a, are held to be slidable in the elongated hole 111.

Further, a nip release motor 105 capable of forward and backward rotation is provided at one end of the support shaft 103 directly or via a drive transmission gear train (not shown). As shown in FIGS. 10B and 10C, the nip release motor 105 rotates the support shaft 103 forward and backward and swings the support arms 104 in a predetermined angle range.

### Setting of Nip Pressure of Rubbing Roll

In the present example, as shown in FIGS. 10A and 10D, biasing springs 115 as the biasing sections for adjusting a nip pressure (corresponding to a contact pressure of the contact region between the plurality of rotating bodies 90a and 90b) of the rubbing roll 90 are provided in the rubbing roll 90. The biasing spring 115 is composed of, for example, a compression coil spring. The biasing spring 115 is interposed, for example, between an upper edge portion of the elongated hole 111 and the bearing 95 of the rotating body 90a. In addition, an adjustment portion 116 that adjusts the compression deformation amount is provided in the biasing spring 115. The adjustment portion 116 variably sets a biasing force of the biasing spring 115 by adjusting the compression deformation amount. As a result, the nip pressure of the rubbing roll 90 is set. The product of the contact region with the nip pressure of the rubbing roll 90 described herein corresponds to a load of the rubbing roll 90 described later.

### Adjustment of Frictional Force of Rubbing Roll

In the present example, the rubbing roll 90 and the transport roll 80 come into contact with the medium S that moves. In this case, in a case where the medium S passes through the contact region CN1 of the rubbing roll 90, as shown in FIG. 8, the frictional force f1 is generated between the rubbing roll 90 and the medium S. Meanwhile, in a case where the medium S passes through the contact region CN0 of the transport roll 80, a frictional force f0 is generated between the transport roll 80 and the medium S.

In the present example, the frictional force f0 between the plurality of rotating bodies 80a and 80b constituting the transport roll 80 and the medium S is required to be greater than the frictional force f1 between the plurality of rotating bodies 90a and 90b constituting the rubbing roll 90 and the medium S.

Here, in a case where a normal force acting on the contact region CN0 of the transport roll 80 is denoted by U0, a kinetic friction coefficient between the transport roll 80 and the medium S is denoted by μ0, a normal force acting on the contact region CN1 of the rubbing roll 90 is denoted by U1, and a kinetic friction coefficient between the rubbing roll 90 and the medium S is denoted by μ1, the relationship is represented as follows.

$$f 0 = μ 0 \cdot U 0$$

$$f 1 = μ 1 \cdot U 1$$

In order to satisfy the condition of f0>f1, since the kinetic friction coefficients μ0 and μ1 are values dependent on the materials and the like, the biasing forces of the biasing springs 114 and 115 that affect the normal forces U0 and U1 need only be adjusted in consideration of the respective kinetic friction coefficients. Here, since U0 is selected such that the transportability of the medium S is ensured at an appropriate level, for example, it is preferable to mostly adjust the biasing force of the biasing spring 115 and appropriately adjust the frictional force f1.

### Relationship Between Physical Properties of Medium and Wax

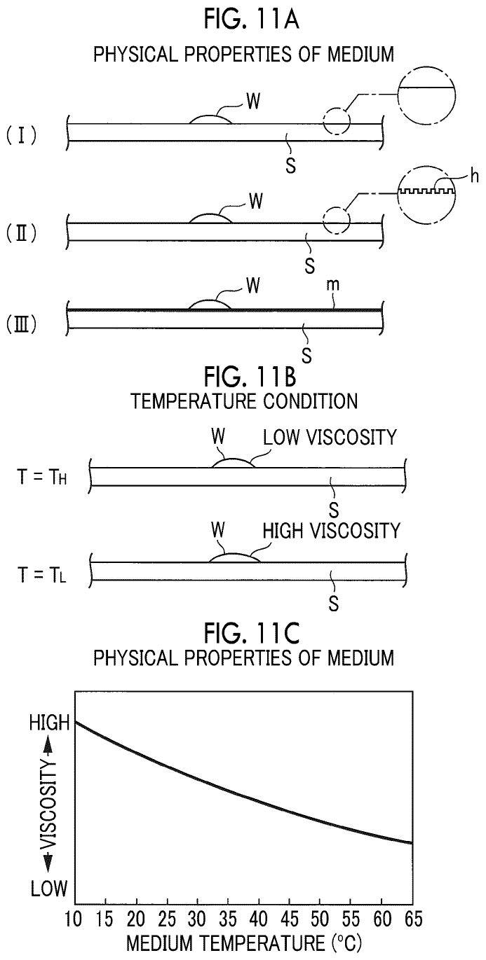

FIG. 11A shows a relationship between the physical properties of the medium and the wax

In the same drawing, (I) is a situation in which the wax W adheres to the medium S of which the surface is smooth (for example, paper having smoothness of equal to or less than 3000). In this case, the wax W is likely to be spread in a flattened manner and to be deformed along a smooth surface of the medium S in a case where the rubbing operation is performed.

In addition, (II) is a situation in which the wax W adheres to the medium S of which the surface is not smooth (for example, paper having smoothness of exceeding 3000). In this case, since the wax W is embedded in a recess portion h on the medium S due to the anchor effect, an adhesion force to the medium S is increased, and the rubbing performance is likely to deteriorate.

Further, (III) is a state where the wax W adheres to the medium S (for example, metallic paper) having the metal layer m on the substrate.

### Relationship Between Temperature Condition and Wax

FIG. 11B shows a relationship between a temperature condition of the medium and the wax.

In the same drawing, for the media having the same smoothness or surface roughness, a case where the wax W adheres under a high temperature condition (T=T_{H}) and a case where the wax W adheres under a low temperature condition (T=T_{L}<T_{H}) are compared, so that the following results are obtained.

Under the high temperature condition (T=T_{H}), the viscosity of the wax W is lower, and the wax W is likely to be spread in a flattened manner and to be deformed on the medium S by the rubbing operation. On the other hand, under the low temperature condition (T=T_{L}), the synthesis of the wax W is increased, and thus an adhesion force of the wax W is increased, and the rubbing performance is likely to deteriorate.

### Viscosity Characteristics of Wax

FIG. 11C shows a relationship between the surface temperature of the medium S and the viscosity of the wax.

It is generally known that a relationship expression between the viscosity and the temperature is represented by Andrade's equation.

Therefore, the relationship between the viscosity and the temperature is not linear, and exhibits an exponential behavior shown below.

$$η = A exp ( B / T )$$

Here, η is a viscosity, A is a constant, B is a constant, and T is a temperature.

### Adjustment of Rubbing Energy of Rubbing Roll

As described above, there is a relationship in which the wax W on the medium S changes in state depending on a use environment (the surface temperature of the medium S and the surface state of the medium S).

Therefore, in the present example, a method of adjusting the rubbing energy Em of the rubbing roll 90 is adopted in consideration of the use environment of the wax W.

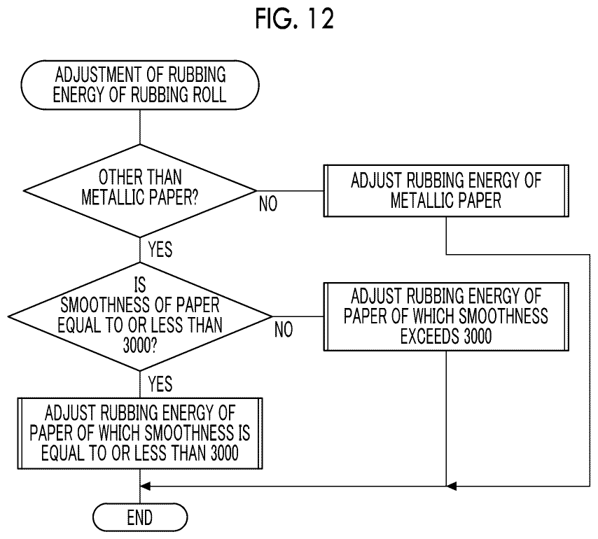

FIG. 12 is a flowchart for adjusting the rubbing energy of the rubbing roll.

In the same drawing, the rubbing energy adjustment by the rubbing roll is divided into three subroutines depending on the type of the medium S.

A first medium type is paper having smoothness of equal to or less than 3000, a second medium type is paper having smoothness of exceeding 3000, and a third medium type is metallic paper.

In the present example, the wax W is more likely to spread in a flattened manner by the rubbing operation in the first medium type than in the second medium type. In addition, as in the first medium type, the wax W is likely to spread in a flattened manner by the rubbing operation in the third medium type than in the second medium type. However, an upper limit of the rubbing energy of the third medium type is limited as compared with the first medium type. This is to avoid a situation where the metal layer is damaged in the metallic paper having the metal layer on the surface in a case where the rubbing energy is set to be excessively high.

### First Medium Type

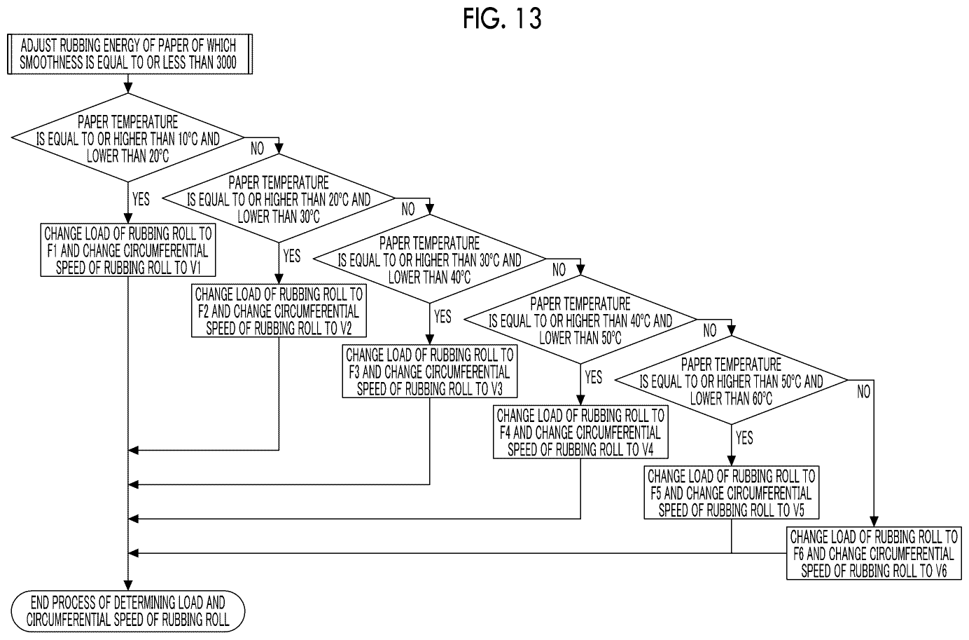

As shown in FIG. 13, in the adjustment of the rubbing energy of the first medium type, the rubbing energy Em of the rubbing roll 90 is adjusted based on the temperature information detected by the temperature detector 150.

In the present example, the paper temperature is classified into equal to or higher than 10° C. and lower than 20° C., equal to or higher than 20° C. and lower than 30° C., equal to or higher than 30° C. and lower than 40° C., equal to or higher than 40° C. and lower than 50° C., equal to or higher than 50° C. and lower than 60° C., and equal to or higher than 60° C.

In addition, the rubbing energy Em of the rubbing roll 90 is adjusted by changing both a load F of the rubbing roll 90 and a circumferential speed difference V between the rubbing roll 90 and the transport roll 80. In the present example, the rubbing energy Em (W) is represented by the product of the load F and the circumferential speed difference V.
Equal to or higher than 10° C. and lower than 20° C.: F1×V1
Equal to or higher than 20° C. and lower than 30° C.: F2×V2
Equal to or higher than 30° C. and lower than 40° C.: F3×V3
Equal to or higher than 40° C. and lower than 50° C.: F4×V4
Equal to or higher than 50° C. and lower than 60° C.: F5×V5
Equal to or higher than 60° C.: F6×V6

The load F of the rubbing roll 90 and the circumferential speed difference V of the rubbing roll 90 are numerical values in Table 1 shown below. The same applies hereinafter.

### Second Medium Type

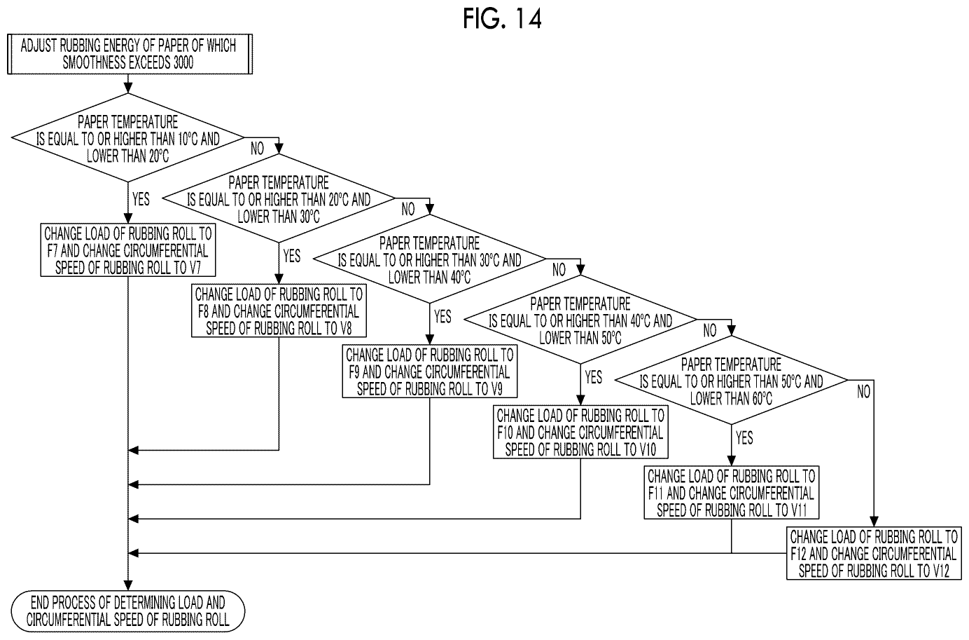

As shown in FIG. 14, in the adjustment of the rubbing energy of the second medium type, the rubbing energy Em of the rubbing roll 90 is adjusted based on the temperature information detected by the temperature detector 150.

In the present example, the paper temperature is classified into seven stages, as in the first medium type.

In addition, the rubbing energy Em of the rubbing roll 90 is adjusted by changing both the load F of the rubbing roll 90 and the circumferential speed difference V between the rubbing roll 90 and the transport roll 80, as in the first medium type.
Equal to or higher than 10° C. and lower than 20° C.: F7×V7
Equal to or higher than 20° C. and lower than 30° C.: F8×V8
Equal to or higher than 30° C. and lower than 40° C.: F9×V9
Equal to or higher than 40° C. and lower than 50° C.: F10×V10
Equal to or higher than 50° C. and lower than 60° C.: F11×V11
Equal to or higher than 60° C. or higher: F12×V12 Third Medium Type

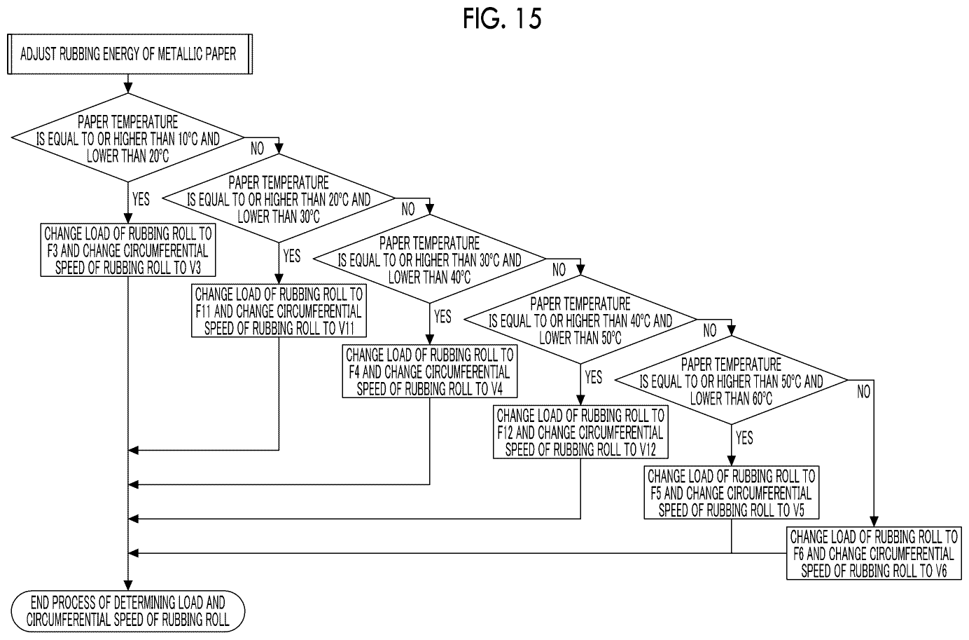

As shown in FIG. 15, in the adjustment of the rubbing energy of the third medium type, the rubbing energy Em of the rubbing roll 90 is adjusted based on the temperature information detected by the temperature detector 150.

In the present example, the paper temperature is classified into seven stages, as in the first medium type.

In addition, the rubbing energy Em of the rubbing roll 90 is adjusted by changing both the load F of the rubbing roll 90 and the circumferential speed difference V between the rubbing roll 90 and the transport roll 80, as in the first medium type.
Equal to or higher than 10° C. and lower than 20° C.: F3× V3
Equal to or higher than 20° C. and lower than 30° C.: F11×V11
Equal to or higher than 30° C. and lower than 40° C.: F4×V4
Equal to or higher than 40° C. and lower than 50° C.: F12×V12
Equal to or higher than 50° C. and lower than 60° C.: F5×V5
Equal to or higher than 60° C.: F6×V6

In the metallic paper, since the surface of the paper is likely to be damaged by the rubbing operation, the product of the load F and the circumferential speed difference V is adjusted to be equal to or less than 280000.

In the present exemplary embodiment, in a case of adjusting the rubbing energy Em by the rubbing roll 90, both the load F of the rubbing roll 90 and the circumferential speed difference V between the rubbing roll 90 and the transport roll 80 are taken into consideration, but it goes without saying that adjustment may be performed using any one of the two.

TABLE 1

| Load of | Set value | Circumferential speed | Set value |
|---|---|---|---|
| rubbing roll | [N] | difference of rubbing roll | [mm/s] |
| F1 | 500 | V1 | 900 |
| F2 | 450 | V2 | 800 |
| F3 | 400 | V3 | 700 |
| F4 | 350 | V4 | 600 |
| F5 | 300 | V5 | 500 |
| F6 | 250 | V6 | 400 |
| F7 | 600 | V7 | 1000 |
| F8 | 550 | V8 | 900 |
| F9 | 500 | V9 | 800 |
| F10 | 450 | V10 | 700 |
| F11 | 400 | V11 | 600 |
| F12 | 350 | V12 | 500 |

Control System of Post-Processing Device

In the present exemplary embodiment, as shown in FIG. 5, the post-processing device 25 is controlled by the control device 120.

In the present example, the control device 120 is configured with a microcomputer including various processors. In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

In the present example, the control device 120 is a device in which required programs, such as an imaging program of the image forming system 20 and a post-processing program of the post-processing device 25, are installed in advance in a memory (not shown). The control device 120 executes the series of imaging programs by turning on a start switch (not shown), and sends out a control signal required for imaging processing to the imaging engine 22, the medium transport system 23, and the fixing device 24. In addition, the control device 120 executes the post-processing program based on the detection signals from the surface information detector 130, the temperature detector 150, and the position detector 160, and sends out a control signal required for the post-processing of the post-processing device 25.

### Operation Procedure Until Medium Reaches Post-Processing Device

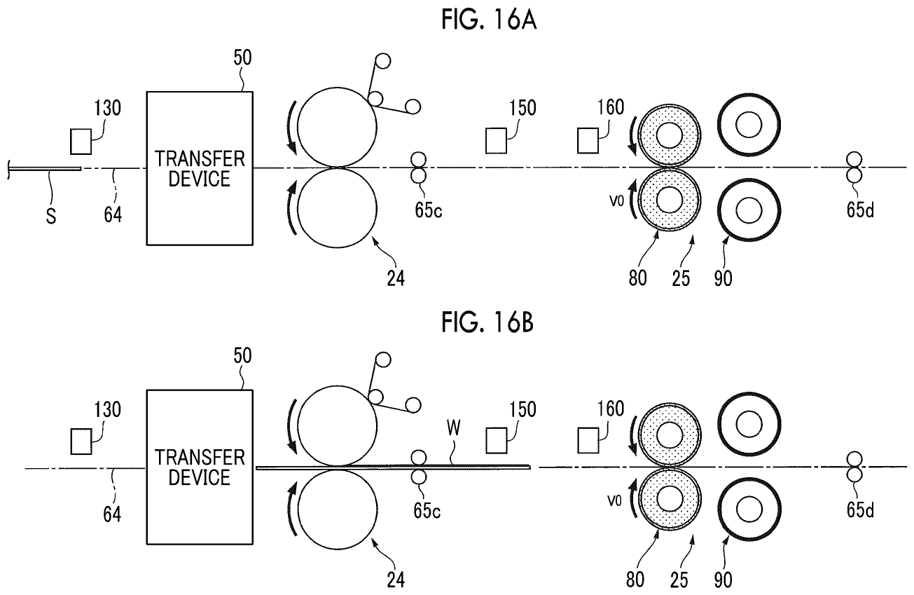

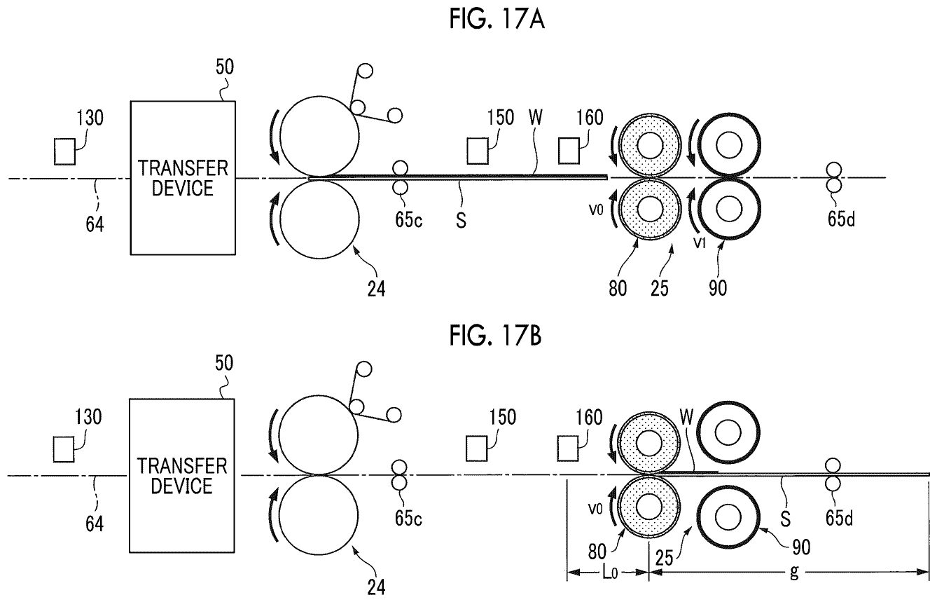

FIGS. 16A and 16B and FIGS. 17A and 17B are diagrams schematically showing an operation procedure until the medium reaches the post-processing device. In FIGS. 16A and 16B and FIGS. 17A and 17B, the wax W on the medium S before the post-processing is shown, and the wax W after the post-processing is not shown.

First, in a case where the medium S passes through the horizontal transport path 64 before the transfer region TR, the surface information detector 130 detects the surface information of the medium S as shown in FIG. 16A. Accordingly, the control device 120 discriminates whether the medium S is the first medium type, the second medium type, or the third medium type by a medium type discrimination portion.

Next, in a case where the medium S passes through the transfer region TR of the transfer device 50, as shown in FIG. 16B, the image produced by the imaging engine 22 is transferred to the medium S, and then the image is fixed to the medium S by the fixing device 24. In a case where the medium S that has passed through the fixing device 24 passes through the temperature detector 150, the temperature detector 150 detects the surface temperature of the medium S. In this state, the control device 120 recognizes the surface temperature of the medium S before the medium S enters the post-processing device 25. Therefore, the control device 120 adjusts the rubbing energy Em of the rubbing roll 90 of the post-processing device 25 based on the detection results of the surface information detector 130 and the temperature detector 150 (see FIGS. 12 to 15). The rubbing energy Em adjusted in this manner effectively acts in spreading the wax W held on the medium S in a flattened manner by the rubbing operation using the rubbing roll 90.

Then, as shown in FIG. 17A, in a case where the leading end of the medium S passes through the position detector 160, the control device 120 executes the pressurization and the rotation of the rubbing roll 90. In this case, a value set for adjusting the rubbing energy Em is used as the load or the circumferential speed difference of the rubbing roll 90.

Thereafter, as shown in FIG. 17B, after a time t1 has elapsed from the time when the leading end of the medium S has passed through the position detector 160, the rotation of the rubbing roll 90 is stopped and the pressurization is released. Here, t1 is a time calculated by (L0+g)/v0. Here, L0 is a distance between the position detector 160 and the center of the transport portion of the transport roll 80, g is a length of the medium S in the transport direction, and v0 is a transport speed of the transport roll 80. That is, in a case where the pressurization of the rubbing roll 90 is not released at a timing at which the trailing end of the medium S passes beyond the transport roll 80, there is a concern that the medium S is jammed due to high-speed ejection of the medium S caused by the high-speed rotation of the rubbing roll 90. From the viewpoint of preventing this concern, it is necessary to stop the rotation of the rubbing roll 90 and release the pressurization at t1.

### Post-Processing Operation Procedure of Post-Processing Device

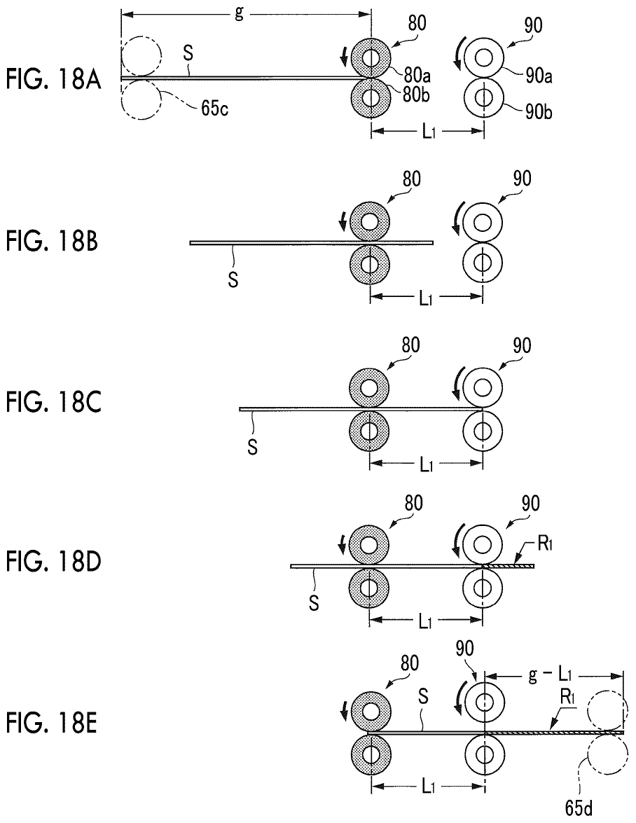

FIGS. 18A to 18E show a post-processing operation procedure of the post-processing device in time series.

In the same drawing, a distance between the rubbing roll 90 and the transport roll 80 is denoted by L1, and the transport direction length of the medium S is denoted by g.

FIG. 18A shows a state where the leading end part of the medium S enters the transport roll 80. In this case, the medium S is transported by the transport roll 65c for feeding located on the inlet side of the post-processing device 25 and enters the transport roll 80.

FIG. 18B shows a state after the leading end part of the medium S has entered the transport roll 80. In this case, the transport roll 80 transports the medium S at the transport speed v0 to be directed to the rubbing roll 90. In this case, the rubbing roll 90 is disposed at the nip position and is in a standby state where the driving is started.

FIG. 18C shows a state where the leading end part of the medium S has entered the rubbing roll 90. In this case, the medium S is transported in a state of being pulled in the transport direction between the rubbing roll 90 and the transport roll 80. Therefore, the rubbing operation using the rubbing roll 90 is started from the leading end part of the medium S.

FIG. 18D shows a state where the leading end part of the medium S passes through the rubbing roll 90. In this case, the rubbing operation using the rubbing roll 90 is carried out from the leading end part of the medium S toward the downstream side of the medium S in the transport direction. In FIG. 18D, R1 indicates a rubbing region (corresponding to a hatched region in the diagonally lower right in the drawing) of the rubbing roll 90 with respect to the medium S.

FIG. 18E shows a state immediately before the trailing end part of the medium S passes through the transport roll 80. In this case, the rubbing roll 90 is disposed at the release position, and the driving is stopped. During this period, the rubbing operation using the rubbing roll 90 is carried out from the leading end part of the medium S to the middle of the medium S in the transport direction. The rubbing operation using the rubbing roll 90 is stopped at a stage in which the rubbing roll 90 is disposed at the release position. In FIG. 18E, the rubbing region R1 of the rubbing roll 90 is provided substantially within a g-L1 range.

In addition, the leading end part of the medium S is nipped and transported by the transport roll 65d located on the outlet side of the post-processing device 25. Therefore, the transportability of the medium S discharged from the post-processing device 25 is well maintained.

As described above, in the present example, the post-processing device 25 rubs both the front and back surfaces of the medium S in the rubbing region R1 of the rubbing roll 90.

### Form Change in Wax on Medium Before and After Post-Processing

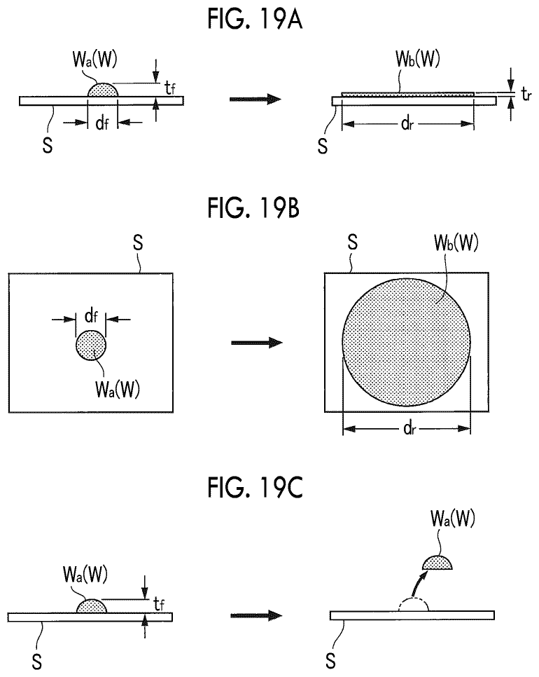

FIG. 19A shows a form change in the wax W before and after the post-processing using the post-processing device 25 in a case where the film medium having the smooth surface is used as the medium S.

In the same drawing, it can be seen that the wax W of the medium S before the post-processing passes through the fixing region FR and then is cooled and solidified to be the granular mass Wa (granular mass having a diameter df of, for example, 5 μm and a thickness tf of, for example, 0.3 μm).

However, after the post-processing using the post-processing device 25, the wax W consisting of the granular mass Wa before the post-processing is hardly visible. The granular mass Wa before the post-processing is spread in a flattened manner by the rubbing operation using the rubbing roll 90. As a result, it is confirmed that the form of the wax W is changed from the granular mass Wa to the thin film-like layer Wb.

In the present example, the wax W consisting of the thin film-like layer Wb is changed to have a smaller thickness tr and a larger diameter dr than the granular mass Wa.

In the present example, as shown in FIG. 19A and FIG. 19B, in the thin film-like layer Wb, the thickness tr is changed to be about ⅓ of the thickness tf (for example, 0.3 μm) before the processing, and the diameter dr is widely spread to be about 5 to 6 times the diameter df (for example, 5 μm) before the processing.

In this state, it is confirmed that the wax W consisting of the thin film-like layer Wb does not have the light scattering phenomenon, and the present of the wax W on the medium S cannot be visually confirmed.

In particular, in the present exemplary embodiment, a method of adjusting the rubbing energy Em of the rubbing roll 90 is adopted in consideration of use environment conditions of the wax W (a surface condition of the medium and a temperature condition of the medium). Therefore, it is possible to more appropriately exhibit the effect of spreading the wax W by the rubbing operation using the rubbing roll 90, as compared with a case where the rubbing energy Em of the rubbing roll 90 is made constant.

### Condition that Makes Wax Less Visible

Here, regarding the form of the wax W after the post-processing using the post-processing device 25, it is presumed that the granular mass Wa is spread into the thin film-like layer Wb to be in a less visible state.

In this case, in a case where a relationship between the thickness tr of the thin film-like layer Wb and a condition that makes the wax W less visible is examined, it is confirmed that, for example, it is preferable that the following relationship is satisfied.

$$tr \leq 0.15 μm$$

A method of measuring the thickness of the wax W and an analysis of a measurement result will be described in detail in Examples described later.

### Comparative Example 1

As shown in FIG. 19C, the post-processing device according to the present comparative example removes the wax W consisting of the granular mass Wa transferred to the medium S by a removal member such as a blade.

In the present example, in a case where the wax W transferred to the medium S is to be mechanically completely removed, it is necessary to strongly press the removal member against the surface of the medium S. In this case, the image held on the medium S may be damaged, and it cannot be said that this measure is a desired measure.

### Modification Aspect

(1) In the present exemplary embodiment, in a case where the rubbing roll 90 is disposed at the release position, the driving of the plurality of rotating bodies 90a and 90b is stopped. However, the rubbing roll 90 may be disposed at the release position without stopping the driving of the plurality of rotating bodies 90a and 90b.

(2) In the present exemplary embodiment, the post-processing device 25 performs the post-processing on the sheet-like medium S, but the present invention is not limited to this, and the post-processing may be performed on a continuous medium such as a roll-like medium. In this case, unlike the sheet-like medium S, the transport roll 80 can always maintain a state where the continuous medium S is nipped. Therefore, for example, this configuration is preferable in that a timing of the nip release of the rubbing roll 90 is controlled, so that the rubbing processing using the rubbing roll 90 can be appropriately carried out on a portion of the continuous medium S that requires the rubbing processing.

(3) In the present exemplary embodiment, the rubbing energy Em by the rubbing roll 90 is adjusted by using both the surface condition of the medium S and the temperature condition of the medium as the use environment conditions of the wax W, but it goes without saying that the rubbing energy Em of the rubbing roll 90 may be adjusted by using only one of the surface condition of the medium S or the temperature condition of the medium.

### Exemplary Embodiment 2

The image forming system 20 according to Exemplary Embodiment 2 has substantially the same basic configuration as in Exemplary Embodiment 1, but has a post-processing device 25 different from the post-processing device 25 according to Exemplary Embodiment 1. The same constituent elements as the constituent elements of Exemplary Embodiment 1 will be denoted by the same reference numerals as the reference numerals of Exemplary Embodiment 1, and the detailed description thereof will be omitted here.

### Basic Configuration of Post-Processing Device

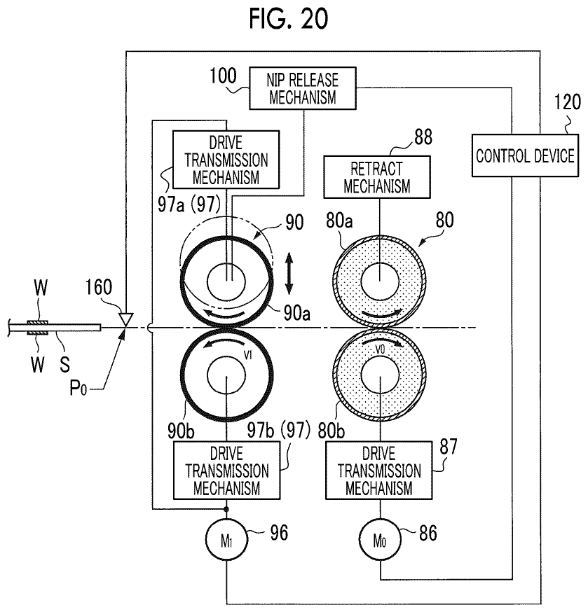

FIG. 20 is a diagram showing a major portion of the post-processing device according to Exemplary Embodiment 2.

In the same drawing, as in Exemplary Embodiment 1, the post-processing device 25 includes the transport roll 80 as the transport section that transports the medium S at the predetermined transport speed v0 by nipping the medium S, the rubbing roll 90 as the rubbing section that is located upstream of the transport roll 80 in the transport direction of the medium S and that rubs the surface of the medium S in the direction opposite to the transport direction of the medium S at the speed v1 different from the transport speed v0, and the transport roll 80 and the rubbing roll 90 are mounted in a housing (not shown) in an appropriate arrangement.

In the present example, the rubbing roll 90 is configured to rub both the front and back surfaces of the medium S, as in Exemplary Embodiment 1.

### Transport Roll

### Configuration Example and Drive Method of Transport Roll

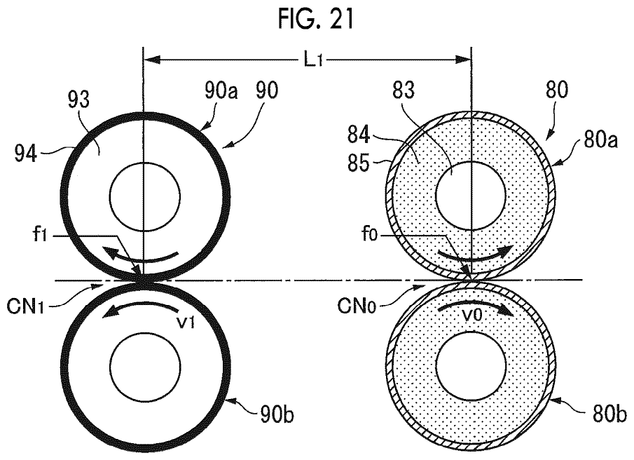

In the present example, as shown in FIGS. 20 and 21, the transport roll 80 consists of the plurality of rotating bodies 80a and 80b that are disposed to face each other with respect to the medium S. The rotating bodies 80a and 80b constituting the transport roll 80 have a three-layer structure including the shaft 83, the elastic layer 84, and the mold-releasing layer 85, as in Exemplary Embodiment 1.

In the present example, the drive method of the transport roll 80 is a method of using one rotating body 80b of the plurality of rotating bodies 80a and 80b as a driving roll, and transmitting a drive force from the drive motor 86 to the driving roll via the drive transmission mechanism 87, in substantially the same manner as in Exemplary Embodiment 1.

### Retract Configuration Example of Transport Roll

In the present example, as shown in FIGS. 20, 9A, and 9B, the retract mechanism 88 (support shaft 88a, support arms 88b, and operation lever 88c) as the retractable retract section is provided in one rotating body 80a of the transport roll 80.

### Setting of Nip Pressure of Transport Roll

As in Exemplary Embodiment 1, as shown in FIG. 9A, the biasing springs 114 as the biasing sections for adjusting the nip pressure (corresponding to the contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and adjusts the compression deformation amount via an adjustment portion (not shown).

### Rubbing Roll

### Configuration Example of Rubbing Roll

In the present example, as shown in FIGS. 20 and 21, the rubbing roll 90 consists of the plurality of rotating bodies 90a and 90b that are disposed to face each other with respect to the medium S. In the present example, the rotating bodies 90a and 90b constituting the rubbing roll 90 need only have, at least on the surface, a rubbing portion as in Exemplary Embodiment 1. In the present example, the rubbing roll 90 has a structure in which the surface of the solid shaft 93 made of metal such as SUS is covered with the nonwoven fabric 94. The configuration example of the rubbing portion may be selected as appropriate in the same manner as in Exemplary Embodiment 1.

### Drive Method of Rubbing Roll

The rubbing roll 90 also uses both the rotating bodies 90a and 90b as driving rolls, as in Exemplary Embodiment 1. In the present example, a drive force from the drive motor 96 is transmitted to both the rotating bodies 90a and 90b via the drive transmission mechanisms 97 (specifically, 97a and 97b) such as the drive transmission gear train. Here, the drive transmission mechanisms 97a and 97b may be partially shared or may be separately provided. In the present example, the drive transmission mechanism 97b shares the drive transmission mechanism 97a, and is configured to add a transmission gear for changing a rotation direction with respect to a transmission gear of the final stage of the drive transmission mechanism 97a.

### Speed Condition of Rubbing Roll

As shown in FIGS. 20 and 21, the rubbing roll 90 need only rub the surface of the medium S in the direction opposite to the transport direction of the medium S at the speed v1 different from the transport speed v0 of the transport roll 80.

In the present example, the rubbing roll 90 is selected so as (i) to rotate in the direction opposite to the transport direction of the medium S in a contact region CN1 between the plurality of rotating bodies 90a and 90b. That is, the rotating body 90a located on the upper side rotates in a clockwise direction, and the rotating body 90b located on the lower side rotates in a counterclockwise direction.

The reason for the selection is based on the viewpoint that the rubbing resistance caused by the rubbing roll 90 is increased. In a case where the selection is made in this way, it is possible to increase the speed difference (v0-v1) corresponding to the circumferential speed difference between the rubbing roll 90 and the transport roll 80. Here, the speed v1 of the rubbing roll 90 may be selected as appropriate, but is set to about 5 to 10 times v0 in the absolute value in the present example.

In order to rub the surface of the medium S via the rubbing roll 90 in the direction opposite to the transport direction of the medium S, in addition to (i), the rubbing roll 90 may be selected so as (ii) to maintain a stop state in the contact region CN1 or (iii) to rotate in the same direction as the transport direction of the medium S at the speed that is lower than the transport speed v0 of the medium S in the contact region CN1. However, it should be noted that the rubbing resistance caused by the rubbing roll 90 is smaller in the methods of (ii) and (iii) than in the method of (i).

### Contact/Separation Configuration Example of Rubbing Roll

In the present example, the rubbing roll 90 includes the nip release mechanism 100, as in Exemplary Embodiment 1. As shown in FIGS. 20, 10A, and 10B, the nip release mechanism 100 supports both ends of the shaft 93 of the rotating body 90a, and switches between the nip state of the rubbing roll 90 (corresponding to the contact state between the plurality of rotating bodies 90a and 90b) and the release state (corresponding to the non-contact state between the plurality of rotating bodies 90a and 90b) based on the control signal.

In the present example, as shown in FIGS. 10B and 10C, the nip release mechanism 100 includes the same constituent elements (support shaft 103, support arms 104, and nip release motor 105) as in Exemplary Embodiment 1.

### Setting of Nip Pressure of Rubbing Roll

In the present example, as shown in FIGS. 10A and 10D, biasing springs 117 as the biasing sections for adjusting the nip pressure (corresponding to the contact pressure of the contact region of the plurality of rotating bodies 90a and 90b) of the rubbing roll 90 are provided in the rubbing roll 90, as in Exemplary Embodiment 1. In addition, an adjustment portion 118 that adjusts the compression deformation amount is provided in the biasing spring 117. The adjustment portion 118 variably sets the biasing force of the biasing spring 117 by adjusting the compression deformation amount. As a result, the nip pressure of the rubbing roll 90 is set. The product of the contact region with the nip pressure of the rubbing roll 90 described herein corresponds to a load of the rubbing roll 90 described later.

### Adjustment of Frictional Force of Rubbing Roll

In the present example, the rubbing roll 90 and the transport roll 80 come into contact with the medium S that moves. In this case, in a case where the medium S passes through the contact region CN1 of the rubbing roll 90, as shown in FIG. 8, the frictional force f1 is generated between the rubbing roll 90 and the medium S. Meanwhile, in a case where the medium S passes through the contact region CN0 of the transport roll 80, a frictional force f0 is generated between the transport roll 80 and the medium S.

In the present example, the frictional force f0 between the plurality of rotating bodies 80a and 80b constituting the transport roll 80 and the medium S is required to be greater than the frictional force f1 between the plurality of rotating bodies 90a and 90b constituting the rubbing roll 90 and the medium S.

Here, in a case where a normal force acting on the contact region CN0 of the transport roll 80 is denoted by U0, a kinetic friction coefficient between the transport roll 80 and the medium S is denoted by μ0, a normal force acting on the contact region CN1 of the rubbing roll 90 is denoted by U1, and a kinetic friction coefficient between the rubbing roll 90 and the medium S is denoted by μ1, the relationship is represented as follows.

$$f 0 = μ 0 \cdot U 0$$

$$f 1 = μ 1 \cdot U 1$$

In order to satisfy the condition of f0>f1, since the kinetic friction coefficients μ0 and μ1 are values dependent on the materials and the like, the biasing forces of the biasing springs 114 and 115 that affect the normal forces U0 and U1 need only be adjusted in consideration of the respective kinetic friction coefficients. Here, since U0 is selected such that the transportability of the medium S is ensured at an appropriate level, for example, it is preferable to mostly adjust the biasing force of the biasing spring 115 and appropriately adjust the frictional force f1.

### Adjustment of Rubbing Energy of Rubbing Roll

There is a relationship in which the wax W on the medium S changes in state depending on the use environment (the surface temperature of the medium S and the surface state of the medium S).

Therefore, in the present example as well, as in Exemplary Embodiment 1, a method of appropriately adjusting the rubbing energy Em of the rubbing roll 90 is adopted in consideration of the use environment of the wax W (the surface temperature of the medium S and the surface state of the medium S).

That is, the rubbing energy Em of the rubbing roll 90 is adjusted by changing the load F of the rubbing roll 90 and the circumferential speed difference V of the rubbing roll 90 for each temperature of the medium S.

### Operation of Post-Processing Device

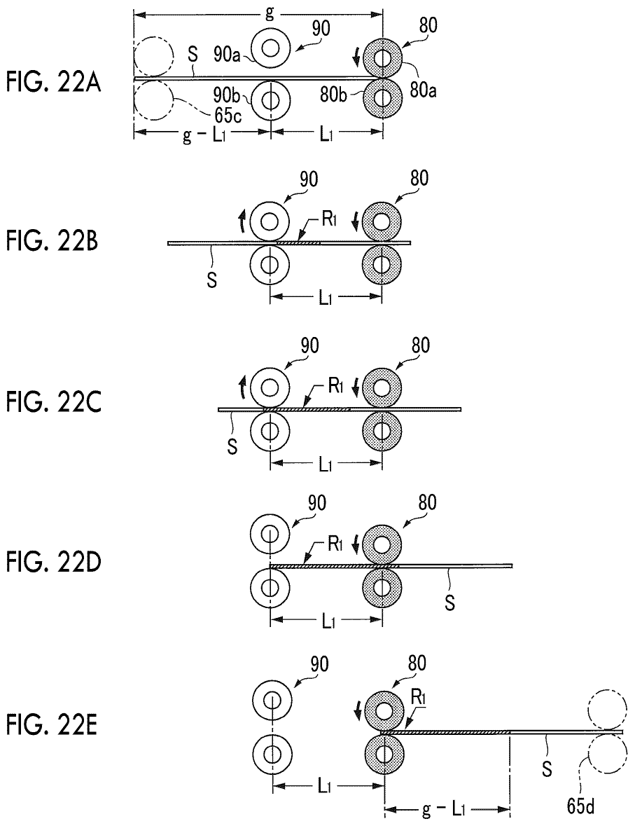

FIGS. 22A to 22E show a post-processing operation procedure of the post-processing device in time series.

In the same drawing, a distance between the rubbing roll 90 and the transport roll 80 is denoted by L1, and the transport direction length of the medium S is denoted by g.

FIG. 22A shows a state where a leading end part of the medium S enters the transport roll 80. In this case, the medium S is transported by the transport roll 65c for feeding located on the inlet side of the post-processing device 25, slips through the rubbing roll 90 located at a release position, and enters the transport roll 80.

FIG. 22B shows a state after the leading end part of the medium S has entered the transport roll 80. In this case, the rubbing roll 90 is disposed at a nip position to start the driving. Then, the medium S is transported in a state of being pulled in the transport direction between the rubbing roll 90 and the transport roll 80. Then, the rubbing operation using the rubbing roll 90 is carried out from the middle of the medium S in the transport direction. In FIG. 22B, R1 indicates a rubbing region (corresponding to a hatched region in the diagonally lower left in the drawing) of the rubbing roll 90 with respect to the medium S.

FIG. 22C shows a state where the medium S is further transported by the transport roll 80. In this case, the rubbing operation using the rubbing roll 90 is continuously carried out.

FIG. 22D shows a state where the trailing end part of the medium S passes through the rubbing roll 90. In this case, the rubbing roll 90 is disposed at the release position, and the driving is stopped. During this period, the rubbing operation using the rubbing roll 90 is carried out from the middle of the medium S in the transport direction to the trailing end part of the medium S.

FIG. 22E shows a state immediately before the trailing end part of the medium S passes through the transport roll 80. In this case, the leading end part of the medium S is nipped and transported by the transport roll 65d located on the outlet side of the post-processing device 25. Therefore, the transportability of the medium S discharged from the post-processing device 25 is well maintained.

As described above, in the present example, the post-processing device 25 rubs both the front and back surfaces of the medium S in the rubbing region R1 of the rubbing roll 90.

### Form Change in Wax on Medium Before and After Post-Processing

In the present exemplary embodiment as well, as in Exemplary Embodiment 1, it is confirmed that the form of the wax W changed from the granular mass Wa to the thin film-like layer Wb before and after the post-processing using the post-processing device 25. In this case, it is confirmed that, in a case where the wax W after the post-processing is changed to the thin film-like layer Wb having the thickness tr equal to or less than 0.15 μm, the wax W is hardly visible to the naked eye.

In particular, in the present exemplary embodiment, a method of adjusting the rubbing energy Em of the rubbing roll 90 is adopted in consideration of use environment conditions of the wax W (a surface condition of the medium and a temperature condition of the medium). Therefore, it is possible to more appropriately exhibit the effect of spreading the wax W by the rubbing operation using the rubbing roll 90, as compared with a case where the rubbing energy Em of the rubbing roll 90 is made constant.

### Exemplary Embodiment 3

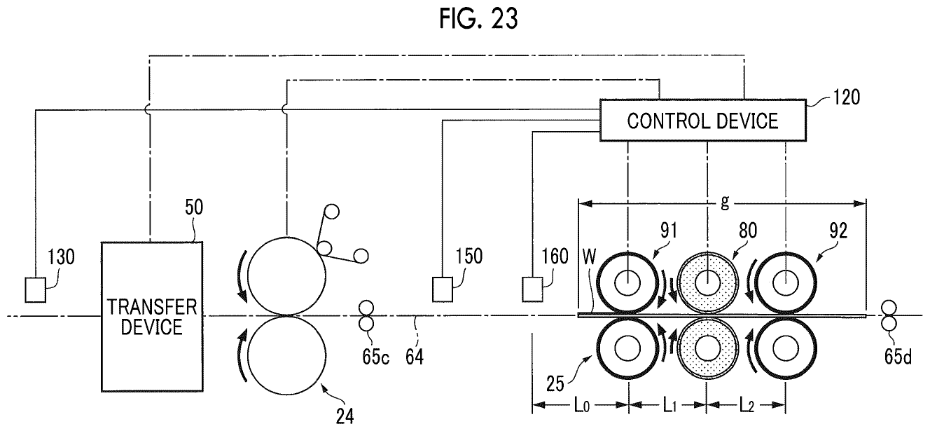

FIG. 23 shows a major portion of an image forming system according to Exemplary Embodiment 3.

In the same drawing, the image forming system 20 has substantially the same basic configuration as in Exemplary Embodiments 1 and 2, but has a post-processing device 25 different from the post-processing device 25 according to Exemplary Embodiments 1 and 2. The same constituent elements as the constituent elements of Exemplary Embodiments 1 and 2 will be denoted by the same reference numerals as the reference numerals of Exemplary Embodiments 1 and 2, and the detailed description thereof will be omitted here.

### Basic Configuration of Post-Processing Device

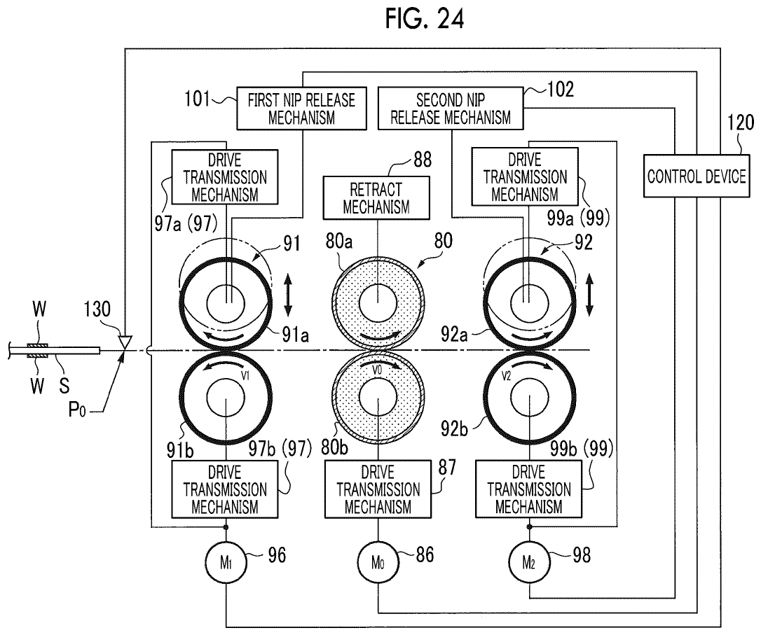

FIG. 24 is a diagram showing a major portion of the post-processing device according to Exemplary Embodiment 3.

In the same drawing, the post-processing device 25 has an aspect in which the post-processing device 25 (see FIG. 7) of the disposition example according to Exemplary Embodiment 1 and the post-processing device 25 (see FIG. 20) of the disposition example according to Exemplary Embodiment 2 are combined.

In the present example, as shown in FIG. 24, the post-processing device 25 includes the transport roll 80 as the transport section that transports the medium S at the predetermined transport speed v0 by nipping the medium S, a first rubbing roll 91 as the rubbing section that is located upstream of the transport roll 80 in the transport direction of the medium S and that rubs the surface of the medium S in a direction opposite to the transport direction of the medium S at the speed v1 that is different from the transport speed v0, and a second rubbing roll 92 as the rubbing section that is located downstream of the transport roll 80 in the transport direction of the medium S and that rubs the surface of the medium S in the same direction as the transport direction of the medium S at the speed v2 that is higher than the transport speed v0, and the transport roll 80, the first rubbing roll 91, and the second rubbing roll 92 are mounted in a housing (not shown) in an appropriate arrangement.

In the present example, the first rubbing roll 91 and the second rubbing roll 92 are configured to rub both the front and back surfaces of the medium S.

### Transport Roll

### Configuration Example and Drive Method of Transport Roll

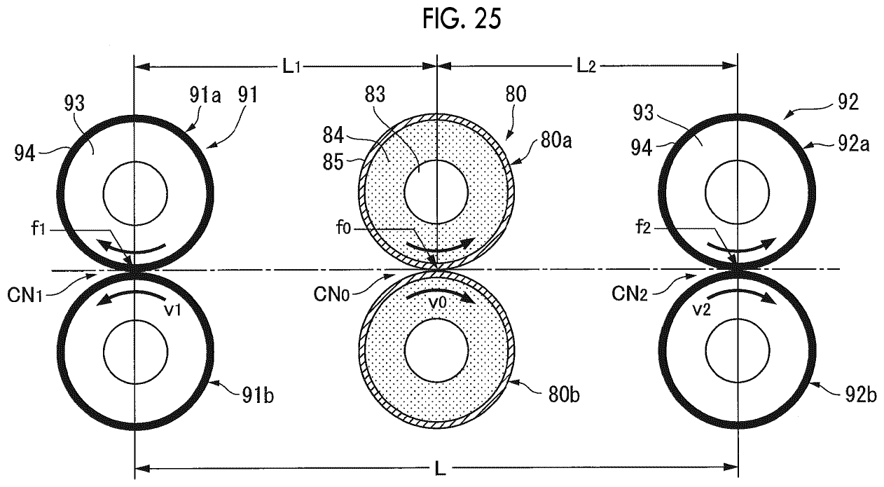

In the present example, as shown in FIGS. 24 and 25, the transport roll 80 consists of the plurality of rotating bodies 80a and 80b that are disposed to face each other with respect to the medium S. The plurality of rotating bodies 80a and 80b constituting the transport roll 80 have a three-layer structure including a shaft 83, an elastic layer 84, and a mold-releasing layer 85, as in Exemplary Embodiments 1 and 2.

In the present example, the drive method of the transport roll 80 is a method of using one rotating body 80b of the plurality of rotating bodies 80a and 80b as a driving roll, and transmitting a drive force from the drive motor 86 to the driving roll via the drive transmission mechanism 87, in substantially the same manner as in Exemplary Embodiments 1 and 2.

### Retract Configuration Example of Transport Roll

In the present example, as shown in FIGS. 24, 9A, and 9B, the retract mechanism 88 (support shaft 88a, support arms 88b, and operation lever 88c) as the retractable retract section is provided in one rotating body 80a of the transport roll 80.

### Setting of Nip Pressure of Transport Roll

As in Exemplary Embodiment 1, as shown in FIG. 9A, the biasing springs 114 as the biasing sections for adjusting the nip pressure (corresponding to the contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and adjusts the compression deformation amount via an adjustment portion (not shown).

### First Rubbing Roll

### Configuration Example of First Rubbing Roll

In the present example, as shown in FIGS. 24 and 25, the first rubbing roll 91 consists of a plurality of rotating bodies 91a and 91b that are disposed to face each other with respect to the medium S. In the present example, the rotating bodies 91a and 91b constituting the first rubbing roll 91 include the shaft 93 and the nonwoven fabric 94, as in the rubbing roll 90 according to Exemplary Embodiment 2.

### Drive Method of First Rubbing Roll

In the present example, the first rubbing roll 91 uses both the rotating bodies 91a and 91b as driving rolls. That is, the same drive method as the drive method of the rubbing roll 90 according to Exemplary Embodiment 2 (drive motor 96 and drive transmission mechanism 97 (97a and 97b)) is adopted for both the rotating bodies 91a and 91b.

### Speed Condition of First Rubbing Roll

As shown in FIGS. 24 and 25, the first rubbing roll 91 has the same speed condition as the rubbing roll 90 according to Exemplary Embodiment 2. Specifically, the first rubbing roll 91 need only rub the surface of the medium S in the direction opposite to the transport direction of the medium S at the speed v1 different from the transport speed v0 of the transport roll 80.

### Contact/Separation Configuration Example of First Rubbing Roll

In the present example, as shown in FIGS. 24, 10A, and 10B, one rotating body 91a of the first rubbing roll 91 is provided with a first nip release mechanism 101 as the contact/separation section that is movable between the contact position at which the rotating body 91a is in contact with the other rotating body 91b and the non-contact position at which the rotating body 91a is separated from the contact position. The first nip release mechanism 101 supports both ends of the shaft 93 of the rotating body 91a, and switches between the nip state of the first rubbing roll 91 (corresponding to the contact state between the plurality of rotating bodies 91a and 91b) and the release state (corresponding to the non-contact state between the plurality of rotating bodies 91a and 91b) based on the control signal. In the present example, as shown in FIGS. 24 and 10B, the first nip release mechanism 101 has the same configuration (support shaft 103, support arms 104, and nip release motor 105) as the nip release mechanism 100 according to Exemplary Embodiment 1.

### Setting of Nip Pressure of First Rubbing Roll

In the present example, as shown in FIGS. 10A and 10D, biasing springs 115 as the biasing sections for adjusting the nip pressure (corresponding to the contact pressure of the contact region of the plurality of rotating bodies 91a and 91b) of the first rubbing roll 91 are provided in the first rubbing roll 91, as in the rubbing roll 90 according to Exemplary Embodiment 1. The biasing spring 115 is composed of, for example, a compression coil spring. An adjustment portion 116 that adjusts the compression deformation amount is provided in the biasing spring 115. The adjustment portion 116 variably sets a biasing force of the biasing spring 115 by adjusting the compression deformation amount. As a result, the nip pressure of the first rubbing roll 91 is set. The product of the contact region with the nip pressure of the first rubbing roll 91 described herein corresponds to a load of the first rubbing roll 91 described later.

### Adjustment of Frictional Force of First Rubbing Roll

In the present example, the first rubbing roll 91 corresponds to the rubbing roll 90 according to Exemplary Embodiment 1.

Therefore, in the present example, the frictional force f0 between the plurality of rotating bodies 80a and 80b constituting the transport roll 80 and the medium S is required to be greater than the frictional force f1 between the plurality of rotating bodies 91a and 91b constituting the first rubbing roll 91 and the medium S.

### Adjustment of Rubbing Energy of First Rubbing Roll

In the present example as well, similarly to the rubbing roll 90 according to Exemplary Embodiment 1, a method of appropriately adjusting the rubbing energy Em of the first rubbing roll 91 is adopted in consideration of the use environment of the wax W (the surface temperature of the medium S and the surface state of the medium S).

That is, the rubbing energy Em of the first rubbing roll 91 is adjusted by changing the load F of the first rubbing roll 91 and the circumferential speed difference V of the first rubbing roll 91 for each temperature of the medium S.

### Second Rubbing Roll

### Configuration Example of Second Rubbing Roll

In the present example, as shown in FIGS. 24 and 25, the second rubbing roll 92 consists of a plurality of rotating bodies 92a and 92b that are disposed to face each other with respect to the medium S. In the present example, the rotating bodies 92a and 92b constituting the second rubbing roll 92 include a shaft 93 and a nonwoven fabric 94, as in the rubbing roll 90 according to Exemplary Embodiment 1.

### Drive Method of Second Rubbing Roll

The second rubbing roll 92 also uses both the rotating bodies 92a and 92b as driving rolls, as in the first rubbing roll 91. That is, the same drive method (in the present example, expressed by the drive motor 98 and the drive transmission mechanism 99 (99a, 99b)) as the drive method of the rubbing roll 90 according to Exemplary Embodiment 1 is adopted for both the rotating bodies 92a and 92b.

### Speed Condition of Second Rubbing Roll

As shown in FIGS. 24 and 25, the second rubbing roll 92 has the same speed condition as the rubbing roll 90 according to Exemplary Embodiment 1. Specifically, the second rubbing roll 92 need only rub the surface of the medium S in the same direction as the transport direction of the medium S at the speed v2 (corresponding to v1 of Exemplary Embodiment 1) that is higher than the transport speed v0 of the transport roll 80.

### Contact/Separation Configuration Example of Second Rubbing Roll

In the present example, as shown in FIGS. 24, 10A, and 10B, one rotating body 92a of the second rubbing roll 92 is provided with a second nip release mechanism 102 as the contact/separation section that is movable between a contact position at which the rotating body 92a is in contact with the other rotating body 92b and a non-contact position at which the rotating body 92a is separated from the contact position. The second nip release mechanism 102 supports both ends of the shaft 93 of the rotating body 92a, and switches between the nip state of the second rubbing roll 92 (corresponding to the contact state between the plurality of rotating bodies 92a and 92b) and the release state (corresponding to the non-contact state between the plurality of rotating bodies 92a and 92b) based on the control signal. In the present example, as shown in FIGS. 24 and 10B, the second nip release mechanism 102 has the same configuration (support shaft 103, support arms 104, and nip release motor 105) as the nip release mechanism 100 according to Exemplary Embodiment 2.

### Setting of Nip Pressure of Second Rubbing Roll

In the present example, as shown in FIGS. 10A and 10D, biasing springs 117 as the biasing sections for adjusting the nip pressure (corresponding to the contact pressure of the contact region of the plurality of rotating bodies 92a and 92b) of the second rubbing roll 92 are provided in the second rubbing roll 92, as in the rubbing roll 90 according to Exemplary Embodiment 1. The biasing spring 117 is composed of, for example, a compression coil spring. An adjustment portion 118 that adjusts the compression deformation amount is provided in the biasing spring 117. The adjustment portion 116 variably sets a biasing force of the biasing spring 115 by adjusting the compression deformation amount. As a result, the nip pressure of the second rubbing roll 92 is set. The product of the contact region with the nip pressure of the second rubbing roll 92 described herein corresponds to a load of the second rubbing roll 92 described later.

### Adjustment of Frictional Force of Second Rubbing Roll

In the present example, the second rubbing roll 92 corresponds to the rubbing roll 90 according to Exemplary Embodiment 1.

Therefore, in the present example, the frictional force f between the plurality of rotating bodies 80a and 80b constituting the transport roll 80 and the medium S is required to be greater than the frictional force f2 between the plurality of rotating bodies 92a and 92b constituting the second rubbing roll 92 and the medium S.

### Adjustment of Rubbing Energy of Second Rubbing Roll

In the present example as well, as in Exemplary Embodiment 1, a method of appropriately adjusting the rubbing energy Em of the second rubbing roll 92 is adopted in consideration of the use environment of the wax W (the surface temperature of the medium S and the surface state of the medium S).

That is, the rubbing energy Em of the second rubbing roll 92 is adjusted by changing the load F of the second rubbing roll 92 and the circumferential speed difference V of the second rubbing roll 92 for each temperature of the medium S.

In the present example, the rubbing energies Em of the first rubbing roll 91 and the second rubbing roll 92 may be set to be the same as each other, or may be set separately.

### Positional Relationship Among Transport Roll and First and Second Rubbing Rolls

In the present example, the positional relationship among the transport roll 80, the first rubbing roll 91, and the second rubbing roll 92 is as follows.

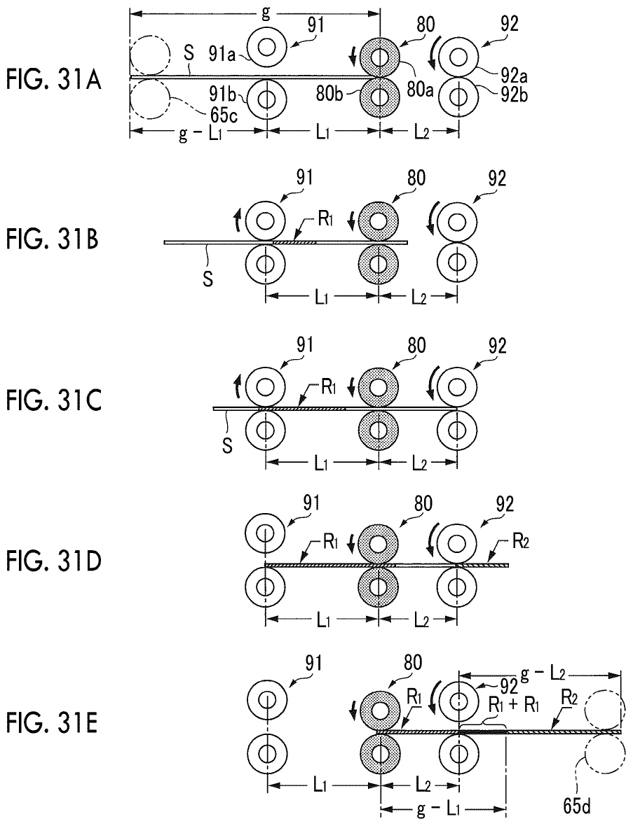

As shown in FIG. 25, in a case where a distance between a circumferential center of the contact region CN1 of the first rubbing roll 91 and a circumferential center of the contact region CN2 of the second rubbing roll 92 is denoted by L, a distance between the circumferential center of the contact region CN1 of the first rubbing roll 91 and a circumferential center of the contact region CN0 of the transport roll 80 is denoted by L1, a distance between the circumferential center of the contact region CN0 of the transport roll 80 and the circumferential center of the contact region CN2 of the second rubbing roll 92 is denoted by L2, and the transport direction length of the medium S is denoted by g (see FIG. 31A), the selection is made such that Expressions (I) and (II) are satisfied.

$$L < g \qquad ( I )$$

$$L 1 , L 2 < g / 2 \qquad ( II )$$

$$Here , L = L 1 + L 2.$$

The circumferential center of the contact region CN0 (CN1 or CN2) refers to an intersection between a straight line connecting axis centers of the plurality of rotating bodies 80a and 80b (91a and 91b, or 92a and 92b) and the contact region CN0 (CN1 or CN2).

In the present example, Expression (I) is a condition for rubbing the entire region of both the front and back surfaces of the medium S via the first rubbing roll 91 and the second rubbing roll 92.

In addition, Expression (II) is a condition for both the first rubbing roll 91 and the second rubbing roll 92 to rub a region covering more than half of both the front and back surfaces of the medium S.

In particular, in Expression (II), since L1 and L2 are less than half of the transport direction length g of the medium S, it is possible to stably transport the medium S while maintaining the transport posture of the medium S without providing the guide member or the like in the transport path of the medium S in the post-processing device 25.

In addition, in the present example, in the horizontal transport path 64, a transport roll 65c for feeding to the post-processing device 25 is disposed upstream of the post-processing device 25 in the transport direction of the medium S. On the other hand, a transport roll 65d for reception from the post-processing device 25 is disposed downstream of the post-processing device 25 in the transport direction of the medium S.

Here, in order to transport the medium S at the transport speed v0 via the transport roll 65c for feeding, the transport roll 80, and the transport roll 65d for reception, it is necessary to set an inter-roll distance among the transport roll 65c for feeding, the transport roll 80, and the transport roll 65d for reception (specifically, a distance between the circumferential centers of the contact regions of the adjacent rolls) to be shorter than the transport direction length g of the medium S.

### Control System of Post-Processing Device

In the present exemplary embodiment, as shown in FIGS. 2 and 23, the control device 120 that controls the respective elements (imaging engine 22, medium transport system 23, fixing device 24, post-processing device 25, and the like) of the image forming system 20 is provided.

In the present example, in the horizontal transport path 64, the surface information detector 130, the temperature detector 150, and the position detector 160 are provided upstream of the post-processing device 25 in the transport direction of the medium S, as shown in FIG. 23.

In the present example, the control device 120 is a device in which required programs, such as the imaging program of the image forming system 20 and the control processing program (see FIG. 17) of the post-processing device 25, are installed in advance in a memory (not shown). The control device 120 executes the imaging program by turning on a start switch (not shown), and sends out a control signal required for imaging processing to the imaging engine 22, the medium transport system 23, and the fixing device 24.

Further, it is assumed that the leading end part of the medium S, which has passed through the fixing device 24, passes through the position detector 160. In this case, the control device 120 imports detection information from the position detector 160 into the processor, and executes the control processing program of the post-processing device 25. Then, the control device 120 sends out a control signal for nip release to the first nip release mechanism 101 and the second nip release mechanism 102. Further, the control device 120 sends out a control signal for driving to each of the drive motors 86, 96, and 98 of the transport roll 80, the first rubbing roll 91, and the second rubbing roll 92.

### Basic Operation of Post-Processing Device

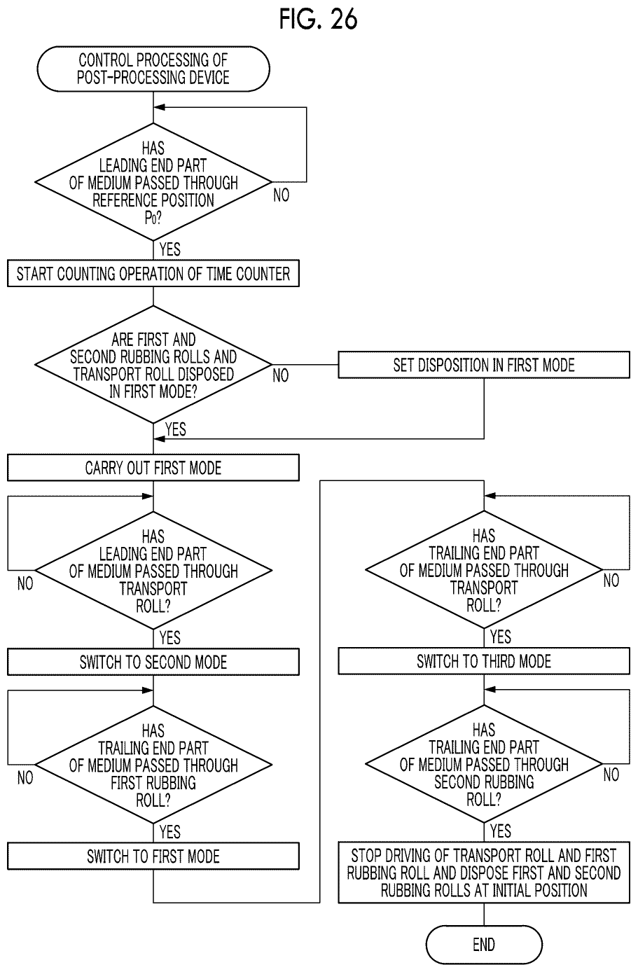

In the present example, the control device 120 executes control processing of the post-processing device 25, as shown in FIG. 26.

In FIG. 26, the control device 120 determines whether or not the leading end part of the medium S that has passed through the fixing device 24 has passed through a predetermined reference position PO. In the present example, the control device 120 determines that the leading end part of the medium S has passed through the reference position PO, based on the detection signal from the position detector 160.

Then, the control device 120 starts a counting operation of an internal time counter and uses the counting operation for discriminating the transport position of the medium S.

### First Mode

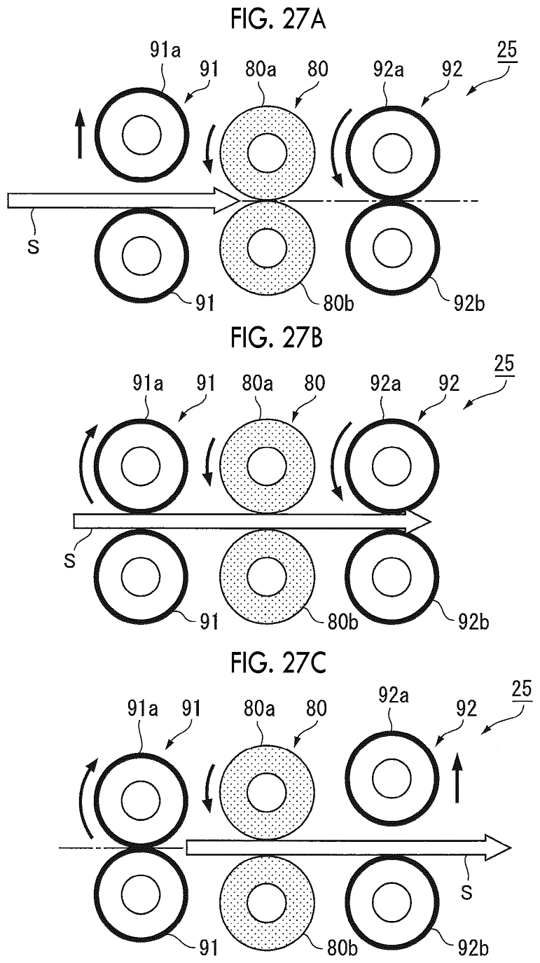

Thereafter, the control device 120 determines whether or not the first rubbing roll 91, the second rubbing roll 92, and the transport roll 80 are disposed as in a first mode. Here, the “first mode” referred to here refers to an operation behavior shown in FIG. 27A. In this case, the first rubbing roll 91 is disposed at the release position, the transport roll 80 and the second rubbing roll 92 are disposed at the nip position. The transport roll 80 and the second rubbing roll 92 located at the nip position are driven.

In the present example, in a case of the disposition in the first mode, the first mode is carried out. In a case of not the disposition in the first mode, the control device 120 disposes the first mode and then carries out the first mode.

In this state, the transport roll 80 rotates idly at the predetermined transport speed v0 at the nip position. The second rubbing roll 92 rotates idly at the speed v2 (v2>v0) in the same direction as the transport roll 80 at the nip position. On the other hand, the first rubbing roll 91 stops the driving at the release position and is in a standby state.

On the other hand, the medium S passes through the position detector 160 via the transport roll 65c for feeding (see FIG. 23), and is transported into the post-processing device 25. Then, the medium S slips as it is through the first rubbing roll 91 and is directed toward the transport roll 80.

### Switching to Second Mode

Next, the control device 120 determines whether or not the leading end part of the medium S has passed through the transport roll 80. Then, in a case where it is determined that the leading end part of the medium S has passed through the transport roll 80, the control device 120 performs switching to a second mode. Here, the “second mode” referred to here refers to an operation behavior shown in FIG. 27B. In this case, unlike the first mode, the first rubbing roll 91 is switched to the nip position to start the driving. The transport roll 80 and the second rubbing roll 92 are the same as in the first mode.

In this state, immediately after the medium S has entered the transport roll 80, the first rubbing roll 91 nips a middle portion of the medium S in the transport direction and rotates in the direction opposite to the transport roll 80 at the speed v1 (|v1|>v0).

Therefore, the medium S is transported in a state of being pulled in the transport direction between the first rubbing roll 91 and the transport roll 80. In this case, a relationship between the frictional force f1 between the first rubbing roll 91 and the medium S and the frictional force f0 between the transport roll 80 and the medium S is f1<f0. Therefore, the medium S is transported by the transport roll 80 at the transport speed v0. In this state, in a case where the first rubbing roll 91 rotates in the opposite direction at the speed v1 in the contact region CN1, the surface of the medium S is rubbed in the direction opposite to the transport direction of the medium S. As a result, the rubbing operation using the first rubbing roll 91 is continued until the trailing end of the medium S in the transport direction passes through the first rubbing roll 91. Therefore, the rubbing region R1 of the first rubbing roll 91 is a rear half region of the medium S from the middle of the medium S in the transport direction to the trailing end of the medium S in the transport direction (see FIGS. 31A to 31F).

In the second mode, in a case where the leading end part of the medium S reaches the second rubbing roll 92, the following behavior is exhibited. In the present example, in a case where the medium S enters the second rubbing roll 92, the second rubbing roll 92 nips the leading end part of the medium S, and rotates in the same direction as the transport roll 80 at the speed v2 (v2>v0).

Therefore, the medium S is transported in a state of being pulled in the transport direction between the transport roll 80 and the second rubbing roll 92. In this case, a relationship between the frictional force f2 between the second rubbing roll 92 and the medium S and the frictional force f0 between the transport roll 80 and the medium S is f2<f0. Therefore, the medium S is transported by the transport roll 80 at the transport speed v0. In this state, in a case where the second rubbing roll 92 rotates in the same direction at the speed v2 in the contact region CN2, the surface of the medium S is rubbed in the same direction as the transport direction of the medium S. As a result, the rubbing operation using the second rubbing roll 92 is continued from the leading end part of the medium S to immediately before the medium S passes through the transport roll 80. Therefore, the rubbing region R2 of the second rubbing roll 92 is a front half region of the medium S from the leading end part of the medium S to the middle of the medium S in the transport direction (see FIGS. 31A to 31E).

### Switching to First Mode

Next, the control device 120 determines whether or not a trailing end part of the medium S has passed through the first rubbing roll 91. In this case, in a case where the control device 120 determines that the trailing end part of the medium S has passed through the first rubbing roll 91, the control device 120 performs switching to the first mode. As a result, the first rubbing roll 91 is disposed at the release position and the driving is stopped.

This is because, in a case where the trailing end part of the medium S passes through the first rubbing roll 91, there is no longer any medium S as the rubbing target of the first rubbing roll 91. In the present example, the switching to the first mode is performed from the viewpoint of performing the preparation for receiving the subsequent medium Sr in advance.

### Switching to Third Mode

Thereafter, the control device 120 determines whether or not the trailing end part of the medium S has passed through the transport roll 80. Then, in a case where it is determined that the trailing end part of the medium S is immediately before passing through the transport roll 80, the control device 120 performs switching to a third mode. Here, the “third mode” referred to here refers to an operation behavior shown in FIG. 27C. In this case, the third mode refers to the operation behavior of stopping the driving by switching the second rubbing roll 92 to the release position, unlike the first mode and the second mode. In this case, the first rubbing roll 91 and the transport roll 80 need only be the same as any one of the first mode or the second mode. FIG. 27C shows a state where the first rubbing roll 91 is the same as in the second mode.

The third mode is a mode for well maintaining the transportability of the medium S discharged from the post-processing device 25. In a case where the rubbing operation using the second rubbing roll 92 is continued even after the trailing end part of the medium S has passed through the transport roll 80, the medium S is discharged by the second rubbing roll 92 at the speed v2 (v2>v0) at a point in time when the transport operation of the medium S using the transport roll 80 is no longer performed. In this case, the medium S is discharged at the speed v2 that is higher than the predetermined transport speed v0 by the second rubbing roll 92, and thus the transportability of the medium S is impaired.

### Return to Initial Position

Next, the control device 120 determines whether or not the trailing end part of the medium S has passed through the second rubbing roll 92. In the present example, in a case where it is determined that the trailing end part of the medium S has passed through the second rubbing roll 92, the control device 120 stops the driving of the transport roll 80 and the first rubbing roll 91, and disposes the first rubbing roll 91 and the second rubbing roll 92 at the initial positions. In the present example, the initial position is selected, for example, as the disposition in the first mode (the first rubbing roll 91 is at the release position and the second rubbing roll 92 is at the nip position).

### Operation Procedure Until Medium Reaches Post-Processing Device

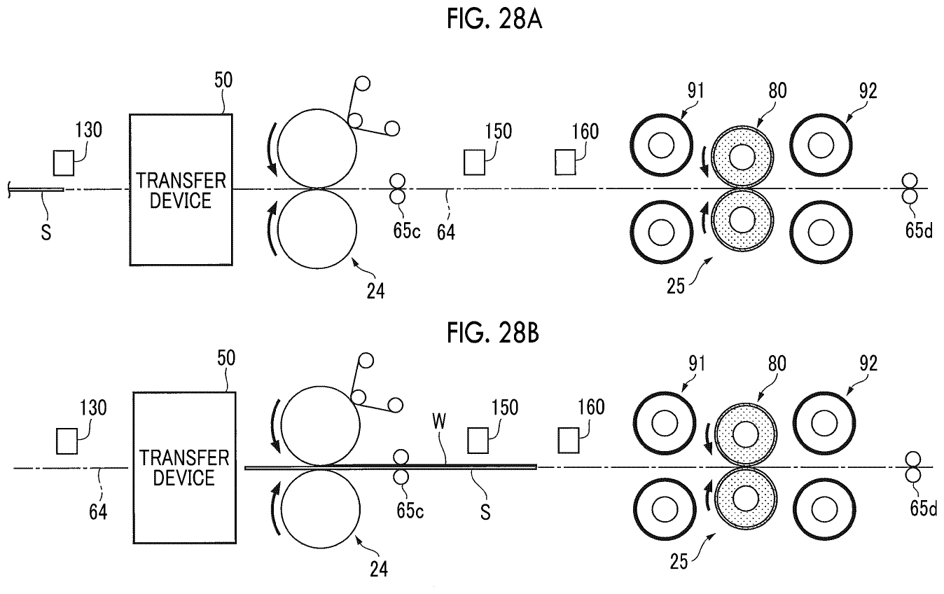

FIGS. 28A and 28B to FIGS. 30A and 30B are diagrams schematically showing an operation procedure of until the medium reaches the post-processing device. In FIGS. 28 to 30, the wax W on the medium S before the post-processing is shown, and the wax W after the post-processing is not shown.

First, in a case where the medium S passes through the horizontal transport path 64 before the transfer region TR, the surface information detector 130 detects the surface information of the medium S as shown in FIG. 28A. As a result, the control device 120 recognizes whether the medium S is the first medium type, the second medium type, or the third medium type.

Next, in a case where the medium S passes through the transfer region TR of the transfer device 50, as shown in FIG. 28B, the image produced by the imaging engine 22 is transferred to the medium S, and then the image is fixed to the medium S by the fixing device 24. In a case where the medium S that has passed through the fixing device 24 passes through the temperature detector 150, the temperature detector 150 detects the surface temperature of the medium S. In this state, the control device 120 recognizes the surface temperature of the medium S before the medium S enters the post-processing device 25. Therefore, the control device 120 adjusts the rubbing energies Em of the first rubbing roll 91 and the second rubbing roll 92 of the post-processing device 25 based on the detection results of the surface information detector 130 and the temperature detector 150. The rubbing energy Em adjusted in this manner effectively acts in spreading the wax W held on the medium S in a flattened manner by the rubbing operations using the first rubbing roll 91 and the second rubbing roll 92.

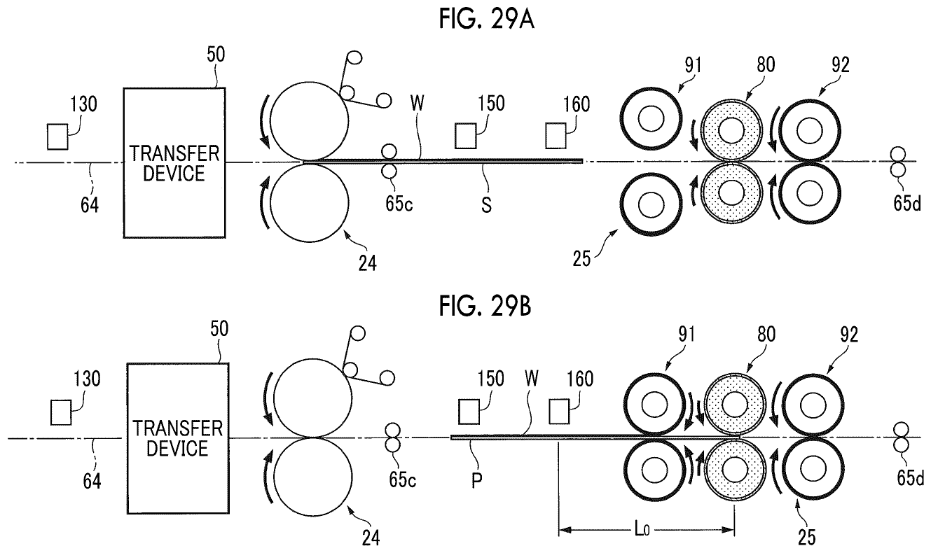

Then, as shown in FIG. 29A, in a case where the leading end of the medium S passes through the position detector 160, the control device 120 executes the pressurization and the rotation of the second rubbing roll 92. In this case, a value set for adjusting the rubbing energy Em is used as the load and the circumferential speed difference of the second rubbing roll 92.

Thereafter, as shown in FIG. 29B, after a time t1 has elapsed from the time when the leading end of the medium S has passed through the position detector 160, the pressurization and the rotation of the first rubbing roll 91 are executed. Here, t1 is a time calculated by L0/v0. Here, L0 is a distance between the position detector 160 and the center of the transport portion of the transport roll 80, and v0 is a transport speed of the transport roll 80. That is, in a case where the first rubbing roll 91 performs the pressurization and the rotation before the leading end of the medium S enters the transport roll 80, there is a concern that the medium S is jammed by the first rubbing roll 91 due to the reverse rotation of the first rubbing roll 91. From the viewpoint of preventing this concern, it is necessary to execute the pressurization and rotation of the first rubbing roll 91 after the transport operation of the medium S by the transport roll 80 is started at t1.

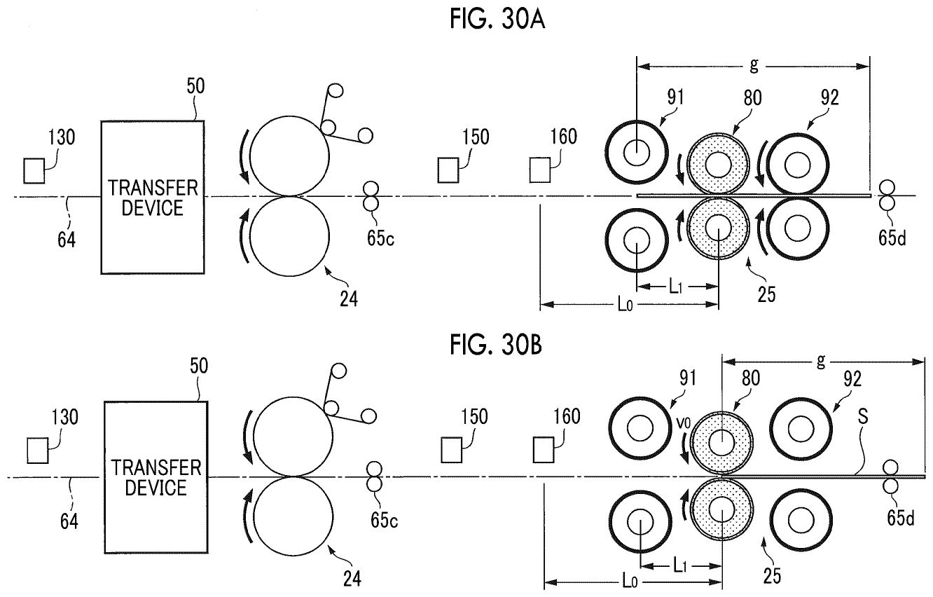

Further, as shown in FIG. 30A, after a time t2 has elapsed from the time when the leading end of the medium S has passed through the position detector 160, the rotation of the first rubbing roll 91 is stopped, and the pressurization is released. Here, t2 is a time calculated by (L0−L1+g)/v0. Here, L0 is a distance between the position detector 160 and the center of the transport portion of the transport roll 80, L1 is a distance between the center of the rubbing portion of the first rubbing roll 91 and the center of the transport portion of the transport roll, g is a length of the medium S in the transport direction, and v0 is a transport speed of the transport roll 80. That is, at a point in time when the trailing end of the medium S passes through the first rubbing roll 91, the rotation of the first rubbing roll 91 is stopped, and the pressurization is released. In this state, in the present example, the first rubbing roll 91 returns to the release position that is the initial position, and waits until the next medium S arrives.

Next, as shown in FIG. 30B, after the time t2 has elapsed from the time when the leading end of the medium S has passed through the position detector 160, the rotation of the second rubbing roll 92 is stopped, and the pressurization is released. Here, t3 is a time calculated by (L0+g)/v0. Here, L0 is a distance between the position detector 160 and the center of the transport portion of the transport roll 80, g is a length of the medium S in the transport direction, and v0 is a transport speed of the transport roll 80. That is, at a point in time when the trailing end of the medium S passes through the transport roll 80, the rotation of the second rubbing roll 92 is stopped, and the pressurization is released. In a case where the pressurization of the second rubbing roll 92 is not released at a timing at which the trailing end of the medium S exits the transport roll 80, there is a concern that the medium S is ejected at a high speed and jammed due to the high-speed rotation of the second rubbing roll 92.

### Post-Processing Operation Procedure of Post-Processing Device

FIGS. 31A to 31E are diagrams showing a post-processing operation procedure of the post-processing device 25 in time series.

In the same drawing, the distance L1 between the first rubbing roll 91 and the transport roll 80 and the distance L2 between the transport roll 80 and the second rubbing roll 92 may be selected as appropriate such that Expression (I): L1+L2=L<g (length of medium S in transport direction) and Expression (II): L1, L2<g/2 are satisfied (see paragraph [0096]).

Therefore, a representative aspect is L1=L2, but L1>L2 or L1<L2 may be acceptable. FIGS. 31A to 31E show a case where L1>L2.

FIG. 31A shows a state where the leading end part of the medium S enters the transport roll 80. In this case, since the first mode is carried out, the medium S is transported by the transport roll 65c for feeding located on the inlet side of the post-processing device 25, slips through the first rubbing roll 91 located at the release position, and enters the transport roll 80.

FIG. 31B shows a state after the leading end part of the medium S has entered the transport roll 80. In this case, the second mode is carried out, so that the first rubbing roll 91 is disposed at the nip position to start the driving. Then, the rubbing operation using the first rubbing roll 91 is carried out from the middle of the medium S in the transport direction. In FIG. 31B, R1 indicates a rubbing region (corresponding to a hatched region in the diagonally lower left in the drawing) of the first rubbing roll 91 with respect to the medium S.

FIG. 31C shows a state where the leading end part of the medium S has entered the second rubbing roll 92. In this case, since the second mode is still being carried out, the rubbing operation using the second rubbing roll 92 is started from the leading end part of the medium. The rubbing operation using the first rubbing roll 91 is continuously carried out.

FIG. 31D shows a state where the trailing end part of the medium S passes through the first rubbing roll 91. In this case, the switching to the first mode is performed, the first rubbing roll 91 is disposed at the release position, and the driving is stopped. During this period, the rubbing operation using the first rubbing roll 91 is carried out from the middle of the medium S in the transport direction to the trailing end part of the medium S. In addition, the rubbing operation using the second rubbing roll 92 is carried out from the leading end part of the medium S toward the downstream side of the medium S in the transport direction. In FIG. 31D, R2 indicates a rubbing region (corresponding to a hatched region in the diagonally lower right in the drawing) of the second rubbing roll 92 with respect to the medium S.

FIG. 31E shows a state immediately before the trailing end part of the medium S passes through the transport roll 80. In this case, the switching to the third mode is performed, the second rubbing roll 92 is disposed at the release position, and the driving is stopped. During this period, the rubbing operation using the second rubbing roll 92 is carried out from the leading end part of the medium S to the middle of the medium S in the transport direction. The rubbing operation using the second rubbing roll 92 is stopped at a stage in which the second rubbing roll 92 is disposed at the release position. In FIG. 31E, the rubbing region R2 of the second rubbing roll 92 is provided substantially within a g-L2 range. On the other hand, the rubbing region R1 of the first rubbing roll 91 is provided substantially within the g-L1 range.

In addition, in a case where the switching to the third mode is performed, the leading end part of the medium S is nipped and transported by the transport roll 65d located on the outlet side of the post-processing device 25. Therefore, the transportability of the medium S discharged from the post-processing device 25 is well maintained.

Form Change in Wax on Medium before and after Post-Processing

As described above, in the present example, as shown in FIG. 31E, in the wax post-processing using the post-processing device 25, both the front and back surfaces of the medium S are rubbed in the rubbing region R1 of the first rubbing roll 91 and the rubbing region R2 of the second rubbing roll 92. In the present example, since R1+R2=2g−L (g>L) is satisfied, it is understood that the wax post-processing using the post-processing device 25 is realized with the entire region of both the front and back surfaces of the medium S as the rubbing target. In addition, in the present example, the rubbing regions R1 and R2 are in a partially overlapping state in the middle portion of the transport direction of the medium S, and the relationship of R2>R1 is satisfied.

In the present exemplary embodiment as well, as in Exemplary Embodiment 1, it is confirmed that the form of the wax W changed from the granular mass Wa to the thin film-like layer Wb before and after the post-processing using the post-processing device 25. In this case, it is confirmed that, in a case where the wax W after the post-processing is changed to the thin film-like layer Wb having the thickness tr equal to or less than 0.15 μm, the wax W is hardly visible to the naked eye.

In particular, in the present exemplary embodiment, a method of adjusting the rubbing energies Em of the first rubbing roll 91 and the second rubbing roll 92 is adopted in consideration of the use environment conditions of the wax W (the surface condition of the medium and the temperature condition of the medium). Therefore, it is possible to more appropriately exhibit the effect of spreading the wax W by the rubbing operations using the first rubbing roll 91 and the second rubbing roll 92, as compared with a case where the rubbing energies Em of the first rubbing roll 91 and the second rubbing roll 92 are made constant.

### C Modification Example

(1) In the present exemplary embodiment, in a case where the first rubbing roll 91 (or second rubbing roll 92) is disposed at the release position, the driving of the plurality of rotating bodies 91a and 91b (or 92a and 92b) is stopped. However, the first rubbing roll 91 (or second rubbing roll 92) may be disposed at the release position without stopping the driving of the plurality of rotating bodies 91a and 91b (or 92a and 92b).

(2) In the present exemplary embodiment, the second mode is once switched to the first mode and then switched to the third mode, but the second mode may be switched to the third mode without passing through the first mode.

(3) In the present exemplary embodiment, the disposition of the first mode is selected as the initial position of the post-processing device 25, but the disposition of the second mode (both the first rubbing roll 91 and the second rubbing roll 92 are at the nip position) can also be selected.

(4) In the present exemplary embodiment, the aspect is adopted in which the first rubbing roll 91 is disposed upstream of the common transport roll 80 in the transport direction of the medium S and the second rubbing roll 92 is disposed downstream of the common transport roll 80 in the transport direction of the medium S, but the present invention is not limited to this, and the first rubbing roll 91 and the second rubbing roll 92 may be disposed with respect to separate transport rolls 80.

(5) In the present exemplary embodiment, the post-processing device 25 uses the sheet-like medium S as a processing target, but the present invention is not limited to this, and a continuous medium may be used as a processing target.

### Exemplary Embodiment 4

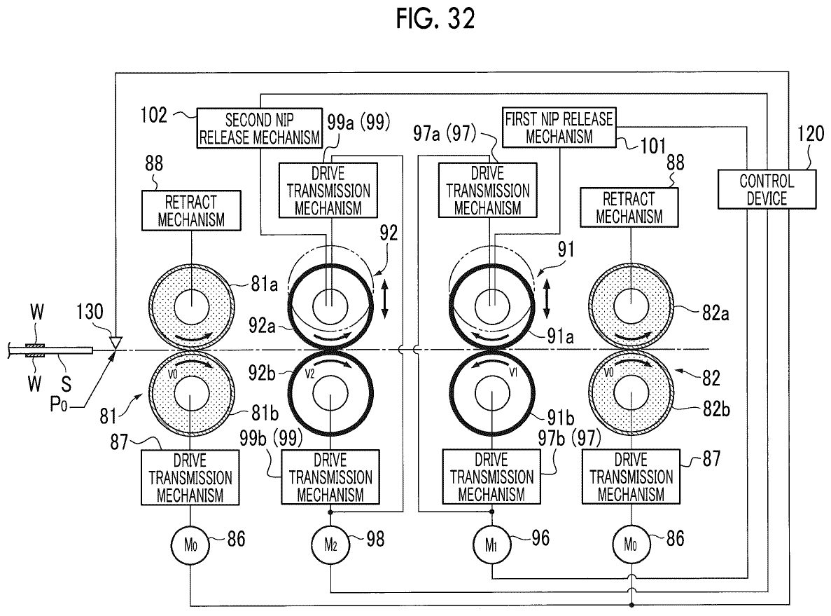

FIG. 32 shows a major portion of a post-processing device built in an image forming system according to Exemplary Embodiment 4.

In the present example, the basic configuration of the image forming system 20 is substantially the same as the basic configuration in Exemplary Embodiment 3 shown in FIG. 23. The post-processing device 25 performs the post-processing of changing the wax remaining on the medium S from a visible state (granular mass) to a less visible state (smoothed state) as in Exemplary Embodiment 3.

### Basic Configuration of Post-Processing Device

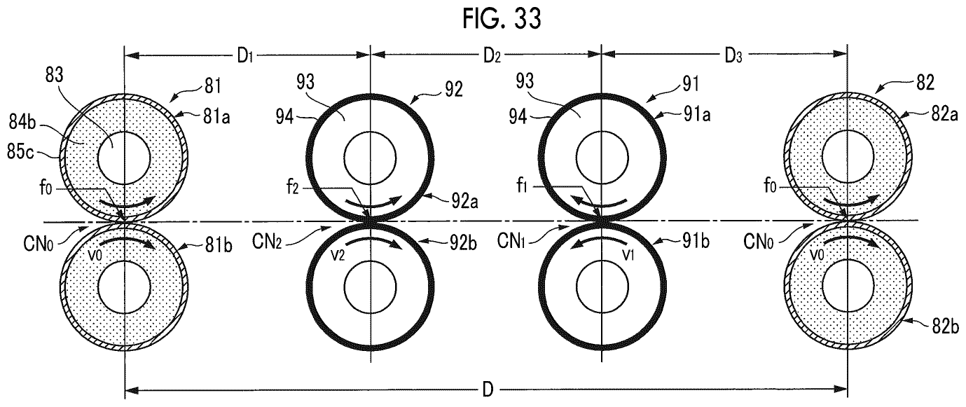

In the present example, as shown in FIGS. 32 and 33, the post-processing device 25 includes a first transport roll 81, a second transport roll 82, the first rubbing roll 91, and the second rubbing roll 92, unlike Exemplary Embodiment 1. These components are mounted in a housing (not shown) in an appropriate arrangement. In the housing (not shown), an inlet opening and an outlet opening for the medium S to pass through are formed.

Here, the first transport roll 81 transports the medium S that has passed through the fixing device 24, at the predetermined transport speed v0 by nipping the medium S. The second transport roll 82 is located downstream of the first transport roll 81 in the transport direction of the medium S, and transports the medium S at the same speed as the transport speed v0 by nipping the medium S.

Further, the first rubbing roll 91 is located downstream of the first transport roll 81 in the transport direction of the medium S, and is located upstream of the second transport roll 82 in the transport direction of the medium S. The first rubbing roll 91 rubs the surface of the medium S in the direction opposite to the transport direction of the medium S at the speed v2 that is different from the transport speed v0. Further, the second rubbing roll 92 is located downstream of the first transport roll 81 in the transport direction of the medium S, and is located upstream of the first rubbing roll 91 in the transport direction of the medium S. Then, the second rubbing roll 92 rubs the surface of the medium S in the same direction as the transport direction of the medium S at the speed v2 that is higher than the transport speed v0.

In the present example, the first rubbing roll 91 and the second rubbing roll 92 are configured to rub both the front and back surfaces of the medium S, as in Exemplary Embodiment 3. However, unlike Exemplary Embodiment 3, the second rubbing roll 92 is disposed upstream of the first rubbing roll 91 in the transport direction of the medium S.

### First Transport Roll

### Configuration Example and Drive Method of First Transport Roll

In the present example, as shown in FIGS. 32 and 33, the first transport roll 81 consists of a plurality of rotating bodies 81a and 81b that are disposed to face each other with respect to the medium S. The rotating bodies 81a and 81b constituting the first transport roll 81 have the same structure (three-layer structure including a shaft 83, an elastic layer 84, and a mold-releasing layer 85) as the transport roll 80 according to Exemplary Embodiment 1.

In the present example, the plurality of rotating bodies 81a and 81b are disposed in contact with each other, and the medium S is nipped in a contact region CN0 between the rotating bodies 81a and 81b and transported. Here, in the first transport roll 81, among the plurality of rotating bodies 81a and 81b, for example, the rotating body 81b located on the lower side is a driving roll, and the rotating body 81a located on the upper side is a driven roll. Then, the drive force from the drive motor 86 is transmitted to the rotating body 81b as a driving roll via the drive transmission mechanism 87 such as the drive transmission gear train.

### Retract Configuration Example of First Transport Roll

In the present example, as shown in FIG. 32, the retract mechanism 88 as the retractable retract section is provided in one rotating body 81a of the first transport roll 81. The retract mechanism 88 has the same configuration (support shaft 88a, support arms 88b, and operation lever 88c) as the retract mechanism 88 used for the transport roll 80 according to Exemplary Embodiment 1.

### Setting of Nip Pressure of First Transport Roll

As in the transport roll 80 according to Exemplary Embodiment 1, biasing springs 114 as the biasing sections for adjusting a nip pressure (corresponding to a contact pressure of the contact region CN0 between the plurality of rotating bodies 81a and 81b) of the first transport roll 81 are provided at both ends of one rotating body 81a of the first transport roll 81. The biasing spring 114 is composed of, for example, a compression coil spring, and can variably set a biasing force by adjusting the compression deformation amount via an adjustment portion (not shown). As a result, the nip pressure of the first transport roll 81 is set.

### Second Transport Roll

### Configuration Example and Drive Method of Second Transport Roll

In the present example, as shown in FIGS. 32 and 33, the second transport roll 82 consists of a plurality of rotating bodies 82a and 82b that are disposed to face each other with respect to the medium S. The rotating bodies 82a and 82b constituting the second transport roll 82 have a three-layer structure including the shaft 83, the elastic layer 84, and the mold-releasing layer 85, as in the plurality of rotating bodies 81a and 81b constituting the first transport roll 81.

In the present example, the plurality of rotating bodies 82a and 82b are disposed in contact with each other, and the medium S is nipped in the contact region CN0 between the rotating bodies 82a and 82b and transported. Here, in the second transport roll 82, among the plurality of rotating bodies 82a and 82b, for example, the rotating body 82b located on the lower side is a driving roll, and the rotating body 82a located on the upper side is a driven roll. Then, the drive force from the drive motor 86 is transmitted to the rotating body 82b as a driving roll via the drive transmission mechanism 87 such as the drive transmission gear train.

### Retract Configuration Example of Second Transport Roll

In the present example, as shown in FIGS. 7, 9A, and 9B, the retract mechanism 88 (specifically, support shaft 88a, support arms 88b, and operation lever 88c) as the retractable retract section is provided in one rotating body 82a of the second transport roll 82, as in the first transport roll 81.

### Setting of Nip Pressure of Second Transport Roll

As in the first transport roll 81, the biasing springs 114 as the biasing sections for adjusting a nip pressure (corresponding to a contact pressure of the contact region CN0 between the plurality of rotating bodies 82a and 82b) of the second transport roll 82 are provided at both ends of one rotating body 82a of the second transport roll 82.

### First Rubbing Roll

### Configuration Example of First Rubbing Roll

In the present example, as shown in FIGS. 32 and 33, the first rubbing roll 91 consists of a plurality of rotating bodies 91a and 91b that are disposed to face each other with respect to the medium S. In the present example, the rotating bodies 91a and 91b constituting the first rubbing roll 91 need only have, at least on the surface, a rubbing portion in substantially the same manner as in Exemplary Embodiment 3. In the present example, the first rubbing roll 91 has a structure in which the surface of the solid shaft 93 made of metal such as SUS is covered with the nonwoven fabric 94.

### Drive Method of First Rubbing Roll

The first rubbing roll 91 uses both the rotating bodies 91a and 91b as driving rolls, as in Exemplary Embodiment 3. That is, a drive force from a drive motor 96 is transmitted to both the rotating bodies 91a and 91b via drive transmission mechanisms 97 (specifically, 97a and 97b) such as drive transmission gear trains. Here, the drive transmission mechanisms 97a and 97b may be partially shared or may be separately provided.

### Speed Condition of First Rubbing Roll

As shown in FIGS. 32 and 33, the first rubbing roll 91 need only rub the surface of the medium S in the direction opposite to the transport direction of the medium S at the speed v1 that is different from the transport speed v0 of the second transport roll 82.

In the present example, the first rubbing roll 91 is selected so as (i) to rotate in the direction opposite to the transport direction of the medium S in the contact region CN1 between the plurality of rotating bodies 91a and 91b, as in Exemplary Embodiment 3. That is, the rotating body 91a located on the upper side rotates in a clockwise direction, and the rotating body 91b located on the lower side rotates in a counterclockwise direction.

The reason for the selection is based on the viewpoint that the rubbing resistance caused by the first rubbing roll 91 is increased. In a case of such a selection, a speed difference (v0-v1) that is the circumferential speed difference between the first rubbing roll 91 and the second transport roll 82 can be increased. Here, the speed v1 of the first rubbing roll 91 may be selected as appropriate, but is set to about 5 to 10 times v0 in the absolute value in the present example.

In order to rub the surface of the medium S via the first rubbing roll 91 in the direction opposite to the transport direction of the medium S, in addition to (i), the first rubbing roll 91 may be selected so as (ii) to maintain a stop state in the contact region CN1 or (iii) to rotate in the same direction as the transport direction of the medium S at the speed that is lower than the transport speed v0 of the medium S in the contact region CN1. However, it should be noted that the rubbing resistance caused by the first rubbing roll 91 is smaller in the methods of (ii) and (iii) than in the method of (i).

### Contact/Separation Configuration Example of First Rubbing Roll

In the present example, the first rubbing roll 91 includes the first nip release mechanism 101, as in Exemplary Embodiment 3. As shown in FIG. 32, the first nip release mechanism 101 is provided on one rotating body 91a of the first rubbing roll 91. The first nip release mechanism 101 is configured in the same manner as the nip release mechanism 100 used in Exemplary Embodiment 1. The first nip release mechanism 101 supports both ends of the shaft 93 of the rotating body 91a, and switches between the nip state of the first rubbing roll 91 (corresponding to the contact state between the plurality of rotating bodies 91a and 91b) and the release state (corresponding to the non-contact state between the plurality of rotating bodies 91a and 91b) based on the control signal.

In the present example, the first nip release mechanism 101 has the same constituent elements (support shaft 103, support arms 104, and nip release motor 105) as in Exemplary Embodiment 1 (see FIG. 10B).

### Setting of Nip Pressure of First Rubbing Roll

In the present example, as in Exemplary Embodiment 3 (the rubbing roll 90 according to Exemplary Embodiment 1), the first rubbing roll 91 is provided with the biasing spring 115 as the biasing section for adjusting the nip pressure of the first rubbing roll 91 (corresponding to the contact pressure of the contact region of the plurality of rotating bodies 91a and 91b) (see FIGS. 10A and 10D). The biasing spring 115 is composed of, for example, a compression coil spring, and the biasing spring 115 is provided with an adjustment portion 116 that adjusts the compression deformation amount. As a result, the nip pressure (or load) of the first rubbing roll 91 is variably set.

### Adjustment of Frictional Force of First Rubbing Roll

In the present example, the first rubbing roll 91 and the second transport roll 82 come into contact with the medium S that moves. In this case, in a case where the medium S passes through the contact region CN1 of the first rubbing roll 91, as shown in FIG. 33, the frictional force f1 is generated between the first rubbing roll 91 and the medium S. On the other hand, in a case where the medium S passes through the contact region CN0 of the second transport roll 82, a frictional force f0 is generated between the second transport roll 82 and the medium S.

In the present example, the frictional force f0 between the plurality of rotating bodies 82a and 82b constituting the second transport roll 82 and the medium S is required to be greater than the frictional force f1 between the plurality of rotating bodies 91a and 91b constituting the first rubbing roll 91 and the medium S.

Here, in a case where a normal force applied to the contact region CN0 of the second transport roll 82 is denoted by U0, a kinetic friction coefficient between the second transport roll 82 and the medium S is denoted by μ0, a normal force applied to the contact region CN1 of the first rubbing roll 91 is denoted by U1, and a kinetic friction coefficient between the first rubbing roll 91 and the medium S is denoted by μ1, the relationship is represented as follows.

$$f 0 = μ 0 \cdot U 0$$

$$f 1 = μ 1 \cdot U 1$$

In order to satisfy the condition of f0>f1, since the kinetic friction coefficients μ0 and μ1 are values dependent on the materials and the like, the biasing forces of the biasing springs 114 and 115 that affect the normal forces U0 and U1 need only be adjusted in consideration of the respective kinetic friction coefficients. Here, since U0 is selected such that the transportability of the medium S is ensured at an appropriate level, for example, it is preferable to mostly adjust the biasing force of the biasing spring 115 and appropriately adjust the frictional force f1.

### Adjustment of Rubbing Energy of First Rubbing Roll

In the present example as well, as in Exemplary Embodiment 3, a method of appropriately adjusting the rubbing energy Em of the first rubbing roll 91 is adopted in consideration of the use environment of the wax W (the surface temperature of the medium S and the surface state of the medium S).

That is, the rubbing energy Em of the first rubbing roll 91 is adjusted by changing the load F of the first rubbing roll 91 and the circumferential speed difference V of the first rubbing roll 91 for each temperature of the medium S.

### Second Rubbing Roll

### Configuration Example of Second Rubbing Roll

In the present example, as shown in FIGS. 32 and 33, the second rubbing roll 92 consists of a plurality of rotating bodies 92a and 92b that are disposed to face each other with respect to the medium S. In the present example, the rotating bodies 92a and 92b constituting the second rubbing roll 92 have the same structure (shaft 93 and nonwoven fabric 94) as the first rubbing roll 91.

### Drive Method of Second Rubbing Roll

In the present example, the second rubbing roll 92 uses both the rotating bodies 92a and 92b as driving rolls, as in the first rubbing roll 91. That is, a drive force from a drive motor 98 is transmitted to both the rotating bodies 92a and 92b via drive transmission mechanisms 99 (specifically, 99a and 99b) such as drive transmission gear trains. Here, the drive transmission mechanisms 99a and 99b may be partially shared or may be separately provided.

### Speed Condition of Second Rubbing Roll

As shown in FIGS. 32 and 33, the second rubbing roll 92 need only rub the surface of the medium S in the same direction as the transport direction of the medium S at the speed v2 that is higher than the transport speed v0 of the first transport roll 81.

In the present example, the second rubbing roll 92 is selected to rotate in the same direction as the transport direction of the medium S in the contact region CN2 between the plurality of rotating bodies 92a and 92b. That is, the rotating body 92a located on the upper side rotates in a counterclockwise direction, and the rotating body 92b located on the lower side rotates in a clockwise direction.

In a case of such a selection, a speed difference (v2-v0) that is the circumferential speed difference between the second rubbing roll 92 and the first transport roll 81 is greater than zero. Therefore, the medium S is transported by the first transport roll 81 at the transport speed v0. In this situation, in a case where the medium S passes through the second rubbing roll 92, the rubbing operation using the second rubbing roll 92 on the surface of the medium S is ensured.

Here, the speed v2 of the second rubbing roll 92 may be selected as appropriate. However, in order to increase the rubbing resistance caused by the second rubbing roll 92, for example, it is preferable to set v2 to be large. In the present example, the value is set to about 5 to 10 times v0 in the absolute value.

### Contact/Separation Configuration Example of Second Rubbing Roll

In the present example, the second rubbing roll 92 includes a second nip release mechanism 102, similar to the first nip release mechanism 101 of the first rubbing roll 91. As shown in FIG. 32, the second nip release mechanism 102 is provided on one rotating body 92a of the second rubbing roll 92. As in the first nip release mechanism 101, the second nip release mechanism 102 supports both ends of the shaft 93 of the rotating body 92a, and switches between the nip state of the second rubbing roll 92 (corresponding to the contact state between the plurality of rotating bodies 92a and 92b) and the release state (corresponding to the non-contact state between the plurality of rotating bodies 92a and 92b) based on the control signal.

In the present example, the second nip release mechanism 102 has the same constituent elements (support shaft 103, support arms 104, and nip release motor 105) as the first nip release mechanism 101 (see FIG. 10B).

### Setting of Nip Pressure of Second Rubbing Roll

In the present example, the biasing springs 117 as the biasing sections for adjusting the nip pressure (corresponding to the contact pressure of the contact region of the plurality of rotating bodies 92a and 92b) of the second rubbing roll 92 are provided in the second rubbing roll 92, as in the first rubbing roll 91 (corresponding to the rubbing roll 90 according to Exemplary Embodiment 1). The biasing spring 117 is composed of, for example, a compression coil spring, and the biasing spring 117 is provided with an adjustment portion 118 that adjusts the compression deformation amount. As a result, the nip pressure (or load) of the first rubbing roll 91 is variably set.

### Adjustment of Frictional Force of Second Rubbing Roll

In the present example, the second rubbing roll 92 and the first transport roll 81 come into contact with the medium S that moves. In this case, in a case where the medium S passes through the contact region CN2 of the second rubbing roll 92, as shown in FIG. 19, a frictional force f2 is generated between the second rubbing roll 92 and the medium S. On the other hand, in a case where the medium S passes through the contact region CN0 of the first transport roll 81, a frictional force f0 is generated between the first transport roll 81 and the medium S.

In the present example, the frictional force f0 between the plurality of rotating bodies 81a and 81b constituting the first transport roll 81 and the medium S is required to be greater than the frictional force f2 between the plurality of rotating bodies 92a and 92b constituting the second rubbing roll 92 and the medium S.

Here, in a case where a normal force applied to the contact region CN0 of the first transport roll 81 is denoted by U0, a kinetic friction coefficient between the first transport roll 81 and the medium S is denoted by μ0, a normal force applied to the contact region CN2 of the second rubbing roll 92 is denoted by U2, and a kinetic friction coefficient between the second rubbing roll 92 and the medium S is denoted by μ2, the relationship is represented as follows.

$$f 0 = μ 0 \cdot U 0$$

$$f 2 = μ 2 \cdot U 2$$

In order to satisfy the condition of f0>f2, since the kinetic friction coefficients μ0 and μ2 are values dependent on the materials and the like, the biasing forces of the biasing springs 114 and 117 that affect the normal forces U0 and U2 need only be adjusted in consideration of the respective kinetic friction coefficients. Here, since U0 is selected such that the transportability of the medium S is ensured at an appropriate level, it is preferable to mostly adjust the biasing force of the biasing spring 117 and appropriately adjust the frictional force f2.

### Adjustment of Rubbing Energy of Second Rubbing Roll

In the present example as well, as in Exemplary Embodiment 3, a method of appropriately adjusting the rubbing energy Em of the second rubbing roll 92 is adopted in consideration of the use environment of the wax W (the surface temperature of the medium S and the surface state of the medium S).

That is, the rubbing energy Em of the second rubbing roll 92 is adjusted by changing the load F of the second rubbing roll 92 and the circumferential speed difference V of the second rubbing roll 92 for each temperature of the medium S.

In the present example, the rubbing energies Em of the first rubbing roll 91 and the second rubbing roll 92 may be set to be the same as each other, or may be set separately.

### Positional Relationship Between First and Second Transport Rolls and First and Second Rubbing Rolls

In the present example, positional relationships between the first transport roll 81 and the second transport roll 82 and between the first rubbing roll 91 and the second rubbing roll 92 are as follows.

As shown in FIG. 33, in a case in which a distance between a circumferential center of the contact region CN0 of the first transport roll 81 and a circumferential center of the contact region CN0 of the second transport roll 82 is denoted by D, a distance between the circumferential center of the contact region CN0 of the first transport roll 81 and a circumferential center of the contact region CN2 of the second rubbing roll 92 is denoted by D1, a distance between the circumferential center of the contact region CN2 of the second rubbing roll 92 and a circumferential center of the contact region CN1 of the first rubbing roll 91 is denoted by D2, a distance between the circumferential center of the contact region CN1 of the first rubbing roll 91 and the circumferential center of the contact region CN0 of the second transport roll 82 is denoted by D3, and the transport direction length of the medium S is denoted by g (see FIG. 23), the selection is made such that Expressions (III) and (IV) are satisfied.

$$D < g \qquad ( III )$$

$$D 1 , D < g / 2 \qquad ( IV )$$

$$Here , D = D 1 + D 2 + D 3.$$

The circumferential center of the contact region CN0 (CN1 or CN2) refers to an intersection between a straight line connecting axis centers of the plurality of rotating bodies 81a and 81b or 82a and 82b (91a and 91b, or 92a and 92b) and the contact region CN0 (CN1 or CN2).

In the present example, Expression (III) is a condition for transporting the medium S at the transport speed v0 via the first transport roll 81 and the second transport roll 82.

Expression (III) is also a condition for rubbing the entire region of both the front and back surfaces of the medium S via the first rubbing roll 91 and the second rubbing roll 92.

In addition, Expression (IV) is a condition for both the first rubbing roll 91 and the second rubbing roll 92 to rub a region covering more than half of both the front and back surfaces of the medium S.

In particular, in Expression (IV), since D1 and D3 are less than half of the transport direction length g of the medium S, it is possible to stably transport the medium S while maintaining the transport posture of the medium S without providing the guide member or the like in the transport path of the medium S in the post-processing device 25.

In addition, in the present example, in the horizontal transport path 64, a transport roll 65c for feeding to the post-processing device 25 is disposed upstream of the post-processing device 25 in the transport direction of the medium S. On the other hand, a transport roll 65d for reception from the post-processing device 25 is disposed downstream of the post-processing device 25 in the transport direction of the medium S.

Here, in order to transport the medium S at the transport speed v0 via the transport roll 65c for feeding, the first transport roll 81, the second transport roll 82, and the transport roll 65d for reception, it is necessary to set a distance between the transport roll 65c for feeding and the first transport roll 81 and a distance between the second transport roll 82 and the transport roll 65d for reception (specifically, a distance between the circumferential centers of the contact regions of the respective adjacent rolls) to be shorter than the transport direction length g of the medium S.

### Control System of Post-Processing Device

In the present exemplary embodiment, as shown in FIG. 32, a control device 120 that controls the respective elements (imaging engine 22, medium transport system 23, fixing device 24, post-processing device 25, and the like) of the image forming system 20 is provided.

The control device 120 is configured with a microcomputer including various processors, as in Exemplary Embodiment 1. In the present example, the surface information detector 130, the temperature detector 150, and the position detector 160 are provided upstream of the post-processing device 25 in the transport direction of the medium S in the horizontal transport path 64.

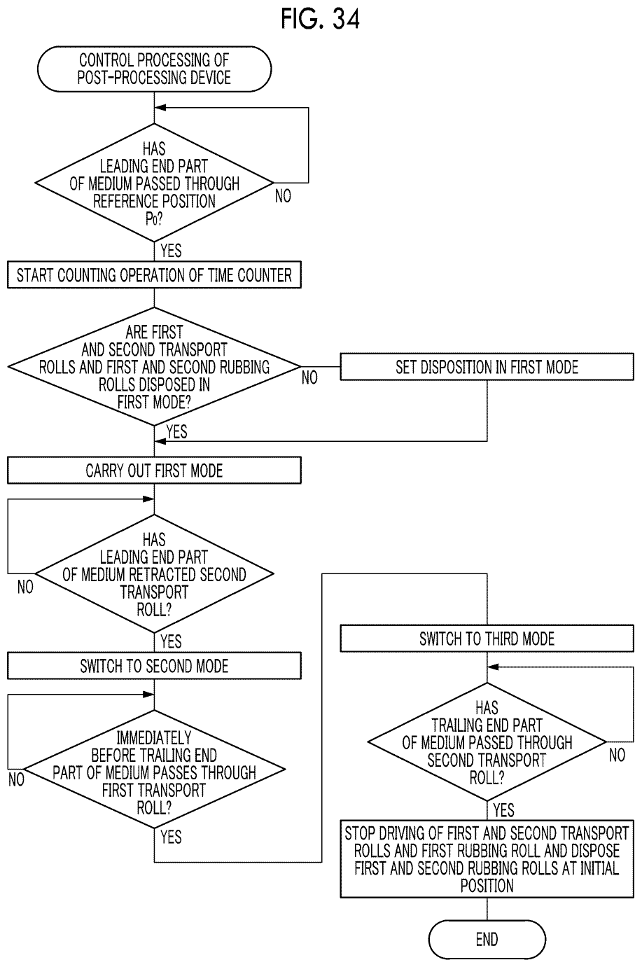

In the present example, the control device 120 is a device in which required programs, such as the imaging program of the image forming system 20 and the control processing program (see FIG. 34) of the post-processing device 25, are installed in advance in a memory (not shown). The control device 120 executes the imaging program by turning on a start switch (not shown), and sends out a control signal required for imaging processing to the imaging engine 22, the medium transport system 23, and the fixing device 24.

Further, it is assumed that the leading end part of the medium S, which has passed through the fixing device 24, passes through the position detector 160. In this case, the control device 120 imports the detection signal from the position detector 160 into the processor, and executes the control processing program of the post-processing device 25. Then, the control device 120 sends out a control signal for nip release to the first nip release mechanism 101 and the second nip release mechanism 102. Further, the control device 120 sends out a control signal for driving to each of the drive motors 86, 96, and 98 of the first transport roll 81, the second transport roll 82, the first rubbing roll 91, and the second rubbing roll 92.

### Operation of Post-Processing Device

In the present example, the control device 120 executes control processing of the post-processing device 25, as shown in FIG. 34.

In FIG. 34, the control device 120 determines whether or not the leading end part of the medium S that has passed through the fixing device 24 has passed through a predetermined reference position PO. In the present example, the control device 120 determines that the leading end part of the medium S has passed through the reference position PO, based on the detection signal from the position detector 160.

Then, the control device 120 starts a counting operation of an internal time counter and uses the counting operation for discriminating the transport position of the medium S.

### First Mode

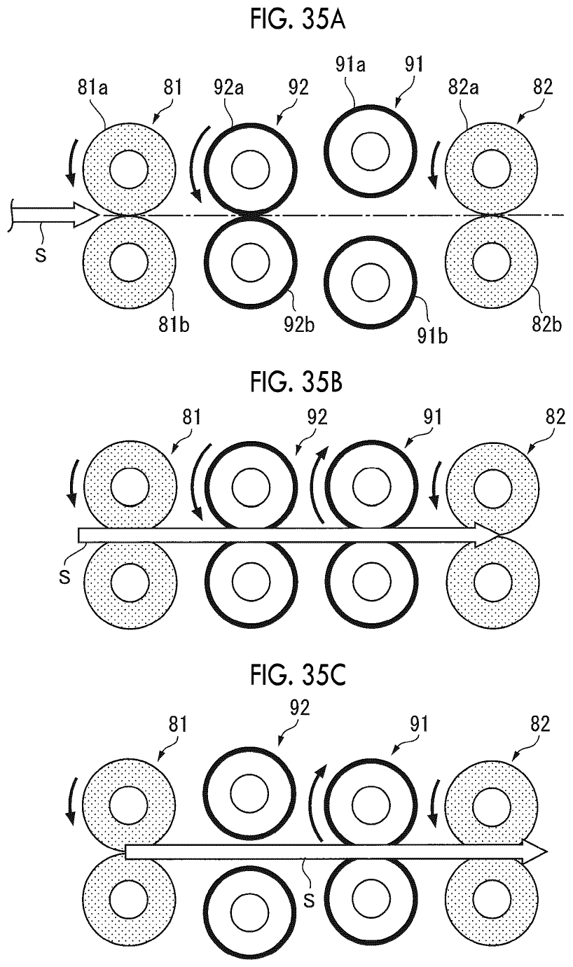

Thereafter, the control device 120 determines whether or not the first rubbing roll 91, the second rubbing roll 92, the first transport roll 81, and the second transport roll 82 are disposed as in a first mode. Here, the “first mode” referred to here refers to an operation behavior shown in FIG. 35A. In this case, the first rubbing roll 91 is disposed at a release position, the first transport roll 81, the second transport roll 82, and the second rubbing roll 92 are disposed at a nip position. The first transport roll 81, the second transport roll 82, and the second rubbing roll 92 located at the nip position are driven.

In the present example, in a case of the disposition in the first mode, the first mode is carried out. In a case of not the disposition in the first mode, the control device 120 disposes the first mode and then carries out the first mode.

In this state, the first transport roll 81 and the second transport roll 82 rotate idly at the predetermined transport speed v0 at the nip position. The second rubbing roll 92 rotates idly in the same direction as the first transport roll 81 and the second transport roll 82 at the speed v2 (v2>v0) at the nip position. On the other hand, the first rubbing roll 91 stops the driving at the release position and is in a standby state.

On the other hand, the medium S passes through the position detector 160 via the transport roll 65c for feeding (see FIG. 2), and is transported into the post-processing device 25. Thereafter, the medium S is drawn in by the first transport roll 81 and is directed toward the second rubbing roll 92.

In the first mode, in a case where the leading end part of the medium S reaches the second rubbing roll 92, the following behavior is exhibited. In the present example, in a case where the medium S enters the second rubbing roll 92, the second rubbing roll 92 nips the leading end part of the medium S, and rotates in the same direction as the first transport roll 81 at the speed v2 (v2>v0).

Therefore, the medium S is transported in a state of being pulled in the transport direction between the first transport roll 81 and the second rubbing roll 92. In this case, a relationship between the frictional force f2 between the second rubbing roll 92 and the medium S and the frictional force f0 between the first transport roll 81 and the medium S is f2<f0. Therefore, the medium S is transported by the first transport roll 81 at the transport speed v0.

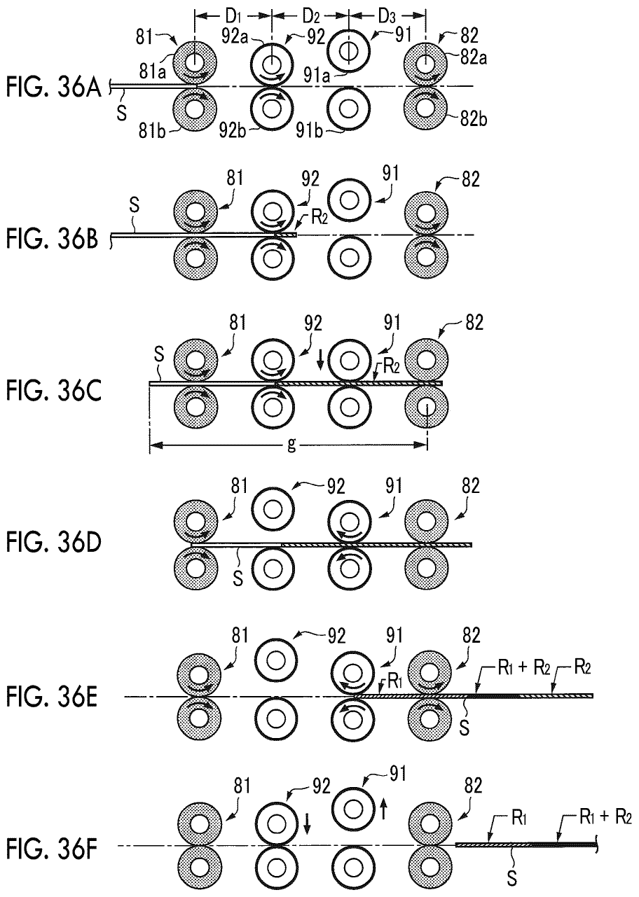

In this state, in a case where the second rubbing roll 92 rotates in the same direction as the transport direction of the medium S at the speed v2 in the contact region CN2, the surface of the medium S is rubbed in the same direction as the transport direction of the medium S. As a result, the rubbing operation using the second rubbing roll 92 is continued from the leading end part of the medium S to immediately before the medium S passes through the first transport roll 81. Therefore, the rubbing region R2 of the second rubbing roll 92 is a front half region of the medium S from the leading end part of the medium S to the middle of the medium S in the transport direction (see FIGS. 36A to 36E).

In a case where the leading end part of the medium S passes through the second rubbing roll 92, the medium S is transported toward the position of the first rubbing roll 91. In this case, in the first mode, the first rubbing roll 91 is in a standby state at the release position. Therefore, the medium S transported by the first transport roll 81 slips through the first rubbing roll 91 and is directed toward the second transport roll 82.

### Switching to Second Mode

Next, the control device 120 determines whether or not the leading end part of the medium S has passed through the second transport roll 82. Then, in a case where it is determined that the leading end part of the medium S has passed through the second transport roll 82, the control device 120 performs switching to a second mode. Here, the “second mode” referred to here refers to an operation behavior shown in FIG. 35B. In this case, unlike the first mode, the first rubbing roll 91 is switched to the nip position to start the driving. The first transport roll 81, the second transport roll 82, and the second rubbing roll 92 are the same as in the first mode.

In this state, immediately after the medium S has entered the second transport roll 82, the first rubbing roll 91 nips a middle portion of the medium S in the transport direction and rotates in the direction opposite to the second transport roll 82 at the speed v1 (|v1|>v0).

Therefore, the medium S is transported in a state of being pulled in the transport direction between the first rubbing roll 91 and the second transport roll 82. In this case, a relationship between the frictional force f1 between the first rubbing roll 91 and the medium S and the frictional force f0 between the second transport roll 82 and the medium S is f1<f0. Therefore, the medium S is transported by the second transport roll 82 at the transport speed v0. In this state, in a case where the first rubbing roll 91 rotates in the opposite direction at the speed v1 in the contact region CN1, the surface of the medium S is rubbed in the direction opposite to the transport direction of the medium S. As a result, the rubbing operation using the first rubbing roll 91 is continued until the trailing end of the medium S in the transport direction passes through the first rubbing roll 91. Therefore, the rubbing region R1 of the first rubbing roll 91 is a rear half region of the medium S from the middle of the medium S in the transport direction to the trailing end of the medium S in the transport direction (see FIGS. 36A to 36F).

### Switching to Third Mode

Thereafter, the control device 120 determines whether or not the trailing end part of the medium S has passed through the first transport roll 81. Then, in a case where it is determined that the trailing end part of the medium S is immediately before passing through the first transport roll 81, the control device 120 performs switching to a third mode. Here, the “third mode” referred to here refers to an operation behavior shown in FIG. 35C. In this case, the third mode refers to the operation behavior of stopping the driving by switching the second rubbing roll 92 to the release position, unlike the first mode and the second mode. In this case, the first transport roll 81, the second transport roll 82, and the first rubbing roll 91 need only be the same as in the second mode.

The third mode is a mode for well maintaining the transportability of the medium S in the post-processing device 25. In a case where the rubbing operation using the second rubbing roll 92 is continued even after the trailing end part of the medium S has passed through the first transport roll 81, the medium S is transported by the second rubbing roll 92 at the speed v2 (v2>v0) at a point in time when the transport operation of the medium S using the first transport roll 81 is no longer performed. In this case, the medium S is transported at the transport speed v0 by the first rubbing roll 91 and the second transport roll 82. Therefore, in the post-processing device 25, the medium S is transported at a high speed only by the first rubbing roll 91, and thus the transportability of the medium S is impaired.

### Return to Initial Position

Next, the control device 120 determines whether or not the trailing end part of the medium S has passed through the second transport roll 82. In the present example, in a case where it is determined that the trailing end part of the medium S has passed through the second transport roll 82, the control device 120 stops the driving of the first transport roll 81, the second transport roll 82, and the first rubbing roll 91, and disposes the first rubbing roll 91 and the second rubbing roll 92 at the initial positions. In the present example, the initial position is selected, for example, as the disposition in the first mode (the second rubbing roll 92 is at the nip position, and the first rubbing roll 91 is at the release position).

### Post-Processing Operation Procedure of Post-Processing Device

FIGS. 36A to 36F are diagrams showing a post-processing operation procedure of the post-processing device in time series.

In the same drawing, the distance D1 between the first transport roll 81 and the second rubbing roll 92, the distance D2 between the second rubbing roll 92 and the first rubbing roll 91, and the distance D3 between the first rubbing roll 91 and the second transport roll 82 may be selected as appropriate such that Expression (III): D1+D2+D3=D<g (length of medium S in transport direction), and Expression (IV): D1, D3<g/2 are satisfied (see paragraph [0133]).

Hereinafter, as an example, an aspect will be described in which D1, D2, and D3 are approximately equal intervals.

FIG. 36A shows a state where the leading end part of the medium S enters the first transport roll 81. In this case, the first mode (see FIG. 35A) is carried out, so that the medium S is transported by the transport roll 65c for feeding located on the inlet side of the post-processing device 25 and then transported by the first transport roll 81.

FIG. 36B shows a state after the leading end part of the medium S has entered the second rubbing roll 92. In this case, the first mode is carried out, so that the rubbing operation using the second rubbing roll 92 is carried out from the middle of the medium S in the transport direction. In FIG. 36B, R2 indicates a rubbing region (corresponding to a hatched region in the diagonally lower left in the drawing) of the second rubbing roll 92 with respect to the medium S.

In addition, the first rubbing roll 91 stops the driving and is in a standby state at the release position, the medium S slips through the first rubbing roll 91 and is directed toward the second transport roll 82.

FIG. 36C shows a state where the leading end part of the medium S has entered the second transport roll 82. In this case, the second mode (see FIG. 35B) is carried out, so that the driving is started after the first rubbing roll 91 is disposed at the nip position. Therefore, the rubbing operation using the first rubbing roll 91 is started from the middle of the medium in the transport direction. The rubbing operation using the second rubbing roll 92 is continuously carried out.

FIG. 36D shows a state where the trailing end part of the medium S passes through the first transport roll 81. In this case, the third mode is switched (see FIG. 35C), the second rubbing roll 92 is disposed at the release position, and the driving is stopped. During this period, the rubbing operation using the second rubbing roll 92 is carried out from the leading end part of the medium S to the middle of the medium S in the transport direction. In addition, the rubbing operation using the first rubbing roll 91 is carried out from the middle of the medium S in the transport direction toward the downstream side of the medium S in the transport direction. In FIG. 36D, R1 indicates a rubbing region (corresponding to a hatched region in the diagonally lower right in the drawing) of the first rubbing roll 91 with respect to the medium S.

FIG. 36E shows a state where the trailing end part of the medium S passes through the second rubbing roll 92. In this case, the third mode is still being carried out. During this period, the rubbing operation using the first rubbing roll 91 is carried out from the middle of the medium S in the transport direction to the trailing end part of the medium S.

In FIG. 36E, the rubbing region R1 of the first rubbing roll 91 is provided substantially within a g-L3 range. On the other hand, the rubbing region R2 of the second rubbing roll 92 is provided substantially within the g-L1 range.

FIG. 36F shows a state immediately after the trailing end part of the medium S has passed through the second transport roll 82.

In this case, the driving of the first transport roll 81, the second transport roll 82, and the first rubbing roll 91 is stopped, and the first rubbing roll 91 and the second rubbing roll 92 are returned to the initial positions (in the present example, the disposition in the first mode).

The leading end part of the medium S that has passed through the post-processing device 25 is nipped and transported by the transport roll 65d for reception located on the outlet side of the post-processing device 25. Therefore, the transportability of the medium S discharged from the post-processing device 25 is well maintained.

As described above, in the present example, as shown in FIGS. 36E and 36F, in the wax rubbing processing using the post-processing device 25, both the front and back surfaces of the medium S are rubbed in the rubbing region R1 of the first rubbing roll 91 and the rubbing region R2 of the second rubbing roll 92. In the present example, since R1+R2=2g-L1-L3 (g>L) is satisfied, it is understood that the wax rubbing processing using the post-processing device 25 is realized with the entire region of both the front and back surfaces of the medium S as the rubbing target. In addition, in the present example, the rubbing regions R1 and R2 are in a partially overlapping state in the middle portion of the transport direction of the medium S, and the relationship of R1=R2 is satisfied.

In the present exemplary embodiment as well, as in Exemplary Embodiment 1, it is confirmed that the form of the wax W changed from the granular mass Wa to the thin film-like layer Wb before and after the post-processing using the post-processing device 25. In this case, it is confirmed that, in a case where the wax W after the post-processing is changed to the thin film-like layer Wb having the thickness tr equal to or less than 0.15 μm, the wax W is hardly visible to the naked eye.

In particular, in the present exemplary embodiment as well, as in Exemplary Embodiment 3, a method of adjusting the rubbing energies Em of the first rubbing roll 91 and the second rubbing roll 92 is adopted in consideration of the use environment conditions of the wax W (the surface condition of the medium and the temperature condition of the medium). Therefore, it is possible to more appropriately exhibit the effect of spreading the wax W by the rubbing operations using the first rubbing roll 91 and the second rubbing roll 92, as compared with a case where the rubbing energies Em of the first rubbing roll 91 and the second rubbing roll 92 are made constant.

### Modification Aspect

(1) In the present exemplary embodiment, in a case where the first rubbing roll 91 (or second rubbing roll 92) is disposed at the release position, the driving of the plurality of rotating bodies 91a and 91b (or 92a and 92b) is stopped. However, the first rubbing roll 91 (or second rubbing roll 92) may be disposed at the release position without stopping the driving of the plurality of rotating bodies 91a and 91b (or 92a and 92b).

(2) In the present exemplary embodiment, the disposition of the first mode is selected as the initial position of the post-processing device 25, but another disposition may be adopted.

### Exemplary Embodiment 5

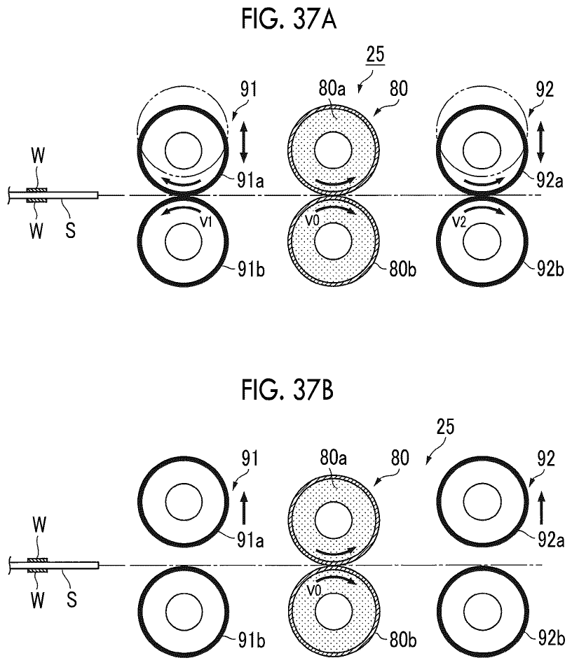

FIG. 37 is a diagram showing a major portion of the post-processing device according to Exemplary Embodiment 5.

In the same drawing, the basic configuration of the post-processing device 25 is substantially the same as the configuration in Exemplary Embodiment 3, but is different from the configuration in Exemplary Embodiment 3 in that the wax rubbing processing is selectively carried out depending on the type of the medium S. The same constituent elements as the constituent elements of Exemplary Embodiment 3 will be denoted by the same reference numerals as the reference numerals of Exemplary Embodiment 3, and the detailed description thereof will be omitted here.

In the present example, the detection signal from the surface information detector 130 is imported into the control device 120 (see FIG. 23). In this case, the control device 120 includes a medium type discrimination portion (not shown) that discriminates whether or not the medium S is a medium that requires the processing, that is, a medium that requires the wax rubbing processing. Here, as the medium of the type that requires processing, a medium of a type in which the wax transferred to the front surface or the back surface of the medium S that has passed through the fixing device 24 is visible is selected. Examples of a representative aspect of the medium S of the type that requires the processing include a transparent film medium of which the surface is smooth.

In addition, various methods can be used as the medium type discrimination method of the medium type discrimination portion.

A first method is a method of performing discrimination using the surface information of the medium S (for example, the smoothness or surface roughness, the presence or absence of the metal layer on the substrate, the glossiness of the surface, and the like) obtained by the surface information detector 130.

A second method is a method of separately detecting and using characteristic information (resistance information, basis weight, air permeability, and the like) of the medium other than the surface information in addition to the surface information of the medium S.

A third method is a method of registering the medium that requires the processing in advance in the memory of the control device 120 and discriminating whether or not the medium designated by the user matches the type that requires the processing.

In the present example, the control device 120 need only cause the medium type discrimination portion to discriminate whether or not the medium is the medium of the type that requires the processing. Then, in a case where the control device 120 discriminates that the medium is the medium that requires the processing, the post-processing device 25 need only carry out the wax rubbing processing. On the other hand, in a case where the control device 120 discriminates that the medium is different from the medium of the type that requires the processing, the wax rubbing processing using the post-processing device 25 may not be carried out.

Here, in a case where the wax rubbing processing is carried out by the post-processing device 25, as shown in FIG. 37A, in substantially the same manner as in Exemplary Embodiment 3, the transport roll 80, the first rubbing roll 91, and the second rubbing roll 92 need only be controlled by the control device 120, and the rubbing operations using the first rubbing roll 91 and the second rubbing roll 92 need only be carried out.

On the other hand, in a case where the wax rubbing processing using the post-processing device 25 is not carried out, as shown in FIG. 37B, the control device 120 need only carry out only the transport operation using the transport roll 80. In this case, the first rubbing roll 91 and the second rubbing roll 92 need only be disposed at the release position, to stop the driving. As a result, the medium S that does not require the wax rubbing processing is transported in the post-processing device 25 by the transport roll 80 without receiving the rubbing operations using the first rubbing roll 91 and the second rubbing roll 92.

In the present exemplary embodiment, the post-processing device 25 having substantially the same configuration as in Exemplary Embodiment 3 is adopted, but the present invention is not limited to this, and it goes without saying that, for example, the post-processing device 25 having substantially the same configuration as in Exemplary Embodiment 1, 2, or 4 may be adopted.

### Exemplary Embodiment 6

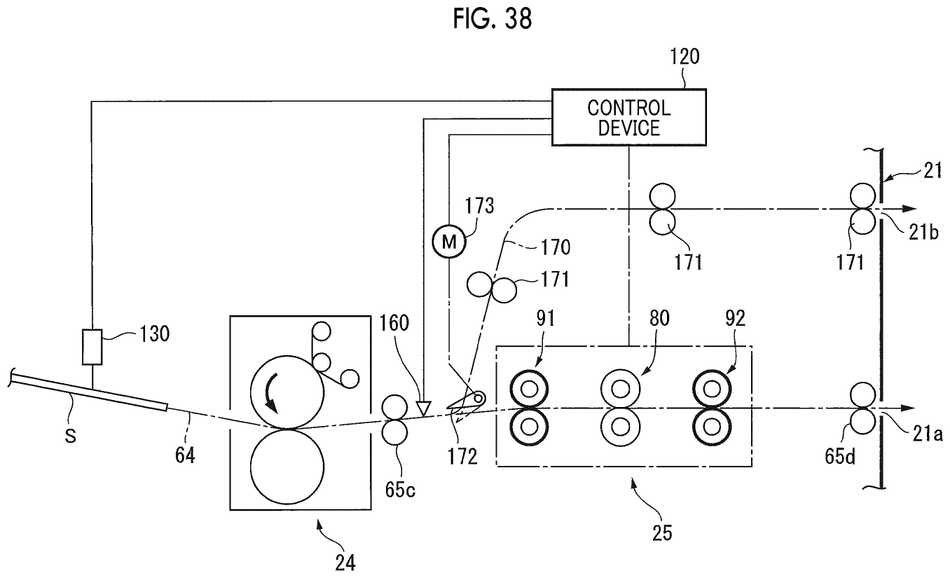

FIG. 38 is a diagram showing a major portion of the post-processing device according to Exemplary Embodiment 6.

In the same drawing, the basic configuration of the post-processing device 25 has an aspect in which the wax rubbing processing is selectively carried out depending on the type of the medium S, which is in substantially the same manner as in Exemplary Embodiment 5, but is different from the configuration of Exemplary Embodiment 5. The same constituent elements as the constituent elements of Exemplary Embodiment 5 will be denoted by the same reference numerals as the reference numerals of Exemplary Embodiment 5, and the detailed description thereof will be omitted here.

In the present example, the control device 120 also includes the medium type discrimination portion (not shown) as in Exemplary Embodiment 5.

In the present example, in the horizontal transport path 64, a branch transport path 170 that branches from the horizontal transport path 64 is provided between the fixing device 24 and the post-processing device 25. The branch transport path 170 branches from the horizontal transport path 64 and then extends in a substantially horizontal direction along the side wall of the unit housing 21 toward a discharge port 21b. An appropriate number of transport rolls 171 for transporting the medium S are provided in the branch transport path 170.

In addition, a switching gate 172 as a switching section is provided at a branch point between the horizontal transport path 64 and the branch transport path 170. The switching gate 172 performs switching via a switching motor 173 to the horizontal transport path 64 or the branch transport path 170 as the transport path of the medium S.

In the present example, the control device 120 need only determine whether or not the medium S is the medium of the type that requires the processing, based on a discrimination signal from the medium type discrimination portion (not shown). Then, in a case where the control device 120 discriminates that the medium is the medium of the type that requires the processing, the post-processing device 25 need only carry out the wax rubbing processing. On the other hand, in a case where the control device 120 discriminates that the medium is different from the medium of the type that requires the processing, the wax rubbing processing using the post-processing device may not be carried out.

Here, in a case where the wax rubbing processing using the post-processing device 25 is carried out, the control device 120 need only control the switching motor 173 and cause the switching gate 172 to switch and select the transport path of the medium S to the horizontal transport path 64. As a result, the medium S is transported to the post-processing device 25, and the wax rubbing processing is carried out by the post-processing device 25.

On the other hand, in a case where the wax rubbing processing using the post-processing device 25 is not carried out, the control device 120 need only control the switching motor 173 and cause the switching gate 172 to switch and select the transport path of the medium S to the branch transport path 170. As a result, the medium S is discharged from the discharge port 21b of the unit housing 21 via the branch transport path 170 without passing through the post-processing device 25 after passing through the position detector 160.

In the present exemplary embodiment, the post-processing device 25 having substantially the same configuration as in Exemplary Embodiment 3 is adopted, but the present invention is not limited to this, and it goes without saying that, for example, the post-processing device 25 having substantially the same configuration as in Exemplary Embodiment 1, 2, or 4 may be adopted.

### EXAMPLES

### Example 1

In Example 1, the wax rubbing processing is carried out by using the post-processing device 25 of the image forming system 20 according to Exemplary Embodiment 1.

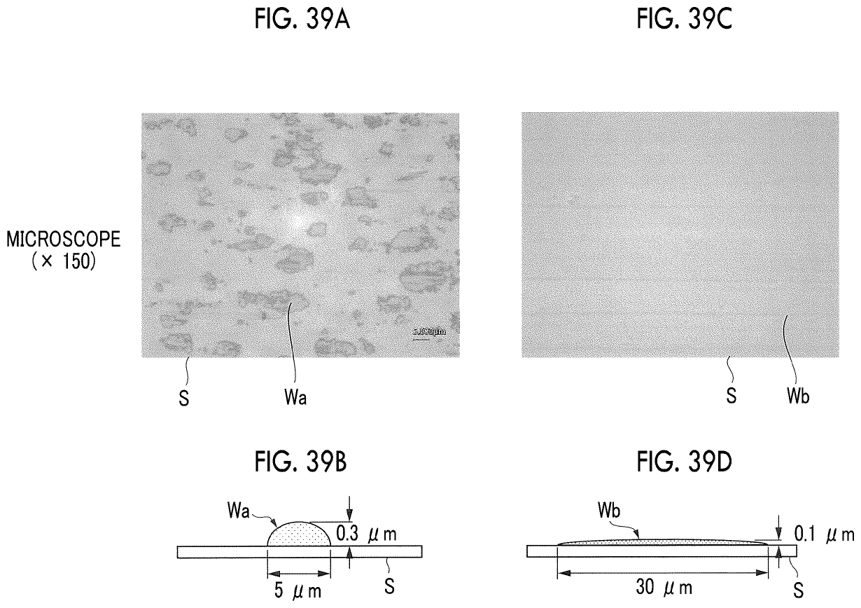

FIG. 39A shows a microscope photograph (×150 times) obtained by imaging a surface state of the medium (transparent film medium is used) that has passed through the fixing device before the post-processing using the post-processing device 25.

FIG. 39C shows a microscope photograph (×150 times) obtained by imaging a surface state of the medium (transparent film medium is used) that has passed through the fixing device after the post-processing using the post-processing device 25.

In a case of evaluating the post-processing using the post-processing device 25, a cross-sectional state of the medium S before the post-processing shown in FIG. 39A is confirmed, and a result as shown in FIG. 39B is obtained. In FIG. 39B, the wax W transferred to the medium S is confirmed in a large amount as the granular mass Wa (for example, a mass having a radius of 5 μm and a thickness of about 0.3 μm). In this case, the reflected light or the transmitted light to the medium S is scattered by the granular mass Wa, and is visualized. Such a granular mass Wa may be conspicuous as a surface contamination of the medium S, and the image formed using the toner may lead to the image defect.

On the other hand, as shown in FIG. 39C, a cross-sectional state of the medium S after the post-processing using the post-processing device 25 is confirmed, and a result as shown in FIG. 39D is obtained. In FIG. 39D, it is confirmed that the wax W transferred to the medium S is changed to the thin film-like layer Wb (for example, a layer having a thickness of about 0.1 μm in a circular region having a diameter of 30 μm) that is smoothly thinly spread in a flattened manner by the rubbing processing using the post-processing device 25. In this case, in the thin film-like layer Wb, there is no scattering as in the granular mass Wa, and the wax is in a less visible state. Therefore, a case where the wax transferred to the medium S may be manifested as surface contamination is effectively suppressed.

### Example 2

Example 2 is to confirm the effectiveness of the rubbing processing using the post-processing device 25 by using the post-processing device 25 of the image forming system 20 according to Exemplary Embodiment 1 or 2.

In the present example, a film medium (for example, OZK-E188A manufactured by DYNIC CORPORATION) of which the surface is smooth is used as the medium S, and for a plurality of medium samples having different visual grades, a post-processing state with respect to the wax transfer is examined, and whether or not the wax is less visible is visually confirmed.

Here, in examining the post-processing state of the medium S, the thickness tr (wax layer thickness) of the thin film-like layer Wb of the wax is measured, and the boundary value of the thickness tr at which the wax of the medium S can be made less visible is obtained.

In the present example, as the measurement method, a method of calculating a height of the wax particles on the medium by averaging maximum heights (corresponding to maximum thicknesses) of a plurality of wax particles existing in a certain measurement region using an optical microscope is adopted. In obtaining the average of the maximum heights, the sum of the maximum heights of the wax particles in the measurement region is divided by the number of particles.

Measurement conditions are as follows.
Optical microscope: KEYENCE VK-X3000
Measurement method: laser irradiation method
Magnification: 500 times
Scan mode: laser confocal
Measurement region: 0.2 mm×0.2 mm
Measurement size: standard (1024×768)
Measurement quality setting: high accuracy
Measurement pitch setting: 0.13 μm

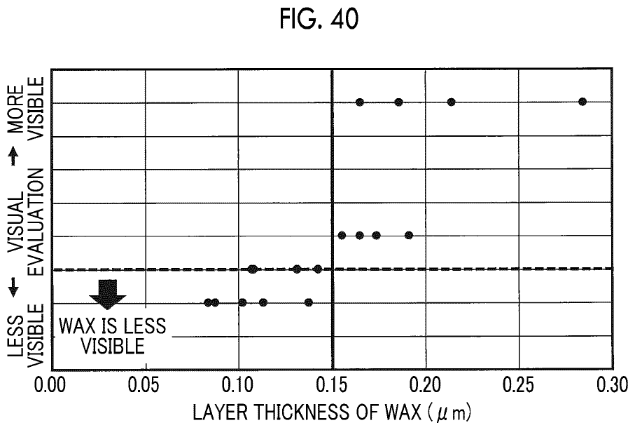

In the present example, in a case where a correlation between the calculated average height of the wax particles (corresponding to the layer thickness of the wax) and the visual grade is graphed, a result shown in FIG. 40 is obtained.

As seen from the same drawing, the wax is less visible in a case where the wax layer thickness is equal to or less than 0.15 μm.

### Example 3

Example 3 shows a setting example of the rubbing energy of the rubbing roll with respect to the medium temperature using the post-processing device 25 used in the image forming system according to Exemplary Embodiment 3.

In the present example, two types of media having different smoothness shown in Table 2 below are used.

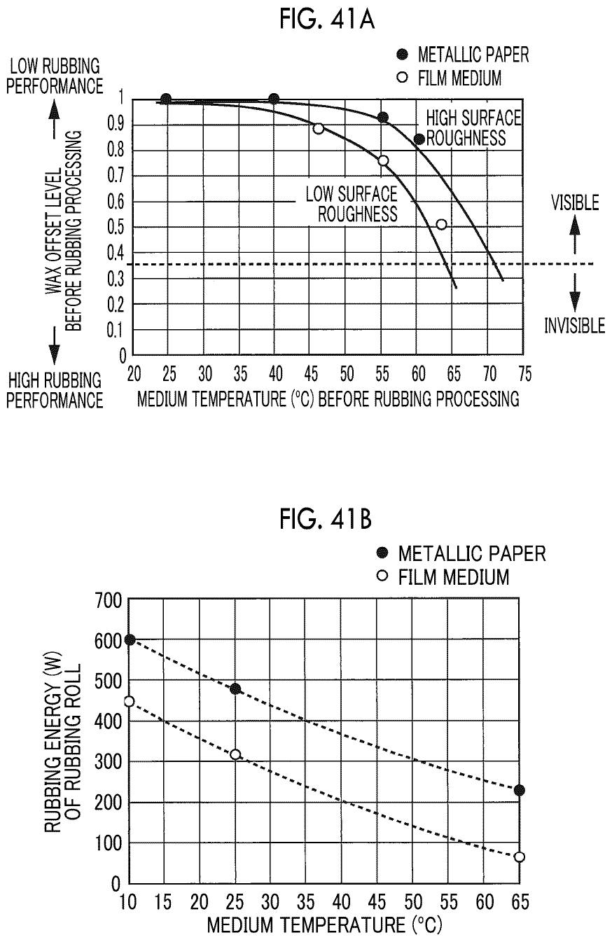

First, a relationship between the medium temperature before the wax rubbing processing using the post-processing device and a wax transfer level (wax offset level) to the medium is examined for each type of medium. The result shown in FIG. 41A is obtained.

The conditions for using the post-processing device are as follows.
Load of first rubbing roll/second rubbing roll: 72 (N)
Speed difference between first rubbing roll/second rubbing roll and medium: 1240 (mm/s)·
Load of transport roll: 150 (N)

The results are shown in FIG. 41A.

As seen from the same drawing, the wax offset level of all types of media changes depending on the medium temperature. As a change state, it is understood that the wax offset level is higher in a case where the medium temperature is low than in a case where the medium temperature is high. In addition, regarding the influence of the medium type, it is found that the wax offset level is higher in the metallic paper having high surface roughness than in the film medium having low surface roughness even in a case where the medium temperature is high.

In addition, in a case where the wax offset level is large, it is necessary to carry out the rubbing processing on the wax on the medium with a large rubbing energy until the wax reaches an invisible level in which the wax is invisible.

In consideration of the above points, for each medium, the rubbing energy Em ((load F×circumferential speed difference V) (W)) of the rubbing roll (first rubbing roll or second rubbing roll) with respect to the medium temperature (C) is adjusted, and the rubbing conditions required for thinning the wax on the medium to the invisible level are examined. The results are shown in FIG. 41B.

In the same drawing, a boundary curve of the rubbing energy of the rubbing roll with respect to the medium temperature is obtained as the rubbing condition for thinning the wax on the medium to the invisible level. That is, it is confirmed that the rubbing processing of the wax on the medium is appropriately performed by selecting the conditions of the region above the boundary curve obtained for each medium for each medium temperature. For example, in a case where the medium temperature is 25° C., it is understood that the rubbing energy Em of the rubbing roll need only be set to be equal to or greater than 490 (W) in a case of the metallic paper. On the other hand, in a case of the film medium, it is understood that the rubbing energy Em of the rubbing roll need only be set to be equal to or greater than 320 (W).

TABLE 2

| | Film medium | Metallic paper |
|---|---|---|
| Brand | OZK-E188A manufactured by | DEEP L Off-Metal 315 |
| | DYNIC CORPORATION | manufactured by TAKEO |
| | | CO., LTD. |
| Smoothness | 2330 | 8730 |
| (seconds) | | |

⊚ Example 4

Example 4 shows a detection result example of the surface information detector used for controlling the post-processing device of the image forming system according to Exemplary Embodiment 1 or 2.

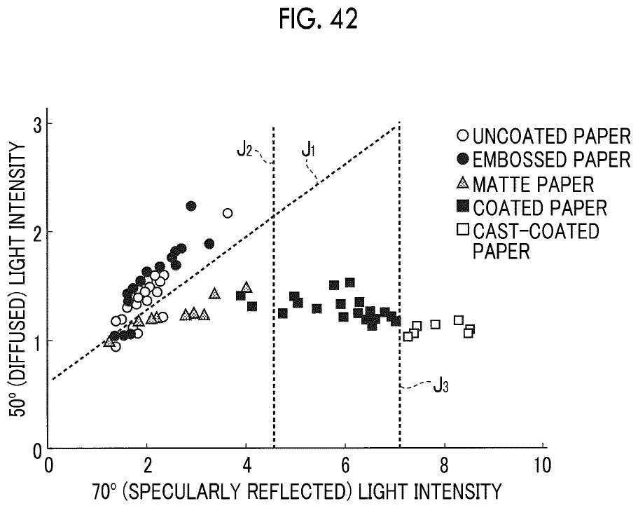

In the present example, in a case where the surface information detector 130 shown in FIG. 6A used in Exemplary Embodiment 1 is used to examine the medium type discrimination performance, the result shown in FIG. 42 is obtained. In the present example, in FIG. 6A, α=20° and β=40° are used.

In the present example, five types of media (uncoated paper, embossed paper, matte paper, coated paper, and cast-coated paper) having different smoothness or similar smoothness as the physical properties of the medium are set as the discrimination targets, and a plurality of sheets of the media are randomly run and detected by the surface information detector 130.

The surface information detector 130 shown in FIG. 6A discriminates a difference in smoothness or surface roughness of the medium by a ratio of the specularly reflected light (in the present example, the specularly reflected light in a direction of 70° with respect to the vertical direction of the surface of the medium) and the diffused light (in the present example, the diffused light in a direction of 50° with respect to the vertical direction) from the medium.

Based on FIG. 42, it is understood that a smooth medium (coated paper or cast-coated paper) tends to have a larger specularly reflected light than a non-smooth medium. In addition, it is understood that the ratio of the diffused light to the specularly reflected light is larger in the non-smooth medium (uncoated paper or embossed paper) than in the smooth medium. In the matte paper, a tendency is observed in which the ratio between the specularly reflected light and the diffused light is substantially the same.

Based on FIG. 42, it is understood that the cast-coated paper, the coated paper, and the matte paper are substantially divided as shown by dashed division lines J1 to J3 that partition the region. In addition, the embossed paper/uncoated paper is generally divided from other medium types with the division line J2 as a boundary, but both the embossed paper and the uncoated paper are in a mixed state.

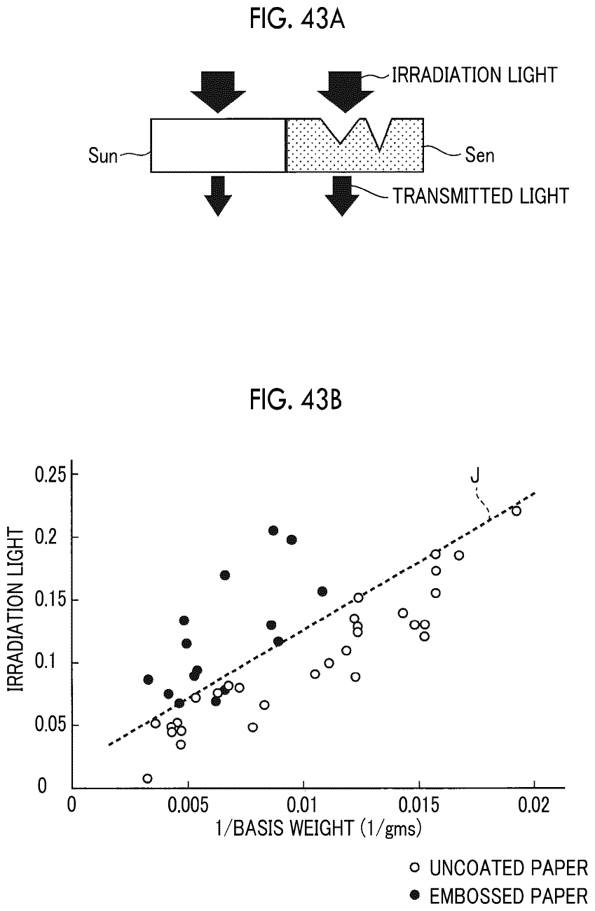

Therefore, in the present example, as shown in FIG. 43A, in a case where the difference in physical properties between the uncoated paper Sun and the embossed paper Sen is examined, it is found that the embossed paper Een has a larger transparency in a case where the thickness is the same.

Therefore, as the surface information detector 130, a device that can measure the basis weight (gms) and the intensity of transmitted light of the medium is separately used, and a relationship between 1/basis weight (1/gms) and the intensity of transmitted light is examined. In addition, the thickness=the basis weight.

The results are shown in FIG. 43B.

Based on the same drawing, it is understood that the divided region of the embossed paper Sen and the divided region of the uncoated paper Sun are substantially divided by a division line J indicated by a linear dashed line.

Therefore, it is confirmed that the above-described five types of media can be discriminated in a case where a separate surface information detector 130 that can measure the basis weight and the intensity of transmitted light of the medium is used in addition to the surface information detector 130 shown in FIG. 6A.

### Supplementary Note

(((1)))

A post-processing device comprising:
a transport section that transports a medium, on which an image formed using an imaging material and wax are held and which has passed through a fixing section that fixes the image of the medium by heating and pressurization, at a predetermined transport speed by nipping the medium;
a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section;
an acquisition section that acquires use environment information of the wax held on the medium that has passed through the fixing section; and
an adjustment section that adjusts a rubbing condition of the rubbing section based on the use environment information acquired by the acquisition section.
   (((2)))

The post-processing device according to (((1))),
wherein the acquisition section acquires surface information related to a surface state of the medium and temperature information of the medium, as the use environment information of the wax.
   (((3)))

The post-processing device according to (((1))) or (((2))),
wherein the acquisition section includes
   a surface information acquisition section that acquires surface information related to a surface state of the medium, and
   a temperature information acquisition section that acquires temperature information of the medium located between the fixing section and the rubbing section.
      (((4)))

The post-processing device according to any one of (((1))) to (((3))),
wherein the acquisition section includes at least a surface information acquisition section that acquires surface information related to a surface state of the medium, and
the surface information acquisition section acquires smoothness or surface roughness of the medium, as the surface information.
   (((5)))

The post-processing device according to any one of (((1))) to (((3))),
wherein the acquisition section includes at least a surface information acquisition section that acquires surface information related to a surface state of the medium, and
the surface information acquisition section acquires presence or absence of a metal layer on a substrate of the medium, as the surface information.
   (((6)))

The post-processing device according to any one of (((1))) to (((3))),
wherein the acquisition section includes at least a surface information acquisition section that acquires surface information related to a surface state of the medium, and
the surface information acquisition section acquires smoothness or surface roughness of the medium and presence or absence of a metal layer on a substrate of the medium, as the surface information.
   (((7)))

The post-processing device according to any one of (((1))) to (((6)))
wherein the acquisition section includes a surface information acquisition section that acquires surface information related to a surface state of the medium, and
the surface information acquisition section is provided upstream of the rubbing section in the transport direction of the medium, and includes a detection section that detects the surface information in a case where the medium passes through the detection section.
   (((8)))

The post-processing device according to (((7))),
wherein the detection section optically detects smoothness a surface roughness of the medium, as the surface information.
   (((9)))

The post-processing device according to (((7))),
wherein the detection section is capable of detecting presence or absence of a metal layer on a substrate of the medium, as the surface information.
   (((10)))

The post-processing device according to any one of (((1))) to (((9))),
wherein the acquisition section includes a temperature information acquisition section that acquires temperature information of the medium located between the fixing section and the rubbing section, and
the temperature information acquisition section includes a temperature detection section that detects a surface temperature of the medium.
   (((11)))

The post-processing device according to (((10))),
wherein the temperature detection section is disposed closer to the rubbing section than the fixing section.
   (((12)))

The post-processing device according to any one of (((1))) to (((11))),
wherein the adjustment section adjusts a rubbing energy applied to the wax held on the medium as the rubbing condition of the rubbing section.
   (((13)))

The post-processing device according to (((12))),
wherein, in a case of adjusting the rubbing energy, the adjustment section makes any one or both of a rubbing load for pressing the surface of the medium and a speed difference between the transport section and the rubbing section variable.
   (((14)))

The post-processing device according to (((12))),
wherein the acquisition section acquires smoothness or surface roughness of the medium, as the use environment information of the wax, and
the adjustment section adjusts, depending on the smoothness or the surface roughness of the medium, the rubbing energy to be larger in a case where the medium is less smooth than in a case where the medium is smoother.
   (((15)))

The post-processing device according to (((12))),
wherein the acquisition section acquires presence or absence of a metal layer on a substrate of the medium, as the use environment information of the wax, and
the adjustment section varies the rubbing energy in a case where the medium has the metal layer on the substrate, as compared with a case where the medium does not have the metal layer on the substrate.
   (((16)))

The post-processing device according to (((12))),
wherein the acquisition section acquires temperature information of the medium, as the use environment information of the wax, and
the adjustment section adjusts, depending on the temperature information of the medium, the rubbing energy to be larger in a case where a temperature of the medium is lower than in a case where the temperature of the medium is higher.
   (((17)))

The post-processing device according to any one of (((1))) to (((16))),
wherein the rubbing section consists of a plurality of rotating bodies that are disposed to face each other with respect to the medium and that are able to come into contact with each other and separable from each other between a contact position at which the plurality of rotating bodies are in contact with the medium and a non-contact position, and rubs the surface of the medium in a case where the plurality of rotating bodies are disposed at the contact position.
   (((18)))

The post-processing device according to (((17))),
wherein, in a case where the plurality of rotating bodies constituting the rubbing section are disposed at the contact position, a frictional force between the transport section and the medium is greater than a frictional force between the rubbing section and the medium.
   (((19)))

The post-processing device according to (((17))),
wherein the plurality of rotating bodies constituting the rubbing section are disposed at the contact position in a case where the transport section transports the medium, and are disposed at the non-contact position in a case where the transport section does not transport the medium.
   (((20)))

An image forming system comprising:
an imaging section that holds an image, which is formed using an imaging material containing wax, on a medium;
a fixing section that performs heating and pressurization to fix the image, which is formed by the imaging section, on the medium; and
the post-processing device according to any one of (((1))) to (((19))) that performs post-processing on the medium that has passed through the fixing section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing device comprising:
a transport section that transports a medium, on which an image formed using an imaging material and wax are held and which has passed through a fixing section that fixes the image of the medium by heating and pressurization, at a predetermined transport speed by nipping the medium;
a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section;
an acquisition section that acquires use environment information of the wax held on the medium that has passed through the fixing section; and
an adjustment section that adjusts a rubbing condition of the rubbing section based on the use environment information acquired by the acquisition section.

2. The post-processing device according to claim 1,
wherein the acquisition section acquires surface information related to a surface state of the medium and temperature information of the medium, as the use environment information of the wax.

3. The post-processing device according to claim 2,
wherein the acquisition section includes
a surface information acquisition section that acquires the surface information related to the surface state of the medium, and
a temperature information acquisition section that acquires the temperature information of the medium located between the fixing section and the rubbing section.

4. The post-processing device according to claim 1,
wherein the acquisition section includes at least a surface information acquisition section that acquires surface information related to a surface state of the medium, and
the surface information acquisition section acquires smoothness or surface roughness of the medium, as the surface information.

5. The post-processing device according to claim 1,
wherein the acquisition section includes at least a surface information acquisition section that acquires surface information related to a surface state of the medium, and
the surface information acquisition section acquires presence or absence of a metal layer on a substrate of the medium, as the surface information.

6. The post-processing device according to claim 1,
wherein the acquisition section includes at least a surface information acquisition section that acquires surface information related to a surface state of the medium, and
the surface information acquisition section acquires smoothness or surface roughness of the medium and presence or absence of a metal layer on a substrate of the medium, as the surface information.

7. The post-processing device according to claim 1,
wherein the acquisition section includes a surface information acquisition section that acquires surface information related to a surface state of the medium, and
the surface information acquisition section is provided upstream of the rubbing section in the transport direction of the medium, and includes a detection section that detects the surface information in a case where the medium passes through the detection section.

8. The post-processing device according to claim 7,
wherein the detection section optically detects smoothness a surface roughness of the medium, as the surface information.

9. The post-processing device according to claim 7,
wherein the detection section is capable of detecting presence or absence of a metal layer on a substrate of the medium, as the surface information.

10. The post-processing device according to claim 1,
wherein the acquisition section includes a temperature information acquisition section that acquires temperature information of the medium located between the fixing section and the rubbing section, and
the temperature information acquisition section includes a temperature detection section that detects a surface temperature of the medium.

11. The post-processing device according to claim 10,
wherein the temperature detection section is disposed closer to the rubbing section than the fixing section.

12. The post-processing device according to claim 1,
wherein the adjustment section adjusts a rubbing energy applied to the wax held on the medium as the rubbing condition of the rubbing section.

13. The post-processing device according to claim 12,
wherein, in a case of adjusting the rubbing energy, the adjustment section makes any one or both of a rubbing load for pressing the surface of the medium and a speed difference between the transport section and the rubbing section variable.

14. The post-processing device according to claim 12,
wherein the acquisition section acquires smoothness or surface roughness of the medium, as the use environment information of the wax, and
the adjustment section adjusts, depending on the smoothness or the surface roughness of the medium, the rubbing energy to be larger in a case where the medium is less smooth than in a case where the medium is smoother.

15. The post-processing device according to claim 12,
wherein the acquisition section acquires presence or absence of a metal layer on a substrate of the medium, as the use environment information of the wax, and
the adjustment section varies the rubbing energy in a case where the medium has the metal layer on the substrate, as compared with a case where the medium does not have the metal layer on the substrate.

16. The post-processing device according to claim 12,
wherein the acquisition section acquires temperature information of the medium, as the use environment information of the wax, and
the adjustment section adjusts, depending on the temperature information of the medium, the rubbing energy to be larger in a case where a temperature of the medium is lower than in a case where the temperature of the medium is higher.

17. The post-processing device according to claim 1,
wherein the rubbing section consists of a plurality of rotating bodies that are disposed to face each other with respect to the medium and that are able to come into contact with each other and separable from each other between a contact position at which the plurality of rotating bodies are in contact with the medium and a non-contact position, and rubs the surface of the medium in a case where the plurality of rotating bodies are disposed at the contact position.

18. The post-processing device according to claim 17,
wherein, in a case where the plurality of rotating bodies constituting the rubbing section are disposed at the contact position, a frictional force between the transport section and the medium is greater than a frictional force between the rubbing section and the medium.

19. The post-processing device according to claim 17,
wherein the plurality of rotating bodies constituting the rubbing section are disposed at the contact position in a case where the transport section transports the medium, and are disposed at the non-contact position in a case where the transport section does not transport the medium.

20. An image forming system comprising:
an imaging section that holds an image, which is formed using an imaging material containing wax, on a medium;
a fixing section that performs heating and pressurization to fix the image, which is formed by the imaging section, on the medium; and
the post-processing device according to claim 1 that performs post-processing on the medium that has passed through the fixing section.
